(19) United States
(12) Patent Application Publication
(10) Pub. No.: US 2006/0134566 A1
(43) Pub. Date: Jun. 22, 2006

(54) Silver halide photographic light-sensitive material

(75) Inventors: Takashi Hoshimiya, Kanagawa (JP); Junichiro Hosokawa, Kanagawa (JP); Naoharu Kiyoto, Kanagawa (JP); Tadashi Inaba, Shizuoka (JP); Takanori Hioki, Kanagawa (JP); Ryoji Nishimura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/304,692

(22) Filed: Dec. 16, 2005

(30) Foreign Application Priority Data
Dec. 16, 2004 (JP) P.2004-364193
Sep. 7, 2005 (JP) P.2005-259350

(51) Int. Cl. G03C 1/46

(52) U.S. Cl. 430/502

(57) ABSTRACT

A silver halide photographic light-sensitive material comprising at least one compound (A), wherein the at least one compound (A) is a compound capable of releasing a sensitizing compound that increases a sensitivity of the silver halide photographic light-sensitive material in comparison with a case where a silver halide photographic light-sensitive material does not comprise the at least one compound (A), and the sensitizing compound is released by hydrolysis.

### BACKGROUND OF THE INVENTION

1. Field of the Invention

The present invention relates to a silver halide photographic light-sensitive material. More particularly, it relates to a silver halide photographic light-sensitive material having a high sensitivity, an excellent preservability and being capable of providing a color image having an excellent color image preservability.

2. Description of the Related Art

In the field of silver halide photographic light-sensitive materials, it has been a long-standing subject to increase its sensitivity without spoiling graininess. In general, photographic sensitivity depends upon size of silver halide emulsion grains. An emulsion of larger grain size provides a more increased photographic sensitivity. However, graininess becomes worse as the size of the silver halide grains increases. Thus, sensitivity and graininess are in a trade-off relation with each other.

In the field of the art, it is the most fundamental and the most important subject to increase sensitivity without deteriorating graininess in improving image quality of photographic light-sensitive materials.

There has heretofore been disclosed a technique of increasing sensitivity without deteriorating graininess by incorporating in a silver halide photographic light-sensitive material a compound having at least 3 hetero atoms (see, for example, JP-A-2000-194085, JP-A-2003-156823 and JP-A-2004-226971).

In contrast with this, it has been found that a hetero ring compound having 1 or 2 hetero atoms is more preferred than the compound having at least 3 hetero atoms and can provide a sensitivity-increasing effect, and the technique has been disclosed (see JP-A-2005-099121).

However, although sensitivity can be increased by the above-mentioned technique, it has been found that there is a case where preservability of a raw light-sensitive material is seriously deteriorated. In particular, preservability of a light-sensitive material in an environment of an extremely high temperature and an extremely low humidity, such as within an automobile left under a burning sun, there can result serious things, and it has become apparent that an increase in fog and a decrease in sensitivity are problems in the case of leaving a light-sensitive material under the conditions of 80° C. or more in temperature and 10% or less in humidity.

### SUMMARY OF THE INVENTION

With the above-mentioned circumstances in mind, the invention has been made, and its object is to provide a silver halide color photographic light-sensitive material which has an increased sensitivity without deteriorating preservability and graininess of the silver halide light-sensitive material.

The inventors have found that the above-described problems can be solved by the following means.

It has also been found that use of the compound of the invention provides an unexpected effect of favorably improving image stability of a processed light-sensitive material.

That is, the invention is as follows.

(1) A silver halide photographic light-sensitive material comprising at least one compound (A),

wherein the at least one compound (A) is a compound capable of releasing a sensitizing compound that increases a sensitivity of the silver halide photographic light-sensitive material in comparison with a case where a silver halide photographic light-sensitive material does not comprise the at least one compound (A), and the sensitizing compound is released by hydrolysis.

(2) The silver halide photographic light-sensitive material as described in (1) above, which further comprises:

a support;

at least one blue-sensitive layer comprising a silver halide emulsion layer;

at least one green-sensitive layer comprising a silver halide emulsion layer;

at least one red-sensitive layer comprising a silver halide emulsion layer; and

at least one light-insensitive layer,

wherein at least one layer of the silver halide photographic light-sensitive material comprises the at least one compound (A).

(3) The silver halide photographic light-sensitive material as described in (1) or (2) above,

wherein the at least one compound (A) is a compound represented by one of formula (A-1) and (A-2):

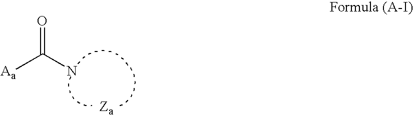

wherein Zₐ represents a group forming a hetero ring containing 1 or 2 hetero atom(s) including a nitrogen atom in the formula; and Aₐ represents an alkyl group, an alkenyl group, a cycloalkyl group, an aryl group, an alkylamino group, an arylamino group or an alkoxy group;

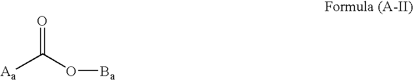

wherein Aₐ represents an alkyl group, an alkenyl group, a cycloalkyl group, an aryl group, an alkylamino group, an arylamino group or an alkoxy group; and Bₐ represents a hetero ring.

(4) The silver halide photographic light-sensitive material as described in any of (1) to (3) above,

wherein the at least one compound (A) is a compound represented by Formula (A-I).

(5) The silver halide photographic light-sensitive material as described in any of (1) to (4) above, wherein the at least one compound represented by Formula (A-I) is a compound in which the hetero ring formed by Zₐ is an imidazole ring, a pyrrole ring, a pyrazole ring or a benzimidazole ring.

### DETAILED DESCRIPTION OF THE INVENTION

The compound (A) to be used in the invention is described in detail below.

In the present invention, when a specific site is called “a group”, this means that the site itself may not be substituted or may be substituted by one or more (up to a possible maximum number) substituents. For example, “an alkyl group” means a substituted or unsubstituted alkyl group. The substituent which can be used in the compound for use in the present invention may be any substituent irrespective of the presence or absence of substitution.

Assuming that this substituent is Wa, the substituent represented by Wa may be any substituent and is not particularly limited, however, examples thereof include a halogen atom, an alkyl group (including a cycloalkyl group, a bicycloalkyl group and a tricycloalkyl group), an alkenyl group (including a cycloalkenyl group and a bicycloalkenyl group),. an alkynyl group, an aryl group, a heterocyclic group, a cyano group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an ammonio group, an acylamino group, an aminocarbonylamino group, an alkoxycarbonylamino group, an aryloxycarbonylamino group, a sulfamoylamino group, an alkylsulfonylamino group, an arylsulfonylamino group, a mercapto group, an alkylthio group, an arylthio group, a heterocyclic thio group, a sulfamoyl group, a sulfo group, an alkylsulfinyl group, an arylsulfinyl group, an alkylsulfonyl group, an arylsulfonyl group, an acyl group, an aryloxycarbonyl group, an alkoxycarbonyl group, a carbamoyl group, an arylazo group, a heterocyclic azo group, an imido group, a phosphino group, a phophinyl group, a phosphinyloxy group, a phosphinylamino group, a phosphono group, a silyl group, a hydrazino group, a ureido group, a boronic acid group (—B(OH)₂), a phosphato group (—OPO(OH)₂), a sulfato group (—OSO₃H) and other known substituents.

More specifically, Wa represents a halogen atom (e.g., fluorine, chlorine, bromine, iodine), an alkyl group [a linear, branched or cyclic, substituted or unsubstituted alkyl group; the alkyl group includes an alkyl group (preferably an alkyl group having from 1 to 30 carbon atoms, e.g., methyl, ethyl, n-propyl, isopropyl, tert-butyl, n-octyl, eicosyl, 2-chloroethyl, 2-cyanoethyl, 2-ethylhexyl), a cycloalkyl group (preferably a substituted or unsubstituted cycloalkyl group having from 3 to 30 carbon atoms, e.g., cyclohexyl, cyclopentyl, 4-n-dodecylcyclohexyl), a bicycloalkyl group (preferably a substituted or unsubstituted bicycloalkyl group having from 5 to 30 carbon atoms, namely, a monovalent group resultant of removing one hydrogen atom from a bicycloalkane having from 5 to 30 carbon atoms, e.g., bicyclo[1,2,2]heptan-2-yl, bicyclo[2,2,2]octan-3-yl), and a tricyclo structure having many cyclic structures; the alkyl group in the substituent described below (for example, an alkyl group in an alkylthio group) means an alkyl group having such a concept and also includes an alkenyl group and an alkynyl group], an alkenyl group [a linear, branched or cyclic, substituted or unsubstituted alkenyl group; the alkenyl group includes an alkenyl group (preferably a substituted or unsubstituted alkenyl group having from 2 to 30 carbon atoms, e.g., vinyl, allyl, prenyl, geranyl, oreyl), a cycloalkenyl group (preferably a substituted or unsubstituted cycloalkenyl group having from 3 to 30 carbon atoms, namely, a monovalent group resultant of removing one hydrogen atom form a cycloalkane having from 3 to 30 carbon atoms, e.g., 2-cyclopenten-1-yl, 2-cyclohexen-1-yl), a bicycloalkenyl group (a substituted or unsubstituted bicycloalkenyl group, preferably a substituted or unsubstituted bicycloalkenyl group having from 5 to 30 carbon atoms, namely, a monovalent group resultant of removing one hydrogen atom from a bicycloalkane having one double bond, e.g., bicyclo[2,2,1]hept-2-en-1-yl, bicyclo[2,2,2]oct-2-en-4-yl)], an alkynyl group (preferably a substituted or unsubstituted alkynyl group having from 2 to 30 carbon atoms, e.g., ethynyl, propargyl, trimethylsilylethynyl), an aryl group (preferably a substituted or unsubstituted aryl group having from 6 to 30 carbon atoms, e.g., phenyl, p-tolyl, naphthyl, m-chlorophenyl, o-hexadecanoylaminophenyl), a heterocyclic group (preferably a monovalent group resultant of removing one hydrogen atom from a 5- or 6-membered substituted or unsubstituted, aromatic or non-aromatic heterocyclic compound, more preferably a 5- or 6-membered aromaheterocyclic group having from 3 to 30 carbon atoms, e.g., 2-furyl, 2-thienyl, 2-pyrimidinyl, 2-benzothiazolyl; the heterocyclic group may also be a cationic heterocyclic group such as 1-methyl-2-pyridinio and 1-methyl-2-quinolinio), a cyano group, a hydroxyl group, a nitro group, a carboxyl group, an alkoxy group (preferably a substituted or unsubstituted alkoxy group having from 1 to 30 carbon atoms, e.g., methoxy, ethoxy, isopropoxy, tert-butoxy, n-octyloxy, 2-methoxyethoxy), an aryloxy group (preferably a substituted or unsubstituted aryloxy group having from 6 to 30 carbon atoms, e.g., phenoxy, 2-methylphenoxy, 4-tert-butylphenoxy, 3-nitrophenoxy, 2-tetradecanoylaminophenoxy), a silyloxy group (preferably a silyloxy group having from 3 to 20 carbon atoms, e.g., trimethylsilyloxy, tert-butyldimethylsilyloxy), a heterocyclic oxy group (preferably a substituted or unsubstituted heterocyclic oxy group having from 2 to 30 carbon atoms, e.g., 1-phenyltetrazol-5-oxy, 2-tetrahydropyranyloxy), an acyloxy group (preferably a formyloxy group, a substituted or unsubstituted alkylcarbonyloxy group having from 2 to 30 carbon atoms, or a substituted or unsubstituted arylcarbonyloxy group having from 6 to 30 carbon atoms, e.g., formyloxy, acetyloxy, pivaloyloxy, stearoyloxy, benzoyloxy, p-methoxyphenylcarbonyloxy), a carbamoyloxy group (preferably a substituted or unsubstituted carbamoyloxy group having from 1 to 30 carbon atoms, e.g., N,N-dimethylcarbamoyloxy, N,N-diethylcarbamoyloxy, morpholinocarbonyloxy, N,N-di-n-octylaminocarbonyloxy, N-n-octylcarbamoyloxy), an alkoxycarbonyloxy group (preferably a substituted or unsubstituted alkoxycarbonyloxy group having from 2 to 30 carbon atoms, e.g., methoxycarbonyloxy, ethoxycarbonyloxy, tert-butoxycarbonyloxy, n-octylcarbonyloxy), an aryloxycarbonyloxy group (preferably a substituted or unsubstituted aryloxycarbonyloxy group having from 7 to 30 carbon atoms, e.g., phenoxycarbonyloxy, p-methoxyphenoxycarbonyloxy, p-n-hexadecyloxyphenoxy-carbonyloxy), an amino group (preferably an amino group, a substituted or unsubstituted alkylamino group having from 1 to 30 carbon atoms, or a substituted or unsubstituted anilino group having from 6 to 30 carbon atoms, e.g., amino, methylamino, dimethylamino, anilino, N-methyl-anilino, diphenylamino), an ammonio group (preferably an ammonio group or an ammonio group substituted by a substituted or unsubstituted alkyl, aryl or heterocyclic group having from 1 to 30 carbon atoms, e.g., trimethylammonio, triethylammonio, diphenylmethylammonio), an acylamino group (preferably a formylamino group, a substituted or unsubstituted alkylcarbonylaminio group having from 1 to 30 carbon atoms, or a substituted or unsubstituted arylcarbonylamino group having from 6 to 30 carbon atoms, e.g., formylamino, acetylamino, pivaloylamino, lauroylamino, benzoylamino, 3,4,5-tri-n-octyloxyphenylcarbonylamino), an aminocarbonylamino group (preferably a substituted or unsubstituted aminocarbonylamino group having from 1 to 30 carbon atoms, e.g., carbamoylamino, N,N-dimethylaminocarbonylamino, N,N-diethylaminocarbonylamino, morpholinocarbonylamino), an alkoxycarbonylamino group (preferably a substituted or unsubstituted alkoxycarbonylamino group having from 2 to 30 carbon atoms, e.g., methoxycarbonylamino, ethoxycarbonylamino, tert-butoxycarbonylamino, n-octadecyloxycarbonylamino, N-methyl-methoxycarbonylamino), an aryloxycarbonylamino group (preferably a substituted or unsubstituted aryloxycarbonylamino group having from 7 to 30 carbon atoms, e.g., phenoxycarbonylamino, p-chlorophenoxycarbonylamino, m-n-octyloxyphenoxycarbonylamino), a sulfamoylamino group (preferably a substituted or unsubstituted sulfamoylamino group having from 0 to 30 carbon atoms, e.g., sulfamoylamino, N,N-dimethylaminosulfonylamino, N-n-octylaminosulfonylamino), an alkyl- or arylsulfonylamino group (preferably a substituted or unsubstituted alkylsulfonylamino group having from 1 to 30 carbon atoms, or a substituted or unsubstituted arylsulfonylamino group having from 6 to 30 carbon atoms, e.g., methylsulfonylamino, butylsulfonylamino, phenylsulfonylamino, 2,3,5-trichlorophenylsulfonylamino, p-methylphenylsulfonylamino), a mercapto group, an alkylthio group (preferably a substituted or unsubstituted alkylthio group having from 1 to 30 carbon atoms, e.g., methylthio, ethylthio, n-hexadecylthio), an arylthio group (preferably a substituted or unsubstituted arylthio group having from 6 to 30 carbon atoms, e.g., phenylthio, p-chlorophenylthio, m-methoxyphenylthio), a heterocyclic thio group (preferably a substituted or unsubstituted heterocyclic thio group having from 2 to 30 carbon atoms, e.g., 2-benzo-thiazolylthio, 1-phenyltetrazol-5-ylthio), a sulfamoyl group (preferably a substituted or unsubstituted sulfamoyl group having from 0 to 30 carbon atoms, e.g., N-ethylsulfamoyl, N-(3-dodecyloxypropyl)sulfamoyl, N,N-dimethylsulfamoyl, N-acetylsulfamoyl, N-benzoylsulfamoyl, N-(N′-phenylcarbamoyl)sulfamoyl), a sulfo group, an alkyl- or arylsulfinyl group (preferably a substituted or unsubstituted alkylsulfinyl group having from 1 to 30 carbon atoms, or a substituted or unsubstituted arylsulfinyl group having from 6 to 30 carbon atoms, e.g., methylsulfinyl, ethylsulfinyl, phenylsulfinyl, p-methylphenylsulfinyl), an alkyl- or arylsulfonyl group (preferably a substituted or unsubstituted alkylsulfonyl group having from 1 to 30 carbon atoms, or a substituted or unsubstituted arylsulfonyl group having from 6 to 30 carbon atoms, e.g., methylsulfonyl, ethylsulfonyl, phenylsulfonyl, p-methylphenylsulfonyl), an acyl group (preferably a formyl group, a substituted or unsubstituted alkylcarbonyl group having from 2 to 30 carbon atoms, a substituted or unsubstituted arylcarbonyl group having from 7 to 30 carbon atoms, or a substituted or unsubstituted heterocyclic carbonyl group having from 4 to 30 carbon atoms and being bonded to a carbonyl group through the carbon atom, e.g., acetyl, pivaloyl, 2-chloroacetyl, stearoyl, benzoyl, p-n-octyloxyphenylcarbonyl, 2-pyridylcarbonyl, 2-furylcarbonyl), an aryloxycarbonyl group (preferably a substituted or unsubstituted aryloxycarbonyl group having from 7 to 30 carbon atoms, e.g., phenoxycarbonyl, o-chlorophenoxycarbonyl, m-nitrophenoxycarbonyl, p-tert-butylphenoxycarbonyl), an alkoxycarbonyl group (preferably a substituted or unsubstituted alkoxycarbonyl group having from 2 to 30 carbon atoms, e.g., methoxycarbonyl, ethoxycarbonyl, tert-butoxycarbonyl, n-octadecyloxycarbonyl), a carbamoyl group (preferably a substituted or unsubstituted carbamoyl group having from 1 to 30 carbon atoms, e.g., carbamoyl, N-methylcarbamoyl, N,N-dimethylcarbamoyl, N,N-di-n-octylcarbamoyl, N-(methylsulfonyl)carbamoyl), an aryl or heterocyclic azo group (preferably a substituted or unsubstituted arylazo group having from 6 to 30 carbon atoms, or a substituted or unsubstituted heterocyclic azo group having from 3 to 30 carbon atoms, e.g., phenylazo, p-chlorophenylazo, 5-ethylthio-1,3,4-thiadiazol-2-ylazo), an imido group (preferably N-succinimido or N-phthalimido), a phosphino group (preferably a substituted or unsubstituted phosphino group having from 2 to 30 carbon atoms, e.g., dimethylphosphino, diphenylphosphino, methylphenoxyphosphino), a phosphinyl group (preferably a substituted or unsubstituted phosphinyl group having from 2 to 30 carbon atoms, e.g., phosphinyl, dioctyloxyphosphinyl, diethoxyphosphinyl), a phosphinyloxy group (preferably a substituted or unsubstituted phosphinyloxy group having from 2 to 30 carbon atoms, e.g., diphenoxyphosphinyloxy, dioctyloxyphosphinyloxy), a phosphinylamino group (preferably a substituted or unsubstituted phosphinylamino group having from 2 to 30 carbon atoms, e.g., dimethoxyphosphinylamino, dimethylaminophosphinylamino), a phospho group, a silyl group (preferably a substituted or unsubstituted silyl group having from 3 to 30 carbon atoms, e.g., trimethylsilyl, tert-butyldimethylsilyl, phenyldimethylsilyl), a hydrazino group (preferably a substituted or unsubstituted hydrazino group having from 0 to 30 carbon atoms, e.g., trimethylhydrazino), or a ureido group (preferably a substituted or unsubstituted ureido group having from 0 to 30 carbon atoms, e.g., N,N-dimethylureido).

Two Wa's may form a ring in cooperation (an aromatic or non-aromatic hydrocarbon or heterocyclic ring or a polycyclic condensed ring comprising a combination of these rings may be formed and examples thereof include a benzene ring, a naphthalene ring, an anthracene ring, a phenanthrene ring, a fluorene ring, a triphenylene ring, a naphthacene ring, a biphenyl ring, a pyrrole ring, a furan ring, a thiophene ring, an imidazole ring, an oxazole ring, a thiazole ring, a pyridine ring, a pyrazine ring, a pyrimidine ring, a pyridazine ring, an indolizine ring, an indole ring, a benzofuran ring, a benzothiophene ring, an isobenzofuran ring, a quinolidine ring, a quinoline ring, a phthalazine ring, a naphthylidine ring, a quinoxaline ring, a quinoxazoline ring, an isoquinoline ring, a carbazole ring, a phenanthridine ring, an acridine ring, a phenanthroline ring, a thianthrene ring, a chromene ring, a xanthene ring, a phenoxathiine ring, a phenothiazine ring and a phenazine ring).

Among these substituents Wa, those having a hydrogen atom may be deprived of the hydrogen atom and substituted by the above-described group. Examples of such a substituent include —CONHSO₂-group (e.g., sulfonylcarbamoyl group, carbonylsulfamoyl group), —CONHCO-group (e.g., carbonylcarbamoyl group) and —SO₂NHSO₂- group (e.g., sulfonylsulfamoyl group).

Specific examples thereof include an alkylcarbonylaminosulfonyl group (e.g., acetylaminosulfonyl), an arylcarbonylaminosulfonyl group (e.g., benzoylaminosulfonyl), an alkylsulfonylaminocarbonyl group (e.g., methylsulfonylaminocarbonyl) and an arylsulfonylaminocarbonyl group (e.g., p-methylphenylsulfonylaminocarbonyl).

The compound (A) to be used in the invention is described below.

The compound (A) is a compound capable of releasing a compound which can increase sensitivity (sensitizing compound). Mechanism of releasing the sensitizing compound may be any one, but hydrolysis of the compound (A) is preferred. In particular, those which release the sensitizing compound with environmental change as a start are more preferred than those which gradually release it during storage. Compounds which release the sensitizing compound upon photographic processing at a rate 10 times as much as the releasing rate or more than that upon storage are preferred, with compounds which release the sensitizing compound upon photographic processing at a rate 100 times as much as the releasing rate or more than that upon storage being more preferred.

As a reaction employable for releasing the sensitizing compound, any reaction that is known in the chemical and photographic fields can be utilized. Examples thereof include a nucleophilic reaction, an electrophilic reaction, an oxidation reaction and a reduction reaction. Of these, a nucleophilic reaction is preferred, with a hydrolysis reaction to be caused by change in pH upon photographic processing being particularly preferred.

The nucleophilic reaction is described in more detail below. The nucleophilic reaction can take place under any condition, and is accelerated with a base or by heating, particularly in the presence of a base. As such base, any base may be employed, and a proper one can be selected from among inorganic bases and organic bases. Examples thereof include tertiary amines such as triethylamine, aromatic hetero ring amines such as pyridine and bases having OH anion such as sodium hydroxide and potassium hydroxide. Particularly, in the invention, the nucleophilic reaction is accelerated in photographic processing conducted at a high pH as in a developing solution, hence the bases being preferably usable.

The nucleophilic agent as used herein means a chemical species which attacks an atom with a low electron density, such as carbonyl carbon, contained in the atoms forming a group to be attacked and released by the nucleophilic agent, thus giving or sharing electron. The nucleophilic agent may have any structure, and preferred examples thereof include a reagent yielding a hydroxide ion (e.g., sodium hydroxide, potassium hydroxide, lithium hydroxide, sodium carbonate or potassium carbonate), a reagent yielding a sulfite ion (e.g., sodium sulfite or potassium sulfite), a reagent yielding a hydroxylamide ion (e.g., hydroxylamine), a reagent yielding a hydrazide ion (e.g., hydrazine hydrate or a dialkylhydrazine), a reagent yielding a hexacyanoferrate (II) ion (e.g., yellow prussiate), and a reagent yielding a cyanide ion, a tin (II) ion, ammonia or an alkoxy ion (e.g., sodium methoxide). Examples of a group to be eliminated upon attack of the nucleophilic agent include a group utilizing the reverse Michael type reaction described in Can. J. Chem., vol. 44, p. 2315 (1966), JP-A-59-137,945 and JP-A-60-41,034, a group described in Chem. Lett., p. 585 (1988), and a group utilizing hydrolysis reaction of an ester bond or an amide bond.

The sensitizing compound which increases sensitivity in comparison with the case of not adding the compound may be any compound that can increase sensitivity, with a hetero ring compound being particularly preferred. The hetero ring compound may have any hetero ring, and may have a polycyclic hetero ring structure wherein a benzene ring or other hetero ring is condensed with the hetero ring. As the hetero ring, hetero rings having one or two hetero atoms are preferred. With such ring, the hetero atom means other atom than carbon atom and hydrogen atom. The hetero ring means a cyclic compound having at least one hetero atom in the atoms forming the ring. The hetero atom or atoms in “the hetero ring containing one or two hetero atoms” means only atom or atoms forming the ring-constituting moiety of the hetero ring and does not mean atom or atoms positioned in the outer moiety of the ring, separated from the ring system through at least one non-conjugated single bond or constituting part of a further substituent of the ring system.

Also, with the polycyclic ring, those wherein the number of hetero atoms contained in the whole ring system is 1 or 2 are more preferred.

Any hetero ring compound that satisfies these requirements may be used. Preferred examples of the hetero atom include nitrogen atom, sulfur atom, oxygen atom, selenium atom, tellurium atom, phosphorus atom, silicon atom and boron atom, more preferred examples thereof include nitrogen atom, sulfur atom, oxygen atom and selenium atom, and still more preferred examples thereof include nitrogen atom, sulfur atom and oxygen atom, and particularly preferred examples thereof include nitrogen atom and sulfur atom, with nitrogen atom being most preferred.

The number of the hetero ring-forming members may be any number, but 3- to 8-membered rings are preferred, 5- to 7-membered rings are more preferred, 5- and 6-membered rings are particularly preferred, and a 5-membered ring is most preferred.

The hetero ring may be saturated or unsaturated, but hetero rings having at least one unsaturated part are preferred, with hetero rings having two unsaturated parts being more preferred. In other words, the hetero rings may be any of aromatic, pseudo-aromatic and non-aromatic hetero rings, with aromatic hetero rings and pseudo-hetero rings being preferred.

Specific examples of these hetero rings include a pyrrole ring, a thiophene ring, a furan ring, an imidazole ring, a triazole ring, a tetrazole ring, a pyrazole ring, a thiazole ring, an isothiazole ring, a thiadiazole ring, a thiatriazole ring, an oxazole ring, an isoxazole ring, an oxadiazole ring, a pyridine ring, a pyrazine ring, a pyrimidine ring, a pyridazine ring, an indolidine ring, benzo-condensed ones thereof such as an indole ring, a benzofuran ring, a benzothiophene ring, an isobenzofuran ring, a quinolidine ring, a quinoline ring, a phthalazine ring, a quinoxaline ring, an isoquinoline ring, a carbazole ring, a phenanthridine ring, a phenanthroline ring and an acridine ring, and partially or totally saturated ones thereof such as a pyrrolidine ring, a pyroline ring and an imidazoline ring.

Examples of typical hetero rings are shown below.

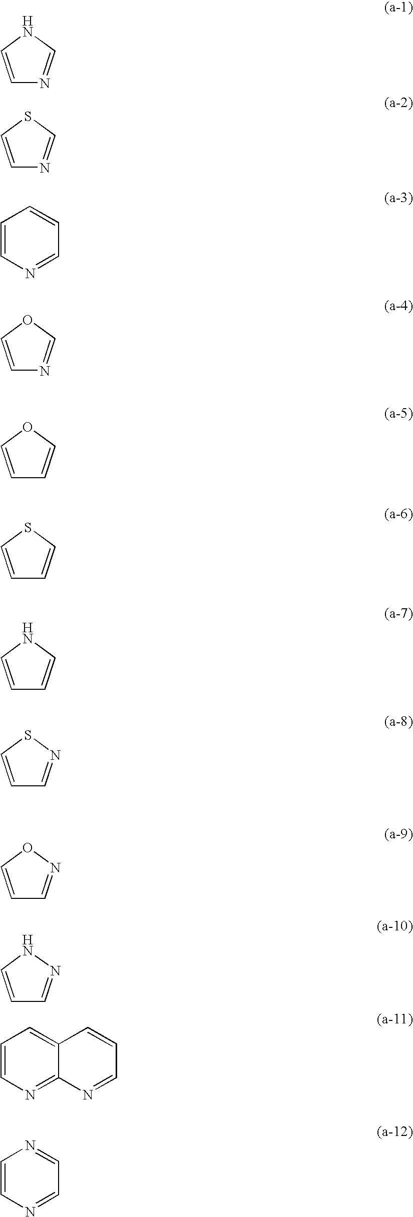

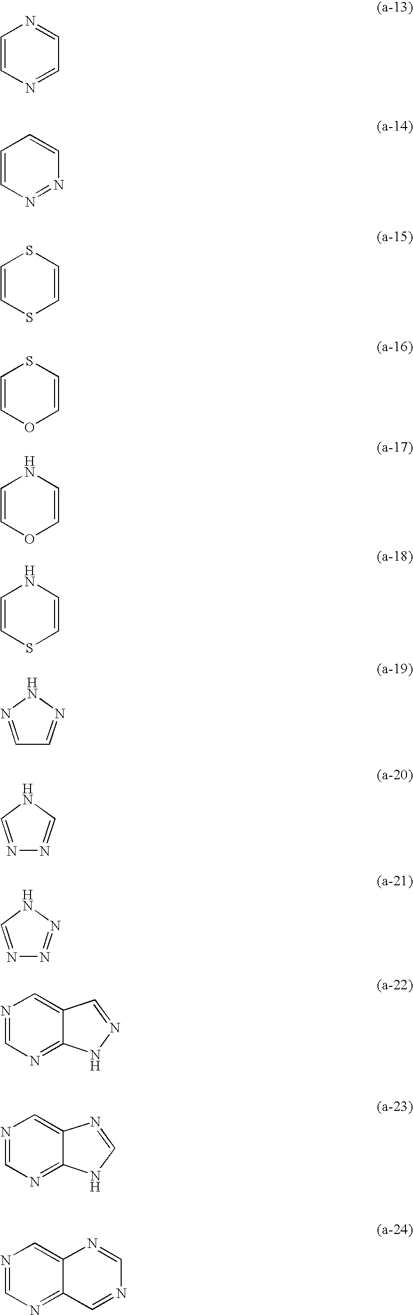

Examples of benzene ring-condensed hetero rings include the following.

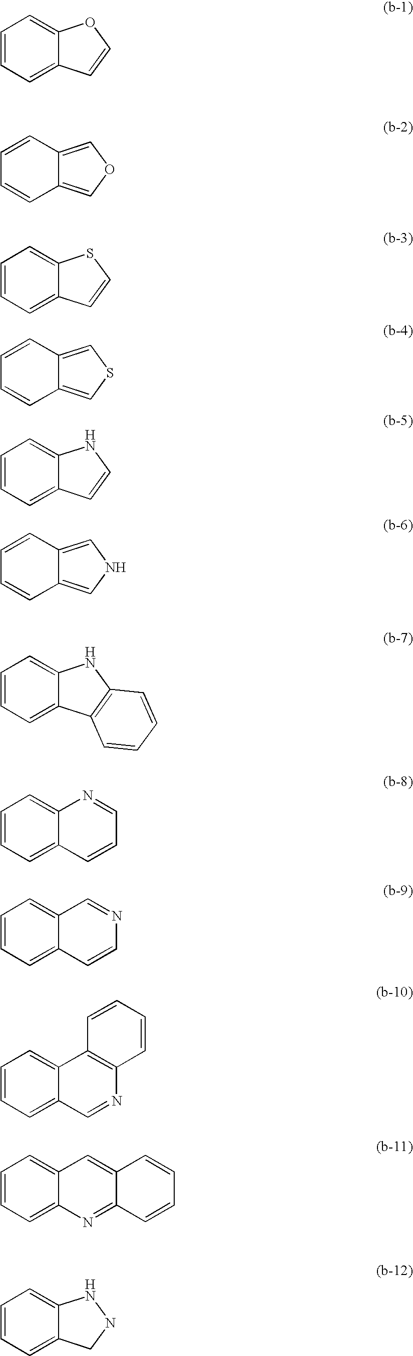

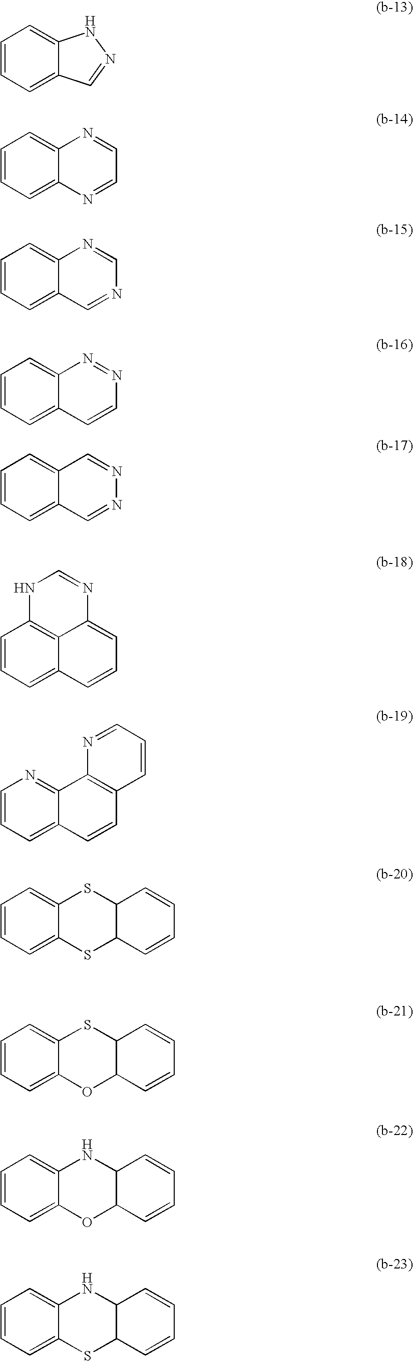

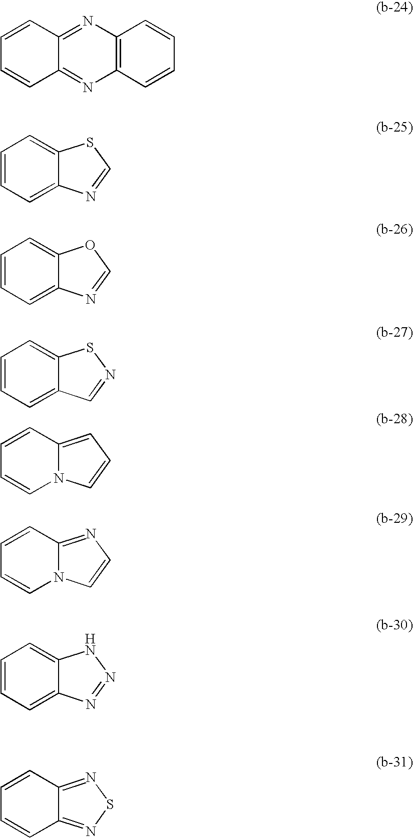

Examples of partially or totally saturated hetero rings include the following.

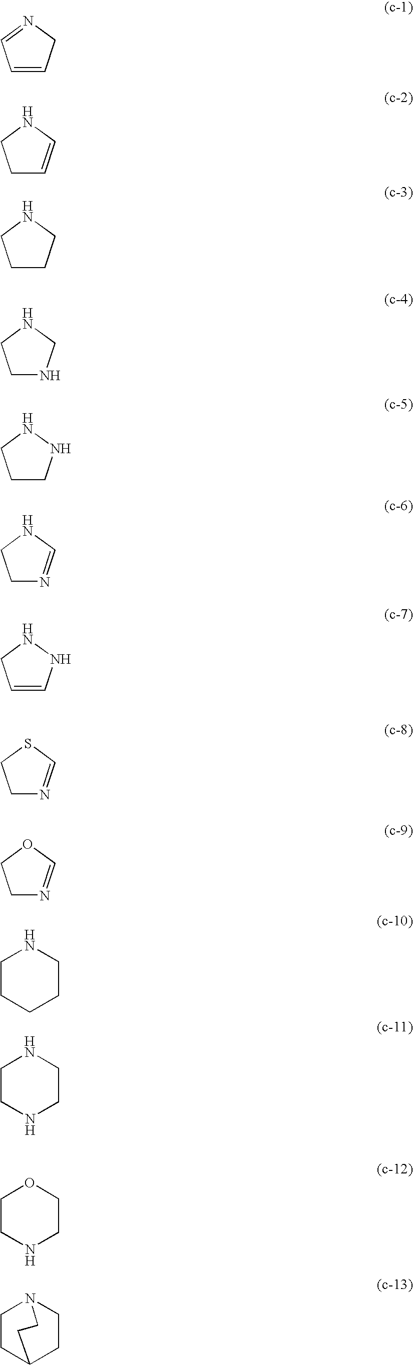

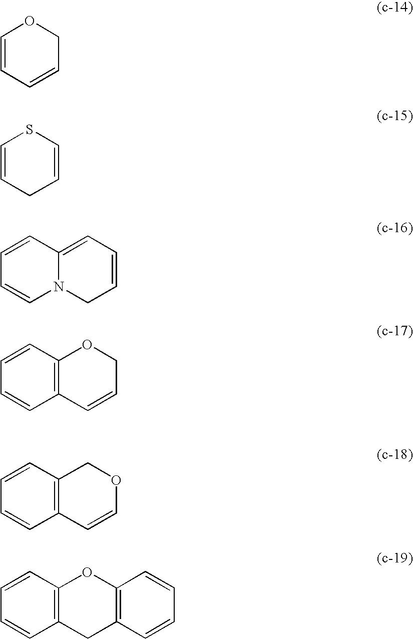

In addition, the following hetero rings can be used as well.

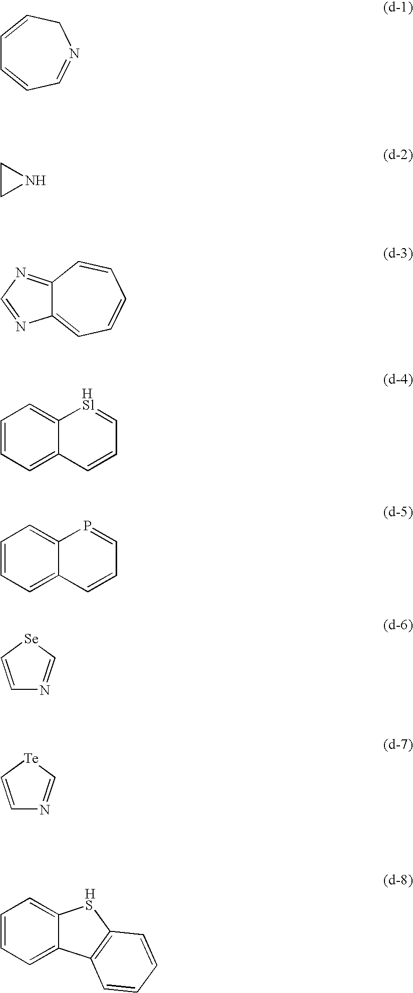

These hetero rings may have any substituent or may form a condensed ring system, and examples of the substituent include those described as foregoing Wa. Also, the tertiary nitrogen atom may be substituted to form a quaternary nitrogen atom. Additionally, the hetero ring can be expressed in other tautomeric structure, and all of the tautomeric structures are chemically equivalent.

Preferably, however, the compound moiety to be released and increase sensitivity is not substituted by a free thiol group (—SH) and a thiocarbonyl group (>C═S).

Of the above-described hetero rings, (a-1) to (a-4) are preferred. With (a-2), (b-25) wherein the hetero ring is condensed with a benzene ring is more preferred.

Additionally, the compound (A) of the invention may or may not react with an oxidized developing agent, but it is more preferred to use a hetero ring compound which does not react with the oxidized developing agent.

That is, those which do not remarkably cause direct chemical reaction or redox reaction with the oxidized developing agent (5 to less than 10%) are preferred and, further, those which are not couplers and which do not react with the oxidized developing agent to form a dye or any other product are preferred.

Reactivity between the compound of the invention and the oxidized developing agent (CRV) is determined in the following manner.

A light-sensitive material (A¹) for evaluation was exposed to white light and was processed in the same manner as that described in Example 1 except for changing the processing time in the color-developing step to 1 minute and 15 seconds. The magenta density and the cyan density of this light-sensitive material were measured and were compared with the magenta density and the cyan density of a light-sensitive material not containing the compound of the invention to determine the differences therebetween. In view of improvement of sensitivity/graininess ratio, CRV is preferably 0.01 or less, more preferably 0.

Light-Sensitive Material (A¹) for Evaluation

(Support) Cellulose Triacetate

(Emulsion layer)

| | | |
|---|---|---|
| Em-D | 1.07 | g/m² as Ag |
| Gelatin | 2.33 | g/m² |
| ExC-1 | 0.76 | g/m² |
| ExC-4 | 0.42 | g/m² |
| tricresyl phosphate | 0.62 | g/m² |
| compound of the invention | 3.9 × 10⁻⁴ | mol/m² |

(Protective layer)

| | | |
|---|---|---|
| gelatin | 2.00 | g/m² |
| H-1 | 0.33 | g/m² |
| B-1 (diameter: 1.7 μm) | 0.10 | g/m² |
| B-2 (diameter: 1.7 μm) | 0.30 | g/m² |
| B-3 | 0.10 | g/m² |

Characteristic properties of the emulosion, Em-D, used in the light-sensitive material (A¹) for evaluation and structural formulae of the compounds are shown in columns of Example 1 to be described hereinafter.

As the compound (A) which releases a compound capable of increasing sensitivity when added in comparison with the case of not adding it, compounds represented by the general formula (A-I) or (A-II) are preferred.

As the substituent for the compound (A) of the invention, any substituent that is used in the art for obtaining desired photographic properties suited for a specific use can be selected. Examples thereof include a hydrophobic group (a ballast group), a solubilizing group, a blocking group and a releasing or releasable group. In general, these groups contain preferably from 1 to 60 carbon atoms, more preferably from 1 to 50 carbon atoms.

In order to control migration of the compound (A) of the invention in the light-sensitive material, it is preferred to contain within the molecule a high-molecular hydrophobic group or ballast group or a polymeric main chain.

The number of carbon atoms in the typical ballast group is preferably from 8 to 60, more preferably from 10 to 57, particularly preferably from 12 to 55, most preferably from 16 to 53. Examples of these substituents include substituted or unsubstituted alkyl, aryl and hetero ring groups containing from 8 to 60 carbon atoms, preferably from 10 to 57 carbon atoms, more preferably from 13 to 55 carbon atoms, particularly preferably from 16 to 53 carbon atoms, most preferably from 20 to 50 carbon atoms. These substituents preferably contain a branched moiety. Typical examples on the groups include an alkyl group, an aryl group, an alkoxy group, an aryloxy group, an alkylthio group, a hydroxyl group, a halogen atom, an alkoxycarbonyl group, an aryloxycarbonyl group, a carboxy group, an acyl group, an acyloxy group, an amino group, an anilino group, a carbonamido group, a carbamoyl group, an alkylsulfonyl group, an arylsulfonyl group, a sulfonamido group and a sulfamoyl group. These substituents contain generally from 1 to 42 carbon atoms. For example, there are illustrated those described hereinbefore as Wa. Such substituents may further be substituted.

Specific examples of the ballast group include the substituents containing 8 or more carbon atoms shown as specific examples of aforesaid Wa.

In the case of incorporating the compound (A) of the invention in a silver halide photographic light-sensitive material, it is a preferred case wherein a compound is used which can be immobilized in a specific layer during storage and can diffuse at a suitable stage of photographic processing (preferably upon development processing). In order to immobilize the compound of the invention for preventing diffusion thereof during storage, any compound or any method may be employed. However, the following compounds and methods are preferred.

(1) A method of emulsifying and dispersing the compound (A) of the invention together with a high-boiling organic solvent and adding the resulting emulsion dispersion to thereby dissociate and dissolve out the compound (A) of the invention only upon development.

The compound (A) of the invention preferably has a substituent at least one pKa of which is 4.0 or more, more preferably 4.5 or more to 11.0 or less, particularly preferably from 4.8 or more to 10.0 or less. Specific example of a method of measuring pKa is described hereinafter.

As a dissosiative group, any group may be employed. Preferred examples thereof include a carboxyl group, a —CONHSO₂- group (sulfonylcarbamoyl group or carbonylsulfamoyl group), a —CONHCO-group (carbonylcarbamoyl group), a —SO₂NHSO₂-group (sulfonylsulfamoyl group), a —NHCONHSO₂-group (carbamoylsulfamoyl group or sulfonylureido group), a —NHSO₂-group (sulfonamido group or sulfamoyl group) and a phenolic hydroxyl group, with a carboxyl group, —CONHSO₂-group, a —NHCONHSO₂-group and a —NHSO₂-group being more preferred.

(2) A method of introducing a ballast group into the compound of the invention to render it diffusion-resistant.

(3) A method of using a blocking group.

Compounds which undergo change in properties (e.g., becoming diffusible) by a chemical reaction such as the nucleophilic reaction, electrophilic reaction, oxidation reaction or reduction reaction during the photographic processing step can be employed. The chemistry relating thereto and any method known in the photographic field can be utilized.

As one example, the nucleophilic reaction is described in detail. The nucleiphilic reaction may take place under any condition, and is accelerated with a base or by heating. The reaction is particularly accelerated in the presence of a base. As the base, any base may be employed and can be selected from inorganic bases and organic bases. Examples thereof include tertiary amines such as triethylamine, aromatic hetero ring amines such as pyridine, and bases having OH anion such as sodium hydroxide and potassium hydroxide. Particularly, in the invention, the nucleophilic reaction is accelerated in photographic processing conducted at a high pH as in a developing solution, hence the bases being preferably usable.

The nucleophilic agent as used herein means a chemical species which attacks an atom with a low electron density, such as carbonyl carbon, contained in the atoms forming a group to be attacked and released by the nucleophilic agent, thus giving or sharing electron. The nucleophilic agent may have any structure, and preferred examples thereof include a reagent yielding a hydroxide ion (e.g., sodium hydroxide, potassium hydroxide, lithium hydroxide, sodium carbonate or potassium carbonate), a reagent yielding a sulfite ion (e.g., sodium sulfite or potassium sulfite), a reagent yielding a hydroxylamide ion (e.g., hydroxylamine), a reagent yielding a hydrazide ion (e.g., hydrazine hydrate or a dialkylhydrazine), a reagent yielding a hexacyanoferrate (II) ion (e.g., yellow prussiate), and a reagent yielding a cyanide ion, a tin (II) ion, ammonia or an alkoxy ion (e.g., sodium methoxide). Examples of a group to be eliminated upon attack of the nucleophilic agent include a group utilizing the reverse Michael type reaction described in Can. J. Chem., vol. 44, p. 2315 (1966), JP-A-59-137,945 and JP-A-60-41,034, a group described in Chem. Lett., p. 585 (1988), and a group utilizing hydrolysis reaction of an ester bond or an amide bond.

In order to impart the above-mentioned function, the compound (A) of the invention may be substituted by a blocking group which releases the compound (A) of the invention during the photographic processing step. As the blocking group, known ones may be employed. Examples thereof include a blocking group such as an acyl group or a sulfonyl group described in JP-B-48-9968, JP-A-52-8828, JP-A-57-82834, U.S. Pat. No. 3,311,476 and JP-B-47-44805 (U.S. Pat. No. 3,615,617), a blocking group utilizing the reverse Michael reaction described in JP-B-55-17369 (U.S. Pat. No. 3,888,677), JP-B-55-9696 (U.S. Pat. No. 3,791,830), JP-B-55-34927 (U.S. Pat. No. 4,009,029), JP-A-56-77842 (U.S. Pat. No. 4,307,175), JP-A-59-105640, JP-A-59-105641 and JP-A-59-105642, a blocking group utilizing generation of quinonemethide or a quinonemethide-analogous compound by intramolecular electron transfer, described in JP-B-54-39727, U.S. Pat. Nos. 3,674,478, 3,932,480 and 3,993,661,JP-A-57-135944, JP-A-57-135945, (U.S. Pat. No. 4,420,554), JP-A-57-136640, JP-A-61-196239, JP-A-61-196240 (U.S. Pat. No. 4,702,999), JP-A-61-185743, JP-A-61-124941 (U.S. Pat. No. 4,639,408) and JP-A-2-280140, a blocking group utilizing intramolecular nucleophilic substitution reaction, described in U.S. Pat. Nos. 4,358,525 and 4,330,617, JP-A-55-53330 (U.S. Pat. No. 4,310,612), JP-A-59-121328, JP-A-59-218439 and JP-A-63-318555 (EP-A-0295729), a blocking group utilizing a 5- or 6-membered ring-opening reaction, described in JP-A-57-76541 (U.S. Pat. No. 4,335,200), JP-A-57-135949 (U.S. Pat. No. 4,350,752), JP-A-57-179842, JP-A-59-137945, JP-A-59-140445, JP-A-59-219741, JP-A-59-202459, JP-A-60-41034 (U.S. Pat. No. 4,618,563), JP-A-62-59945 (U.S. Pat. No. 4,888,268, JP-A-62-65039 (U.S. Pat. No. 4,772,537), JP-A-62-80647, JP-A-3-236047 and JP-A-3-238445, a blocking group utilizing addition reaction of a nucleophilic agent to a conjugated unsaturated bond, described in JP-A-59-201057 (U.S. Pat. No. 4,518,685), JP-A-61-43739 (U.S. Pat. No. 4,659,651), JP-A-61-95346 (U.S. Pat. No. 4,690,885), JP-A-61-95347 (U.S. Pat. No. 4,892,811), JP-A-64-7035, JP-A-4-42650 (U.S. Pat. No. 5,066,573), JP-A-1-245255, JP-A-2-207249, JP-A-2-235055 (U.S. Pat. No. 5,118,596) and JP-A-4-186344, a blocking group utilizing ,-elimination reaction, described in JP-A-59-93442, JP-A-61-32839, JP-A-62-163051 and JP-B-5-37299, a blocking group utilizing nucleophilic substitution reaction of a diarylmethane, described in JP-A-61-188540, a blocking group utilizing Lossen rearrangement reaction, described in JP-A-62-187850, a blocking group utilizing reaction between an N-acyl derivative of thiazolidine-2-thione and an amine, described in JP-A-62-80646, JP-A-62-144163 and JP-A-62-147457 and a blocking group having two electrophilic groups and capable of reacting with a dinucleophile reagent, described in JP-A-2-296240 (U.S. Pat. No. 5,019,492), JP-A-4-177243, JP-A-4-177244, JP-A-4-177245, JP-A-4-177246, JP-A-4-177247, JP-A-4-177248, JP-A-4-177249, JP-A-4-179948, JP-A-4-184337, JP-A-4-184338, WO92/21064, JP-A-4-330438, WO93/03419 and JP-A-5-45816. Of these blocking agents, a blocking group having two electrophilic groups and capable of reacting with a dinucleophile reagent, described in JP-A-2-296240 (U.S. Pat. No. 5,019,492), JP-A-4-177243, JP-A-4-177244, JP-A-4-177245, JP-A-4-177246, JP-A-4-177247, JP-A-4-177248, JP-A-4-177249, JP-A-4-179948, JP-A-4-184337, JP-A-4-184338, WO92/21064, JP-A-4-330438, WO93/03419 and JP-A-5-45816, is preferred. Also, these blocking groups may contain a timing group which can cause cleavage reaction utilizing the electron transfer reaction, described in U.S. Pat. No. 4,409,323 or 4,421,845. In this case, it is preferred to block the terminus of the timing group causing the electron transfer reaction.

(4) A method of using a dimer or a polymer compound of 3 or more in number of repeating unit, containing the partial structure of the compound (A) of the invention.

(5) A method of immobilizing using a water-insoluble compound of the invention (solid dispersion). As is described in (1), the compound of the invention having a specific pKa is preferred because it dissolves only upon development. Examples of using a water-insoluble dye solid (solid dispersion) are described in JP-A-56-12639, JP-A-55-155350, JP-A-55-155351, JP-A-63-27838, JP-A-63-197943 and EP No. 15,601.

Method for dispersing a solid will be described hereinafter.

(6) A method of immobilizing the compound (A) of the invention by allowing to coexist as a mordant a polymer having an opposite electric charge to that of the compound (A) of the invention. Examples of immobilizing a dye are disclosed in U.S. Pat. Nos. 2,548,564, 4,124,386 and 3,625,694.

(7) A method of immobilizing the compound (A) of the invention by adsorbing it on a metal salt such as silver halide. Examples of immobilizing a dye are disclosed in U.S. Pat. Nos. 2,719,088, 2,496,841 and 2,496,843 and JP-A-60-45237.

As the silver halide-adsorptive group to be used in the compound (A) of the invention, those groups which are described in JP-A-2003-156823, page 16, right column, line 1 to page 17, right column, line 12 are typical examples.

The adsorptive group is preferably a mercapto-substituted, nitrogen-containing hetero ring group (e.g., a 2-mercaptothiadiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzothiazole group or a 1,5-dimethyl-1,2,4-triazolium-3-thiolate group) or a nitrogen-containing hetero ring group having —NH-group capable of forming iminosilver (>Nag) as a partial structure of the hetero ring (e.g., a benzotriazole group, a benzimidazole group or an indazole group). Of these, a 5-mercaptotetrazole group, a 3-mercapto-1,2,4-triazole group and a benzotriazole group are particularly prefereed, with a 3-mercapto-1,2,4-triazole group and a 5-mercaptotetrazole group being most preferred.

Compounds having two or more mercapto groups as partial structure within the molecule, as the adsorptive groups, are also particularly preferred. Here, the mercapto group (—SH) may be in a form of thione group when tautomerism is possible. Preferred examples of the adsorptive group having two or more mercapto groups as a partial structure (e.g., dimercapto-substituted, nitrogen-containing hetero ring group) include a 2,4-dimercaptopyrididine group, a 2,4-dimercaptotriazine group and a 3,5-dimercapto-1,2,4-triazole group.

Also, a quatemary salt structure of nitrogen or phosphorus is preferably employed as the adsorptive group. Specific examples of the quaternary salt structure of nitrogen include an ammonio group (e.g., a trialkylammonio group, a dialkylaryl(or heteroaryl)ammonio group or an alkyldiaryl(orheteroaryl)ammonio group) and a group containing a hetero ring group containing a quaternized nitrogen atom. Examples of the quatemary salt structure of phosphorus include a phosphonio group (e.g., a trialkylphosphonio group, a dialkylaryl(or heteroaryl)phosphonio group, an alkyldiaryl(or heteroaryl)phosphonio group and a triaryl(or heteroaryl)phosphonio group), etc. More preferably, a quaternary salt structure of nitrogen is employed and, more preferably, a 5- or 6-membered, nitrogen-containing aromatic hetero ring group containing a quaternized nitrogen atom is employed. Particularly preferably, a pyridinio group, a quinolinio group and an isoquinolinio group are employed. These nitrogen-containing hetero ring groups containing a quaternized nitrogen atom may have an arbitrary substituent.

Examples of the counter ion for the quatemary salt include halide ion, carboxylate ion, sulfonate ion sulfate ion, perchlorate ion, carbonate ion, nitrate ion, BF₄⁻, PF₆⁻and Ph₄B⁻. In the case where a group having a negative charge such as a carboxylate group exists within the molecule, an intramolecular salt may be formed with such group. As a counter ion not existing within the molecule, a chloride ion, a bromide ion or a methanesulfonate ion is particularly preferred.

Of the above-described methods, method (1) of using a compound having a specific pKa, method (2) of using a compound having a ballast group, method (3) of using a compound having a blocking group and method (5) of using a solid dispersion are preferred as the method of immobilizing the compound (A) of the invention. It is useful to use a compound adapted for each method. More preferred are methods (1), (2) and (3) and compounds for the methods, and still more preferred are methods (1) and (2) and compounds for the methods. It is most preferred to employ both methods (1) and (2). That is, compound (A) of the invention having a specific pKa and a ballast group can most preferably be used.

Preferred examples of the compound (A) of the invention are compounds represented by the foregoing general formula (A-I) or (A-II).

In the general formula (A-I), Zₐ represents a group forming a hetero ring containing 1 or 2 hetero atoms including nitrogen atom. Aₐ represents an alkyl group, an alkenyl group, a cycloalkyl group, an aryl group, an alkylamino group, an arylamino group or an alkoxy group.

In the general formula (A-II), Aₐ represents an alkyl group, an alkenyl group, a cycloalkyl group, an aryl group, an alkylamino group, an arylamino group or an alkoxy group. Bₐ represents a hetero ring group.

Hereinafter, the general formulae (A-I) and (A-II) are described in detail.

Aa represents an alkyl group (containing preferably from 1 to 60 carbon atoms; e.g., methyl, ethyl, propyl, iso-propyl, t-butyl, t-octyl, 1-ethylhexyl, nonyl, cyclohexyl, undecyl, pentadecyl, n-hexadecyl or 3-decanamidopropyl), ankenyl group (containing preferably from 2 to 60 carbon atoms; e.g., vinyl, allyl or oleyl), a cycloalkyl group (containing preferably from 5 to 60 carbon atoms; e.g., cyclopentyl, cyclohexyl, 4-t-butylcyclohexyl, 1-indanyl or cyclododecyl), an aryl group (containing preferably from 6 to 60 carbon atoms; e.g., phenyl, p-tolyl or naphthyl), an alkylamino group (containing preferably from 1 to 60 carbon atoms; e.g., methylamino, diethylamino, octylamino or octadecylamaino) or an arylamino group (containing preferably from 6 to 60 carbon atoms; e.g., phenylamino, naphthylamino or N-methyl-N-phenylamino) or an alkoxy group (containing preferably from 1 to 60 carbon atoms; e.g., methoxy, ethoxy, butoxy, n-octyloxy, hexadecyloxy or methoxyethoxy).

Aₐ may further have a substituent and, as the substituent, there are illustrated those which have been shown with respect to foregoing Wa.

In the general formula (A-I), the hetero ring formed by Zₐ is preferably an imidazole ring, a pyrrole ring, a pyrazole ring or a benzimidazole ring, more preferably an imidazole ring or a benzimidazole ring and, most preferably an imidazole ring. These rings may further be substituted by a substituent (for example, aforesaid Wa) or may be condensed with other ring.

In the general formula (A-II), examples of Ba include those described in (a-1) to (d-8), and similar ones are preferred. These may further be substituted by a substituent (for example, foregoing Wa) or may further be condensed with other ring.

These substituents are not limited as to total carbon number, but the carbon number is preferably from 8 to 60, more preferably from 10 to 57, particularly preferably from 12 to 55, most preferably from 14 to 53.

The compounds represented by the general formulae (A-I) and (A-II) are preferably compounds according to the aforesaid immobilizing methods (1) to (7), more preferably compounds according to the method (1), (2) or (3), particularly preferably compounds according to the method (1) or (2), most preferably compounds according to both the methods of (1) and (2). That is, compounds having a group with a specific pKa and a ballast group can most preferably be used.

The compound (A) of the invention may contain a necessary number of a necessary cation or anion when necessary for neutralizing the charge of the compound of the invention. Examples of typical cation include inorganic cations such as hydrogen ion (H⁺), alkali metal ion (e.g., sodium ion, potassium ion or lithium ion) and alkaline earth metal ion (e.g., calcium ion) and organic ions such as ammonium ion (e.g., ammonium ion, tetraalkylammonium ion, triethylammonium ion, pyridinium ion, ethylpyridinium ion or 1,8-diazabicyclo[5.4.0]-7-undecenium ion). The anion may be either of an inorganic anion and an organic anion, and is exemplified by a halide anion (e.g., fluoride ion, chloride ion or iodide ion), a substituted arylsulfonate ion (e.g., p-toluenesulfonate ion or p-chlorobenzenesulfonate ion), an aryldisulfonate ion (e.g., 1,3-benzenedisulfonate ion, 1,5-naphthalenedisulfonate ion or 2,6-naphthalenedisulfonate ion), an alkylsulfate ion (e.g., methylsulfate ion), sulfate ion, thiocyanate ion, perchlorate ion, tetrafluoroborate ion, picrate ion, acetate ion and trifluoromethanesulfonate ion. Further, an ionic polymer or other dye having an opposite charge to the dye may be used. In the case where CO²⁻ and SO₃⁻ have a hydrogen ion as a counter ion, they may be expressed as CO₂H and SO₃H, respectively.

Preferred examples of the compound (A) of the invention are combinations of the aforementioned individual matters (particularly, combinations of the most preferred individual matters). Compounds represented by the foregoing formula (A-I) and having a group with a specific pKa and a ballast group are particularly preferred.

Next, of the compounds (A) of the invention having been described in detail in the description on best mode for carrying out the invention, particularly preferred specific examples are shown below. It is needless to say that the invention is not limited only to them.

| | |
|---|---|
| 1 | 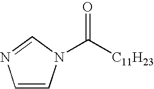 |
| 2 | 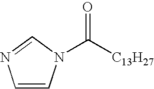 |
| 3 | 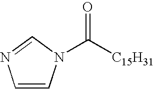 |
| 4 | 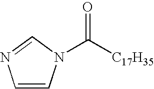 |
| 5 | 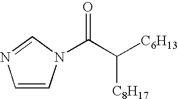 |
| 6 | 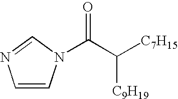 |
| 7 | 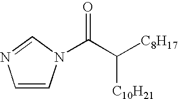 |
| 8 | 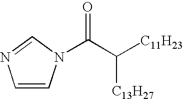 |
| 9 | 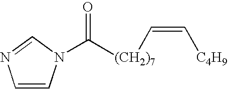 |
| 10 | 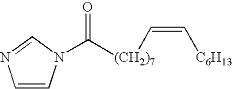 |
| 11 | 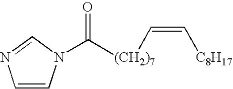 |
| 12 | 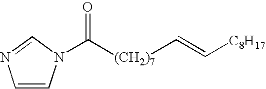 |
| 13 | 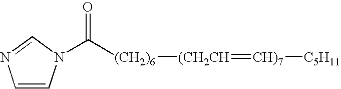 |
| 14 | 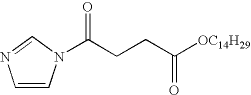 |
| 15 | 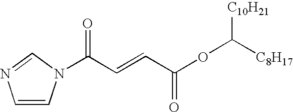 |
| 16 | 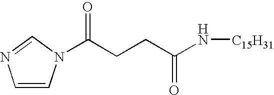 |
| 17 | 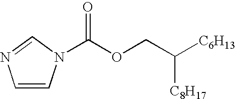 |
| 18 | 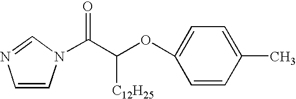 |
| 19 | 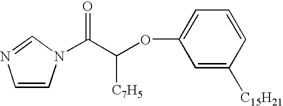 |
| 20 | 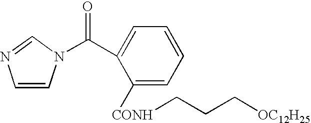 |
| 21 | 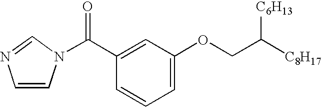 |
| 22 | 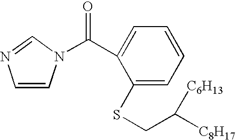 |
| 23 | 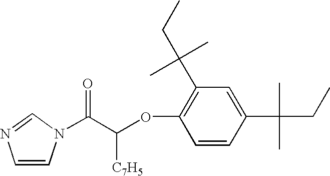 |
| 24 | 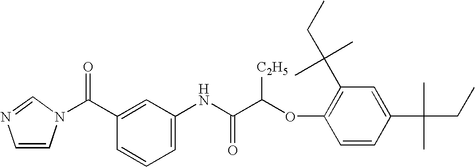 |
| 25 | 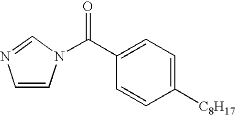 |
| 26 | 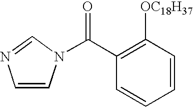 |
| 27 | 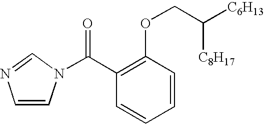 |
| 28 | 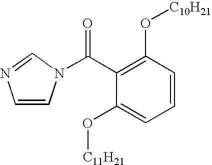 |
| 29 | 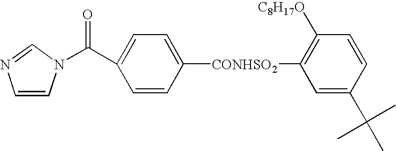 |
| 30 | 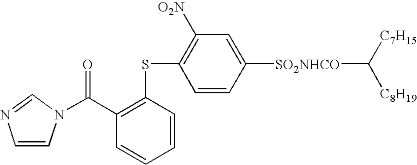 |
| 31 | 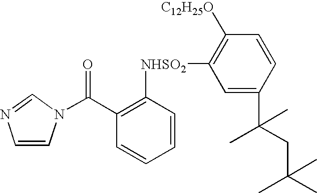 |
| 32 | 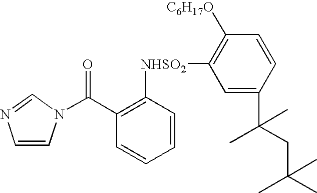 |
| 33 | 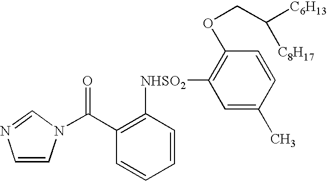 |
| 34 | 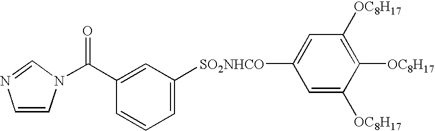 |
| 35 | 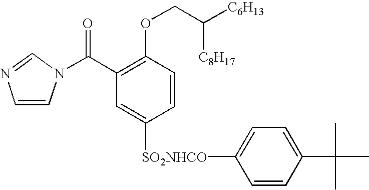 |
| 36 | 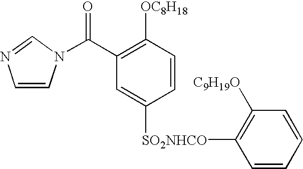 |
| 37 | 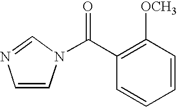 |
| 38 | 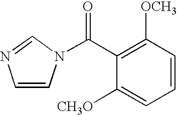 |
| 39 | 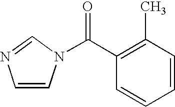 |
| 40 | 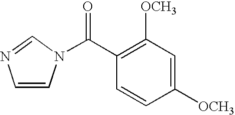 |
| 41 | 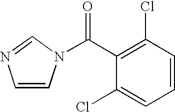 |
| 42 | 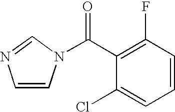 |
| 43 | 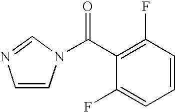 |
| 44 | 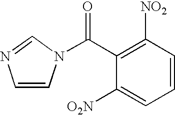 |
| 45 | 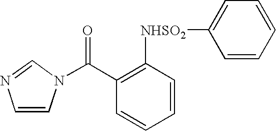 |
| 46 | 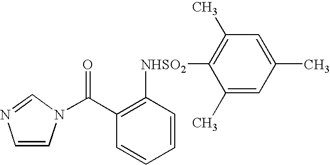 |
| 47 | 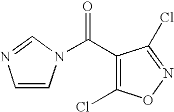 |
| 48 | 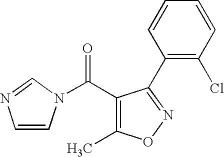 |
| 49 | 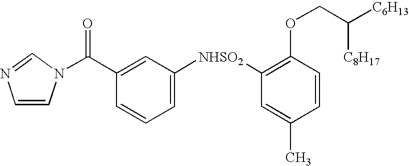 |
| 50 | 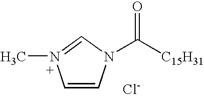 |
| 51 | 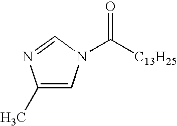 |
| 52 | 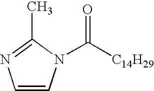 |
| 53 | 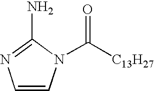 |
| 54 | 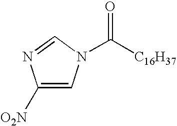 |
| 55 | 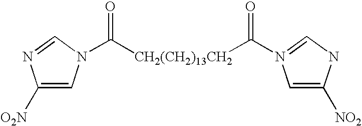 |
| 56 | 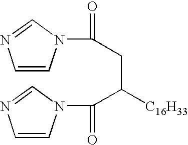 |
| 57 | 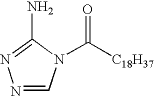 |
| 58 | 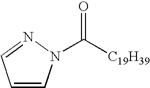 |
| 59 | 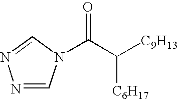 |
| 60 | 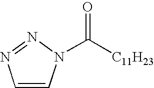 |
| 61 | 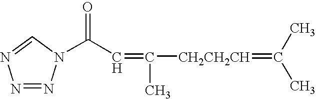 |
| 62 | 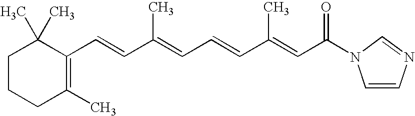 |
| 63 | 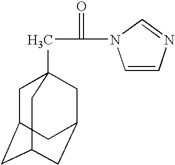 |
| 64 | 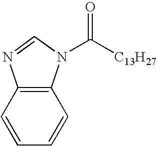 |
| 65 | 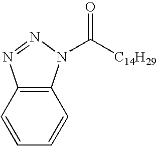 |
| 66 | 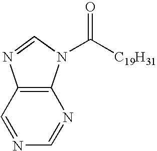 |
| 67 | 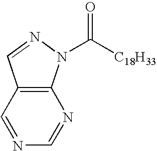 |
| 68 | 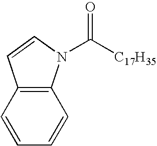 |
| 69 | 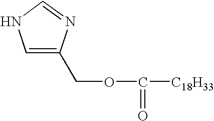 |
| 70 | 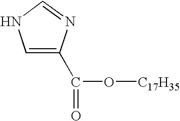 |
| 71 | 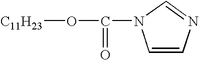 |
| 72 | 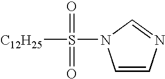 |
| 73 | 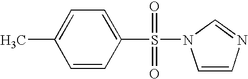 |
| 74 | 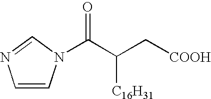 |
| 75 | 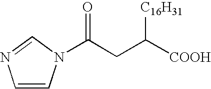 |
| 76 | 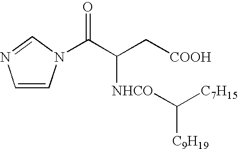 |
| 77 | 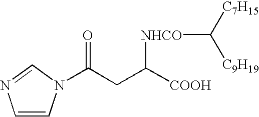 |
| 78 | 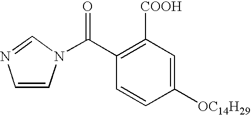 |
| 79 | 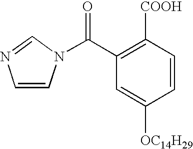 |
| 80 | 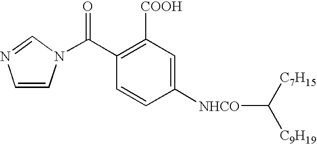 |
| 81 | 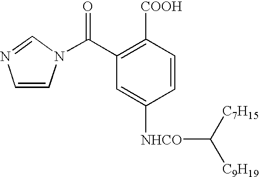 |
| 82 | 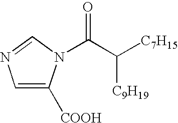 |
| 83 | 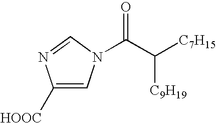 |
| 84 | 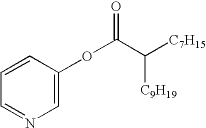 |
| 85 | 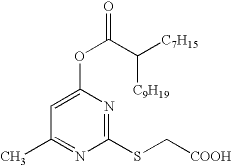 |
| 86 | 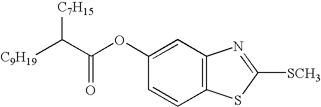 |

Additionally, in the case where the compound (A) of the invention has a plurality of asymmetric carbon atom, there exist a plurality of stereoisomers for one and the same structure. In this specification, all possible stereoisomers are shown and, in the invention, it is possible to use only one stereoisomer of the plural stereoisomers or to use several of them as a mixture.

The compounds (A) of the invention may be used independently or in combination thereof, with the number and kinds of compounds to be used being able to be arbitrarily selected.

As the compound (A) of the invention, compounds those which are described in The Chemistry of Heterocyclic Compounds—A series of Monographs, compiled by Edward C. Tailor and Arnold Weissberger, vols. 1 to 59 (published by John Wiley & Sons Co.) and Heterocyclic Compounds, vols. 1 to 6 (published by John Wiely & Sons Co.) and belong to the compounds (A) can be used. Also, the compounds (A) of the invention can be synthesized based on the processes described therein.

Synthesis examples of the compounds (A) of the invention are shown below.

Synthesis Example: Synthesis of Compound (2)

Compound (2) can be synthesized according to the scheme shown below.

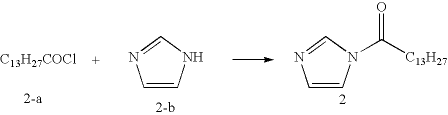

20.4 g of compound (2-b) and 200 milliliters (hereinafter also expressed as “mL”) of acetonitrile were stirred at an inside temperature of 5° C. or lower than that under cooling with ice, and 24.7 g of compound (2-a) was dropwise added thereto.

Further, after stirring for 3 hours at room temperature, 500 mL of ethyl acetate was added to the reaction solution, and the resulting solution was washed with and separated from an aqueous solution, then washed with and separated from a saturated sodium chloride aqueous solution. The ethyl acetate layer was dried over magnesium sulfate, and the solvent was distilled off under reduced pressure to concentrate the solution. Acetonitrile was added to the concentrate, and the mixture was stirred. Crystals formed were collected by suction filtration and dried to obtain 24.7 g of white crystals (2) (yield: 89%) (mp: 77-78° C.).

Synthesis Example: Synthesis of Compound (34)

Compound (34) can be synthesized according to the scheme shown below.

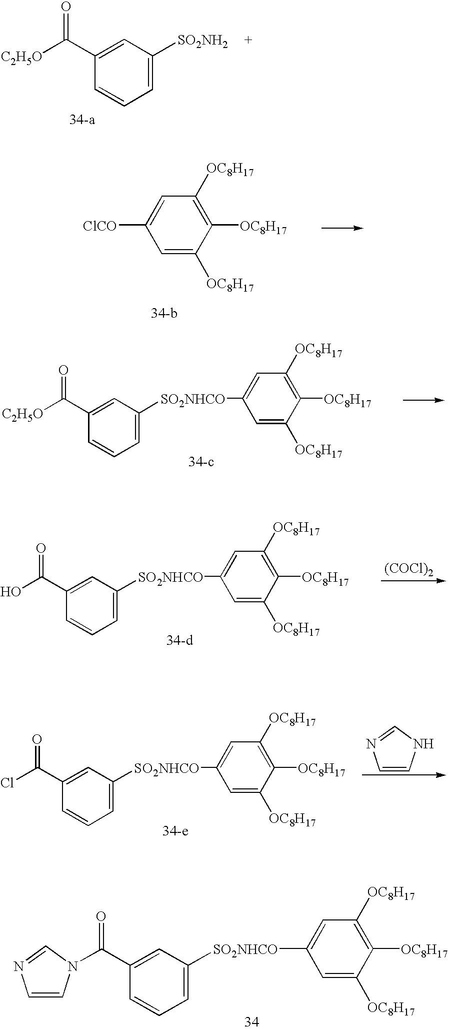

8.3 g of compound (34-a), 11.2 mL of triethylamine and 200 mL of acetonitrile were stirred at 5° C. or lower than that under cooling with ice, and a solution of 20.1 g of compound (34-b) in 100 mL of ethyl acetate was dropwise added thereto. After stirring for 3 hours at room temperature, 500 mL of ethyl acetate was added thereto, and the solution was washed with and separated from a dilute hydrochloric acid, further washed with and separated from a saturated sodium chloride aqueous solution. The ethyl acetate layer was dried over magnesium sulfate, and the solvent was distilled off under reduced pressure to concentrate the solution. The resulting concentrate was purified by silica gel column chromatography (eluent: hexane:acetone=4:1) to obtain 12.3 g of compound (34-c). (Yield: 47%)

12.3 g of compound (34-c), 200 mL of ethanol and 8.6 mL of 5N NaOH were stirred at 50° C. for 3 hours. Thereafter, 600 mL of ethyl acetate was added thereto, and the resulting solution was washed with and separated from dilute hydrochloric acid, further washed with and separated from a saturated sodium chloride aqueous solution. The resultant ethyl acetate layer was dried over magnesium sulfate, and the solvent was distilled off under reduced pressure to concentrate. Acetonitriled was added to the concentrate, followed by stirring the solution. Crystals precipitated were collected by suction filtration and dried to obtain 10.3 g of white crystals (34-d). (Yield: 88%)

10.3 g of compound (34-d), 50 mL of ethyl acetate and a catalytic amount of dimethylformamide were stirred at room temperature, and 1.9 mL of oxalyl chloride was dropwise added thereto. After stirring for 3 hours at room temperature, the reaction solution was concentrated under reduced pressure to obtain compound (34-e).

3.0 g of imidazole and 200 mL of acetonitrile were stirred at 5° C. or lower than that under cooling with ice, and a solution of compound (34-e) in 100 mL of ethyl acetate was dropwise added thereto. After stirring for 3 hours at room temperature, 500 mL of ethyl acetate was added thereto. The resultant solution was washed with and separated from dilute hydrochloric acid, further washed with and separated from a saturated sodium chloride aqueous solution. The ethyl acetate layer was dried over magnesium sulfate, and the solvent was distilled off under reduced pressure to concentrate. Acetonitrile was added to the concentrate, followed by stirring. Crystals precipitated were collected by suction filtration and dried to obtain 9.2 g of white crystals (34). (Yield: 83%) (mp: 55-58° C.)

The compound (A) of the invention can be combined with one or more arbitrary methods having the effect of increasing sensitivity and one or more compounds having the effect of increasing sensitivity. The number and kind of the methods and compounds to be employed in such case can freely be selected.

For example, the compound (A) of the invention may further be combined with compounds containing at least 3 hetero atoms and being described in JP-A-2000-194085 and JP-A-2003-156823.

In the invention, all that is required is to act the compound (A) of the invention on a silver halide photographic light-sensitive material (preferably a silver halide color photographic light-sensitive material), and there are no limits as to where to add it. The compound may be used in either of a silver halide light-sensitive layer and a light-insensitive layer.

In the case of using the compound in the silver halide light-sensitive layer which is constituted by a plurality of layers having different sensitivities, the compound may be used in any of them, but it is preferred to add the compound to a layer having the highest sensitivity.

In the case of using the compound in the light-insensitive layer, it is preferred to use it in a light-insensitive layer positioned between a red-sensitive layer and a green-sensitive layer or between a green-sensitive layer and a blue-sensitive layer. The light-insensitive layer includes all layers except for silver halide emulsion layers, including an anti-halation layer, an intermediate layer, a yellow filter layer and a protective layer.

As to a method for adding the compound (A) of the invention to a light-sensitive material, there are no particular regulations. There are a method of emulsifying and dispersing together with an organic solvent having a high boiling point and adding the emulsion, a method of dispersing as solids to add, a method of adding to a coating solution in a solution form (for example adding as a solution in water, an organic solvent such as methanol or a mixed solvent), and a method of adding upon preparation of a silver halide emulsion. Introduction of the compound as an emulsion dispersion or as a solid dispersion into a light-sensitive material is preferred, with introduction thereof as an emulsion dispersion into the light-sensitive material being more preferred.

As the emulsifying and dispersing method, a method of dispersing oil in water is employed wherein the compound is dissolved in an organic solvent having a high boiling point (combined use with an organic solvent having a low boiling point being possible), the resultant solution is emulsified and dispersed in a gelatin aqueous solution, and the emulsion dispersion is added to a silver halide emultion.

Examples of the organic solvent having a high boiling point to be used in the method of dispersing oil in water are described in U.S. Pat. No. 2,322,027. Also, as one of polymer-dispersing methods, specific examples of a method of dispersing as a latex are described in U.S. Pat. No. 4,199,363, West German OLS No. 2,541,274, JP-B-53-41091, EP-A-0,727,703 and EP-A-0,727,704. Further, a method of dispersing using an organic solvent-soluble polymer is described in WO88/723 pamphlet.

As the high-boiling organic solvent to be used in the method of dispersing oil in water, there are illustrated, for example, phthalates (e.g., dibutyl phthalate, dioctyl phthalate and di-2-ethylhexyl phthalate), phosphates or phosphonates (e.g., triphenyl phosphate, tricresyl phosphate and tri-2-ethylhexyl phosphate), fatty acid esters (e.g., di-2-ethylhexyl succinate and tributyl citrate), benzoates (e.g., 2-ethylhexyl benzoate and dodecyl benzoate), amides (e.g., N,N-diethyldodecanamide and N,N-dimethyloleinamide), alcohols or phenols (e.g., isostearyl alcohol, 2,4-di-tert-amylphenol), anilines (e.g., N,N-dibutyl-2-butoxy-5-tert-octylaniline), chlorinated paraffins, hydrocarbons (e.g., dodecylbenzene and diisopropylnaphthalene) and carboxylic acids (e.g., 2-(2,4-di-tert-amylphenoxy)butyric acid). Also, organic solvents having a boiling point of from 30° C. to 160° C. (e.g., ethyl acetate, butyl acetate, methyl ethyl ketone, cyclohexanone, methyl cellosolve acetate and dimethylformamide) may be used together as auxiliary solvents. The high-boiling organic solvent is used in an amount of 0 to 10 times by weight, preferably 0 to 4 times, as much as that of the compound (A) of the invention.

In view of improving stability with time of the emulsion dispersion during storage, suppressing change in photographic performance of a final coating composition prepared by mixing the emulsion with other components and improving stability of the composition with time, all or part of the auxiliary solvent may be removed, as needed, from the emulsion dispersion by distillation under reduced pressure, noodle washing with water or by ultrafiltration.

The average particle size of the thus-obtained oleophilic fine particle dispersion is preferably from 0.04 to 0.50 μm, more preferably from 0.05 to 0.30 μm, most preferably from 0.08 to 0.20 μm. The average particle size can be measured by using a Coulter sub-micron particle analyzer, model N4 (trade name; manufactured by Coulter Electronics Co.)

As a method for dispersing solid fine particles, there are illustrated methods of dispersing the compound (A) of the invention in a suitable solvent such as water by means of a ball mill, colloid mill, vibrated ball mill, sand mill, jet mill, roller mill or ultrasonic waves to prepare a solid dispersion. Additionally, upon preparation, a protective colloid (e.g., polyvinyl alcohol) or a surfactant (e.g., anionic surfactant such as a mixture of sodium triisopropylnaphthalenesulfonates (different from each other in substitution position of three isopropyl groups) may be used. In the above-mentioned mills, beads of, for example, zirconia are commonly used as a dispersing medium, and Zr dissolved out of the beads can contaminate the dispersion. The contamination degree is usually in the range of from 1 to 1,000 ppm, though depending upon dispersing condition. As long as the content of Zr in the light-sensitive material is 0.5 mg or less per g of silver, there arise no practical problems. An antiseptic (e.g., sodium salt of benzisothiazolinone) may be incorporated in the aqueous dispersion.

In the invention, for the purpose of obtaining a solid dispersion showing a high S/N ratio, having a small particle size and not causing aggregation, a dispersing method can be employed wherein the aqueous dispersion is converted to a high-speed flow, followed by decreasing the pressure. A solid-dispersing apparatus to be used for practicing such dispersing method and the technique thereof are described in detail in, for example, Bunsankei Reoroji and Bunsanka Gijutsu (written by Toshio Kajiuchi & Hiroki Usui; published in 1991 by Shinzansha Shuppan K. K., pp. 357-403) and Kagaku Kogyo No Shinpo Dai 24 Shu (compiled by Shadanhojin Kagaku Kogakukai Tokai Shibu; published in 1990 by Maki Shoten, pp. 184-185).

The addition amount of the compound (A) of the invention is preferably from 0.1 to 1,000 mg/m², more preferably from 1 to 500 mg/m², particularly preferably from 5 to 100 mg/m². In the case of using in a light-sensitive silver halide emulsion layer, the addition amount is preferably from 1×10⁻⁵ to 1 mol, more preferably from 1×10⁻⁴ to 1×10⁻¹ mol, particularly preferably from 1×10⁻³ to 5×10⁻² mol, per mol of silver in the same layer. The compounds (A) of the invention may be used in combination of two or more thereof In such case, the compounds may be added to one and the same layer or to a different layer.

pKa of the compound (A) of the invention is determined, if possible, by the following method. To 100 mL of a solution of 0.01 mmol of the compound (A) in 6:4 (by weight) of tetrahydrofuran/water was added 0.5 mL of IN sodium chloride and, while stirring in a nitrogen gas atmosphere, titration is conducted using a 0.5N potassium hydroxide solution. pH positioned at the center of inflection point in a titration curve obtained by plotting the dropwise added amount of the potassium hydroxide aqueous solution as abscissa and the pH value as ordinate was taken as pKa. Additionally, with a compound having plural dissociative sites, the compound has plural inflection points, and plural pKa's can be determined. It is also possible to determine the inflection point by monitoring UV and visible light spectrum and examining change in absorption.

As has been described with the related art, photographic sensitivity is generally determined by the size of silver halide emulsion grains. As the size of emulsion grains becomes larger, there results a more increased photographic sensitivity. However, graininess becomes worse with the increase in size of silver halide emulsion grains, thus sensitivity and graininess being in a trade-off relation with each other.

In addition to increasing size of the silver halide emulsion grains as described above, sensitivity can be increased by a method of highly activating a coupler or a method of reducing the amount of development inhibitor-releasing coupler (DIR coupler). However, in the case of increasing sensitivity by these methods, there results at the same time a deteriorated graininess. These methods of changing the size of emulsion grains, adjusting activity of couplers and adjusting the amount of DIR couplers are merely “adjusting means” for increasing sensitivity while deteriorating graininess or for improving graininess while decreasing sensitivity, in the trade-off relationship between sensitivity and graininess.

The term “increase sensitivity” used in the claims does not mean a method of increasing sensitivity which is accompanied by counterbalancing deterioration of the graininess.

The method of the invention for increasing sensitivity is a method for increasing sensitivity without involving deterioration of graininess or a method for increasing sensitivity which can increase sensitivity in comparison with deterioration of graininess. In the case where increase in sensitivity and deterioration of graininess occur at the same time, it is necessary that a substantial increase in sensitivity is observed by comparing after adjusting graininess employing the aforesaid “adjusting means”.

“Substantial increase in sensitivity” is determined to be 0.02 or more in sensitivity difference when light-sensitive materials to be compared are exposed through a continuous wedge and are compared with respect to sensitivity in terms of logarithm of a reciprocal number of an exposure amount giving the minimum density+0.2.

In the light-sensitive material of the invention, it preferably contains “a compound whose one-electron-oxidation product generated by one electron oxidation can release one or more electrons.

As such compounds, those which are selected form the following types 1 and 2 are preferred.

(Type 1)

Compounds capable of undergoing one-electron oxidation to thereby form a one-electron oxidation product thereof, wherein the one-electron oxidation product is capable of releasing one or more electrons accompanying a subsequent bond cleavage reaction.

(Type 2)

Compounds capable of undergoing one-electron oxidation to thereby form a one-electron oxidation product thereof, wherein the one-electron oxidation product is capable of releasing further one or more electrons after going through a subsequent bond-forming reaction.

First, compounds of type 1 are described below.

As compounds capable of undergoing one-electron oxidation to thereby form a one-electron oxidation product thereof, wherein the one-electron oxidation product is capable of releasing one electrons accompanying a subsequent bond cleavage reaction, there are illustrated those compounds which are described in JP-A-9-211769 (specific examples: compounds PMT-1 to S-37 described in Tables E and F on pages 28 to 32), JP-A-9-211774 and JP-A-11-95355 (specific examples: compounds INV1 to 36), JP-T-2001-500996 (the term “JP-T” as used herein means a published Japanese translation of a PVT patent application)(specific examples: compounds 1 to 74, 80 to 87, and 92 to 122), U.S. Pat. Nos. 5,747,235 and 5,747,236, European Patent No. 786692A1 (specific examples: compounds INV1 to 35), European Patent No. 893732A1, U.S. Pat. Nos. 6,054,260 and 5,994,051, called “one photon-two electrons sensitizer” or “deprotonating electron-donating sensitizer”. Preferred scopes of these compounds are the same as the preferred scopes described in the above-mentioned patent specifications.

Also, as compounds of type 1 capable of undergoing one-electron oxidation to thereby form a one-electron oxidation product thereof, wherein the one-electron oxidation product is capable of releasing one or more electrons accompanying a subsequent bond cleavage reaction, there are illustrated compounds represented by the general formula (1) (the same as the general formula (1) described in JP-A-2003-114487), the general formula (2) (the same as the general formula (2) described in JP-A-2003-114487), the general formula (3) (the same as the general formula (1) described in JP-A-2003-114488), the general formula (4) (the same as the general formula (2) described in JP-A-2003-114488), the general formula (5) (the same as the general formula (3) described in JP-A-2003-114488), the general formula (6) (the same as the general formula (1) described in JP-A-2003-75950), the general formula (7) (the same as the general formula (2) described in JP-A-2003-75950), the general formula (8) (the same as the general formula (1) described in JP-A-2004-239943) and compounds capable of causing the reaction represented by the chemical reaction formula (1) (the same as the chemical reaction formula (1) described in JP-A-2004-245929 and represented by the general formula (9) (the same as the general formula (3) described in JP-A-2004-245929). Preferred scopes of these compounds are the same as the preferred scopes described in the above-cited patent specifications.

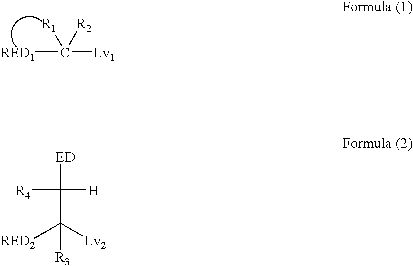

In the general formulae (1) and (2), RED₁ and RED₂ each independently represents a reducing group. R₁ represents non-metallic atoms capable of forming a cyclic structure corresponding to a tetrahydro or hexahydro derivative of a 5- or 6-membered aromatic ring (including aromatic hetero ring) together with the carbon atom (C) and RED₁, R₂, R₃ and R₄ each independently represents a hydrogen atom or a substituent. Lᵥ₁ and Lᵥ₂ each independently represents a leaving group. ED represents an electron donating group.

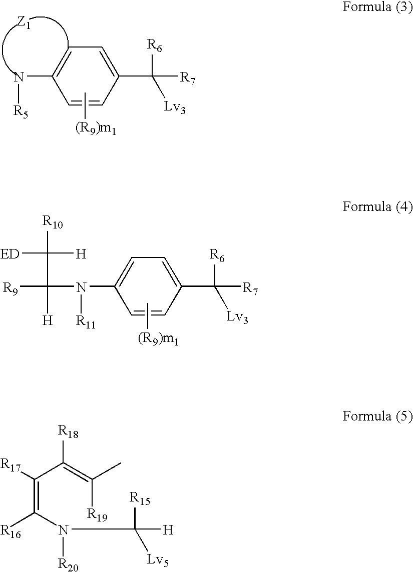

In the general formulae (3), (4) and (5), Z₁ represents atoms capable of forming a 6-membered ring together with the nitrogen atom and two carbon atoms of the benzene ring, R₅, R₆, R₇, R₉, R₁₀, R₁₁, R₁₃, R₁₄, R₁₅, R₁₆, R₁₇, R₁₈ and R₁₉ each independently represents a hydrogen atom or a substituent. R₂₀ represents a hydrogen atom or a substituent and, when R₂₀ represents a group other than an aryl group, R₁₆ and R₁₇ are connected to each other to form an aromatic ring or an aromatic hetero ring. R₈ and R₁₂ each independently represents a substituent capable of connecting to the benzene ring, m1 represents an integer of from 0 to 3, and m2 represents an integer of from 0 to 4. Lᵥ₃, Lᵥ₄ and Lᵥ₅ each independently represents a leaving group.

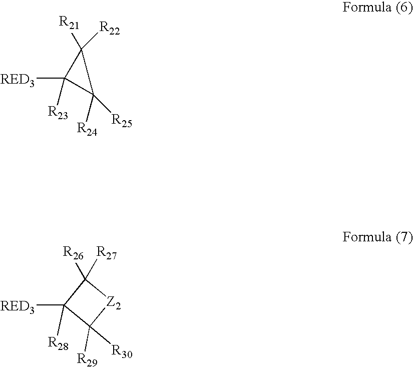

In the general formulae (6) and (7), RED₃ and RED₄ each independently represents a reducing group. R₂₁ to R₃₀ each independently represents a hydrogen atom or a substituent. Z₂ represents —CR₁₁₁R₁₁₂—, —NR₁₁₃— or —O—.

R₁₁₁ and R₁₁₂ each independently represents a hydrogen atom or a substituent.

R₁₁₃ represents a hydrogen atom, an alkyl group, an aryl group or a hetero ring group.

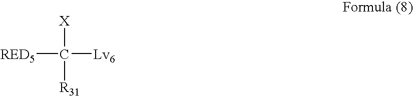

In the general formula (8), RED₅ is a reducing group and represents an arylamino group or a hetero ring amino group. R31 represents a hydrogen atom or a substituent. X represents an alkoxy group, an aryloxy group, a hetero ring oxy group, an alkylthio group, an arylthio group, a hetero ring thio group, an alkylamino group, an arylamino group or a hetero ring amino group. Lᵥ₆ is a leaving group and represents a carboxyl group or the salt thereof or a hydrogen atom.

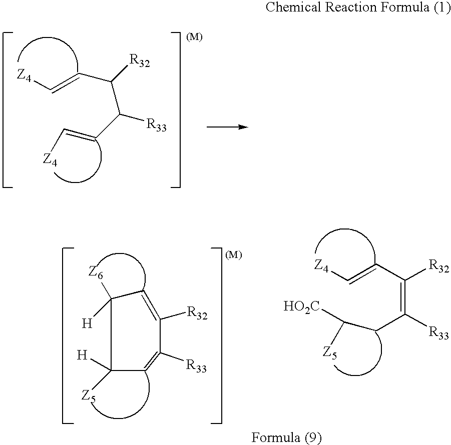

The compound represented by the general formula (9) is a compound which, after occurrence of two-electron oxidation accompanying decarboxylation, undergoes oxidation to cause the bond-forming reaction represented by the chemical reaction formula (1). In the chemical reaction formula (1), R₃₂ and R₃₃ each independently represents a hydrogen atom or a substituent. Z₃ represents a group forming a 5- or 6-membered hetero ring together with C═C. Z₄ represents a group forming a 5- or 6-membered aryl group or hetero ring group together with C═C. Z₅ and Z₆ each represents a group forming a 5- or 6-membered cyclic aliphatic hydrocarbon group or hetero ring group together with C—C. M represents a radical, a radical cation or a cation. In the general formula (9), R₃₂, R₃₃, Z₃ and Z₅ are the same as those in the chemical reaction formula (1).

Next, compound of type 2 are described below.

As the compounds of type 2 capable of undergoing one-electron oxidation to thereby form a one-electron oxidation product thereof, wherein the one-electron oxidation product is capable of releasing further one or more electrons after going through a subsequent bond-forming reaction, there are illustrated compounds represented by the general formula (10) (the same as the general formula (1) described in JP-A-2003-140287) and compounds capable of causing the reaction represented by the chemical reaction formula (1) (the same as the chemical reaction formula (1) described in JP-A-2004-245929) and represented by the general formula (11) (the same as the general formula (2) described in JP-A-2004-245929). Preferred scopes of these compounds are the same as the preferred scopes described in the above-cited patent specifications.
RED₆-Q-Y Formula (10)

In the general formula (10), RED₆ represents a reducing group capable of being one-electron-oxidized. Y represents a reactive group containing a carbon-carbon double bond moiety, carbon-carbon triple bond moiety, aromatic group moiety or non-aromatic hetero ring moiety of a benzo-condensed ring, which moiety can react with the one-electron oxidation product generated by one-electron oxidation of RED₆. Q represents a linking group which connects RED₆ to Y.

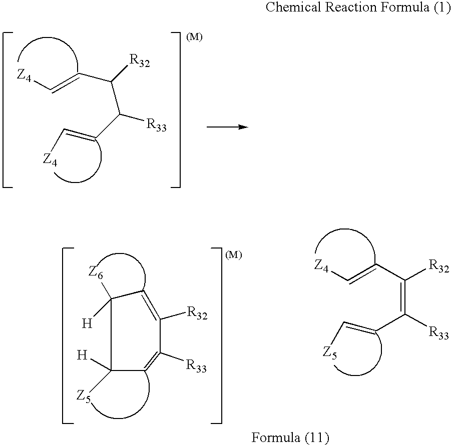

The compounds represented by the general formula (11) are compounds which cause, when oxidized, the bond-forming reaction represented by the chemical reaction formula (1). In the chemical reaction formula (1), R₃₂ and R₃₃ each independently represents a hydrogen atom or a substituent. Z₃ represents a group forming a 5- or 6-membered hetero ring together with C═C. Z₄ represents a group forming a 5- or 6-membered aryl group or hetero ring group together with C═C. Z₅ and Z₆ each represents a group forming a 5- or 6-membered cyclic aliphatic hydrocarbon group or hetero ring group together with C—C. M represents a radical, a radical cation or a cation. In the general formula (11), R₃₂, R₃₃, Z₃ and Z₄ are the same as those in the chemical reaction formula (1).

Of the compounds of types 1 and 2, preferred are “compounds having within the molecule an adsorptive group to silver halide” or “compounds having a partial structure of a spectrally sensitizing dye within the molecule”. Typical examples of the adsorptive group to silver halide include those groups which are described in JP-A-2003-156823, p. 16, right column, line 1 to p. 17, right column, line 12. The partial structure of a spectrally sensitizing dye is a structure described in the same specification, p. 17, right column, line 34 to p. 18, left column, line 6.

The compounds of types 1 and 2 are more preferably “compounds having at least one adsorptive group to silver halide within the molecule”, more preferably “compounds having two or more adsorptive groups to silver halide within the molecule”. In the case where two or more adsorptive groups exist within one single molecule, the adsorptive groups may be the same or different from each other.

Preferred examples of the adsorptive group include a mercapto-substituted, nitrogen-containing hetero ring group (e.g., a 2-mercaptothiadiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzothiazole group or a 1,5-dimethyl-1,2,4-triazolium-3-thiolate) and a nitrogen-containing hetero ring group having a —NH-group capable of forming an imino silver group (>NAg) as a partial structure of the hetero ring (e.g., a benzotriazole group, a benzimidazole group or an indazole group). Particularly preferred are a 3-mercapto-1,2,4-triazole group, a 3-mercapto-1,2,4-triazole group and a benzotriazole group, and most preferred are a 3-mercapto-1,2,4-triazole group and a 5-mercaptotetrazole group.

Compounds having, as the adsorptive group, two or more mercapto group as a partial structure are also particularly preferred. Here, the mercapto group (—SH) may be in a thione group form if the compound can undergo tautomerism. Preferred examples of an adsorptive group having two or more mercapto groups as a partial structure (e.g., a dimercapto-substituted, nitrogen-containing hetero ring group) include a 2,4-dimercaptopyrimidine group, a 2,4-dimercaptotriazine group and a 3,5-dimercapto-1,2,4-triazole group.

Also, a quatemary salt structure of nitrogen or phosphorus can preferably be used as the adsorptive group. The quatemary salt structure of nitrogen is specifically an ammonio group (a trialkylammonio group, a dialkylaryl(or heteroaryl)ammonio group, an alkyldiaryl(or heteroaryl) group or a group having a nitrogen-containing hetero ring group containing a quarternised nitrogen atom.

Examples of the quaternary salt structure of phosphorus include a phosphonio group (a trialkylphosphonio group, a dialkylaryl (or heteroaryl)phosphonio group, an alkyldiaryl (or heteroaryl)phosphonio group and a triaryl(or heteroaryl)phosphonio group. It is more preferred to use the quatemary salt structure of nitrogen, with a 5- or 6-membered, nitrogen-containing aromatic hetero ring group containing the quaternised nitrogen atom being still more preferably used. Particularly preferably, a pyridinio group, a quinolinio group and an isoquinolinio group are used. These nitrogen-containing hetero ring groups containing the quaternised nitrogen atom may have an arbitrary substituent.

Examples of the counter anion for the quaternary salt include halide ion, carboxylate ion, sulfonate ion sulfate ion, perchlorate ion, carbonate ion, nitrate ion, BF₄⁻, PF₆⁻ and Ph₄B⁻. In the case where a group having a negative charge such as a carboxylate group exists within the molecule, an intramolecular salt may be formed with such group. As a counter ion not existing within the molecule, a chloride ion, a bromide ion or a methanesulfonate ion is particularly preferred.

A preferred structure of the compound of type 1 or type 2 having the quaternary salt structure of nitrogen or phosphorus as the adsorptive group is represented by the following general formula (X).
(P-Q₁-)ᵢ-R(-Q₂-S)ⱼ Formula (X)

In the general formula (X), P and R each independently represents a quaternary salt structure of nitrogen or phosphorus which is not a partial structure of a sensitizing dye. Q₁ and Q₂ each independently represents a linking group, specifically one of, or a combination of, a single bond, an alkylene group, an arylene group, a hetero ring group, —O—, —S—, —NR_{N}—, —C(═O)—, —SO₂—, —SO— and —P(═O)—. Here, R_{N} represents a hydrogen atom, an alkyl group, an aryl group or a hetero ring group. S represents a residue formed by removing one atom from the compound of type (1) or (2). i and j each represents an integer of 1 or more, and are selected so that i+j is in the range of from 2 to 6. Preferably, i represents an integer of from 1 to 3, and j represents an integer of from 1 to 2. More preferably, i represents 1 or 2, and j represents 1. Particularly preferably, i represents 1, and j represents 1. The compounds represented by the general formula (X) have a total carbon atom number of preferably from 10 to 100, more preferably from 10 to 70, still more preferably from 11 to 60, particularly preferably from 12 to 50.

The compounds of the invention of types 1 and 2 may be used in any of a step of preparing an emulsion and steps of preparing a light-sensitive material. For example, they may be used upon formation of grains, in a desalting step, upon chemical sensitization or before coating.

It is also possible to add them plural times by portions in these steps. A preferred stage for the addition is upon completion of grain formation, from completion of grain formation and before the desalting step, upon chemical sensitization (between immediately before initiation of chemical sensitization and immediately after completion of chemical sensitization) or before coating, with a stage upon chemical sensitization and a stage before coating being more preferred.

The compounds of the invention of types 1 and 2 are preferably added as a solution in water, a water-miscible solvent such as methanol or ethanol, or in a mixed solvent thereof. In the case of dissolving in water, compounds which show an increased solubility when pH of water is increased or decreased may be dissolved with increasing or decreasing pH to prepare a solution for the addition.

The compounds of the invention of types 1 and 2 are preferably used in an emulsion layer. Also, they may be added to a solution for forming a protective layer or an intermediate layer together with the emulsion layer and allow them to diffuse upon coating. The stage of adding the compound of the invention may be before or after the addition of a sensitizing dye, and the compound is incorporated in each of the silver halide emulsion layers in an amount of from 1×10⁻⁹ to 5×10⁻² mol, more preferably from 1×10⁻⁸ to 2×10⁻³ mol, per mol of silver halide.

In the invention, it is preferred to employ the invention together with the technique of improving a light absorption ratio with a spectrally sensitizing dye. For example, there are a technique of adsorbing a sensitizing dye onto the surface of silver halide grains in a more amount than the amount of one-layer saturation coating by utilizing intermolecular force and a technique of adsorbing a dye wherein two or more separate,.non-conjugated dye chromophores are connected to each other through a covalent bond, so-called linked dye, onto silver halide grains, which are described in, for example, the following patents.

JP-A-10-239789, JP-A-11-133531, JP-A-2000-267216, JP-A-2000-275772, JP-A-2001-75222, JP-A-2001-75247, JP-A-2001-75221, JP-A-2001-75226, JP-A-2001-75223, JP-A-2001-255615, JP-A-2002-23294, JP-A-2002-99053, JP-A-2002-148767, JP-A-2002-287309, JP-A-2002-351004, JP-A-2002-365752, JP-A-2003-121956, JP-A-2004-184596, JP-A-2004-191926, JP-A-2004-219784, JP-A-2004-280062, JP-A-10-171058, JP-A-10-186559, JP-A-10-197980, JP-A-2000-81678, JP-A-2001-5132, JP-A-2001-13614, JP-A-2001-166413, JP-A-2002-49113, JP-A-2003-177486, JP-A-64-91134, JP-A-10-110107, JP-A-10-226758, JP-A-10-307358, JP-A-10-307359, JP-A-10-310715, JP-A-2000-231174, JP-A-2000-231172, JP-A-2000-231173, JP-A-2001-356442, JP-A-2002-55406, JP-A-2002-169258, JP-A-2003-121957, European Patent Nos. 985965A, 985964A, 985966A, 985967A, 1085372A, 1085373, 1172688A, 1199595A and 887700A1, U.S. Pat. Nos. 6,699,652B1, 6,790,602B2, 6,794,121B2 and 6,787,297B1, European Patent No. 1,439,417A1, 2004/0142288A1 and 2004/0146818A1.

Further, it is preferred to use in combination with the techniques described in JP-A-10-239789, JP-A-10-171058, JP-A-2001-75222, JP-A-2002-287309, JP-A-2004-184596 and JP-A-2004-191926.

The light-sensitive material of the invention preferably comprises a support having provided thereon at least one blue-sensitive silver halide emulsion layer, at least one green-sensitive silver halide emulsion layer, at least one red-sensitive emulsion layer and at lease one light-insensitive layer. A typical example thereof is a silver halide color photographic light-sensitive material comprising a support having provided thereon a blue-sensitive layer, a green-sensitive layer and a red-sensitive layer each of which comprises a plurality of silver halide emulsion layers having substantially the same color sensitivity but being different from each other in light sensitivity, and at least one light-insensitive layer. The light-sensitive layer is a unit light-sensitive layer having color sensitivity to one of blue light, green light and red light and, in a multi-layer silver halide color photographic light-sensitive material, the unit light-sensitive layers are provided in the order of generally a red-sensitive layer, a green-sensitive layer and a blue-sensitive layer from the support side. However, this order of arrangement can be reversed depending upon the intended use, or the layers may be arranged such that sensitive layers sensitive to the same color can sandwich another sensitive layer sensitive to a different color. A light-insensitive layer may be provided as an interlayer between the silver halide light-sensitive layers, or as the uppermost layer or as the lowermost layer. These layers may contain couplers, DIR compounds and color mixing inhibitors to be described hereinafter. With a plurality of the silver halide emulsion layers constituting each unit light-sensitive layer, it is preferred that two of a high-sensitive emulsion layer and a low-sensitive emulsion layer are provided in such order that light sensitivity decreases toward the support, as described in German Patent No. 1,121,470 or British Patent No. 923,945. Also, as is described in JP-A-57-112751, JP-A-62-200350, JP-A-62-206541 and JP-A-62-206543, a low-sensitive emulsion layer may be placed away from the support, and a high-sensitive emulsion layer may be placed nearer to the support.

Specific examples of the layer arrangement from the side remotest from the support include an order of low-sensitivity blue-sensitive layer (BL)/high-sensitivity blue-sensitive layer (BH)/high-sensitivity green-sensitive layer (GH)/low-sensitivity green-sensitive layer (GL)/high-sensitivity red-sensitive layer (RH)/low-sensitivity red-sensitive layer (RL), an order of BH/BL/GL/GH/RH/RL and an order of BH/BL/GH/GL/RL/RH.

Also, as described in JP-B-55-34932, arrangement in the order of blue-sensitive layer/GH/RH/GL/RL from the side remotest from the support may be employed. Furthermore, as described in JP-A-56-25738 and JP-A-62-63936, arrangement in the order of blue-sensitive layer/GL/RL/GH/RH from the side remotest from the support may also be employed.

In addition, arrangement consisting of three layers differing in the light sensitivity may be used as described in JP-B-49-15495, where a silver halide emulsion layer having highest light sensitivity is provided as an upper layer, a silver halide emulsion layer having light sensitivity lower than that of the upper layer is provided as a medium layer and a silver halide emulsion layer having light sensitivity lower than that of the medium layer is provided as a lower layer so as to sequentially decrease the light sensitivity toward the support. Also in this structure consisting of three layers differing in the light sensitivity, the layers having the same color sensitivity may be disposed in the order of medium-sensitivity emulsion layer/high-sensitivity emulsion layer/low-sensitivity emulsion layer from the side remote from the support as described in JP-A-59-202464.

Other than this, the layers may also be disposed in the order of high-sensitivity emulsion layer/low-sensitivity emulsion layer/medium-sensitivity emulsion layer, or low-sensitivity emulsion layer/medium-sensitivity emulsion layer/high-sensitivity emulsion layer.

The layer arrangement may be changed as described above also in the case of four or more layers.

A silver halide to be preferably used in the invention is silver bromoiodide, silver chloroiodide or silver chlorobromoiodide containing silver iodide in a content of about 30 mol % or less than that. A particularly preferred silver halide is silver bromoiodide or silver chlorobromoiodide containing silver iodide in a content of from about 2 mol % to about 10 mol %.

Silver halide grains in the photographic emulsion may be grains having a regular crystal form such as cubic form, octahedral form or tetradecahedral form, grains having an irregular form such as spherical form or tabular form, grains having a crystal defect such as twinned crystal form, or grains of a composite form thereof.

As to the grain size of silver halide, the silver halide grains may be fine grains of about 0.2 μm or less in grain size or large-sized grains of up to about 10 μm in projected area diameter, and the emulsion may be a polydisperse emulsion or monodisperse emulsion.

The silver halide photographic emulsion to be used in the invention can be prepared by processes described in, for example, Research Disclosure (hereinafter abbreviated as “RD”) No. 17643 (December 1978), pp. 22-23, I. Emulsion Preparation and types, and ibid. No. 18716 (November 1979), p. 648, ibid. No. 307105 (November 1989), pp. 863-865, and P. Glafkides, Chimie et Phisique Photographiques (Paul Montel, 1967), G. F. Duffin, Photographic Emulsion Chemistry (Focal press, 1966) and V. L. Zelikman, et al., Making and Coating Photographic Emulsion (Focal Press, 1964).

Monodisperse emulsions described in U.S. Pat. Nos. 3,574,628 and 3,655,394 and British Patent No. 1,413,748 are also preferred.

Tabular grains of about 3 or more in aspect ratio can particularly preferably be used in the invention. The tabular grains can be prepared with ease according to processes described in Gutoff, Photographic Science and Engineering, vol. 14, pp. 248-257 (1970), and U.S. Pat. Nos. 4,434,226, 4,414,310, 4,433,048 and 4,439,520 and British Patent No. 2,112,157.

It has also been found that the compound of the invention functioning to improve sensitivity/graininess ratio exhibits particularly remarkable effects when used in the same layer as tabular grains of 8 or more in average aspect ratio. The average aspect ratio is preferably from 8 to 100, more preferably from 12 to 50.

As to crystal structure, the inner part and outer part of the grains may be different from each other in halide composition, or the grains may have a layered structure. Silver halide grains different from each other in halide composition may be joined to each other, or silver halide grains may be joined to other compounds than silver halide, such as silver rhodanide or lead oxide. Also, a mixture of grains of various crystal forms may be used.

The above-mentioned emulsion preferably has dislocation. Particularly with the tabular grains, it is preferred for them to have dislocation in the fringe thereof. As a method for introducing dislocation, there may be employed a method of forming a high-silver iodide layer by adding an aqueous solution of an alkali iodide, a method of adding fine grains of AgI, and a method described in JP-A-5-323487.

The above-mentioned emulsion may be any of a surface latent image type emulsion which predominantly forms a latent image on the surface of the silver halide grain, an internal latent image type emulsion which predominantly forms a latent image in the interior of the silver halide grains, and another type emulsion which forms a latent image both on the surface and in the interior of the silver halide grains. However, the emulsion must be a negative-working type. The internal latent image type emulsion may be a core/shell internal latent image type emulsion described in JP-A-63-264740. A process for preparing the emulsion is described in JP-A-59-133542. Although the thickness of the shell of this emulsion depends upon, for example, development conditions, it is preferably from 3 to 40 nm, particularly preferably from 5 to 20 nm.

The silver halide emulsion is usually subjected to physical ripening, chemical ripening and spectral sensitization before use. The additives used in these steps are described in RD Nos. 17643, 18716 and 307105 and the pertinent portions thereof are summarized in the Table later.

In the same layer of the light-sensitive material of the present invention, a mixture of two or more emulsions differing in at least one property of the light-sensitive silver halide emulsion, that is, grain size, grain size distribution, halogen composition, grain shape or sensitivity, may be used.

A silver halide grain with the grain surface being fogged described in U.S. Pat. No. 4,082,553, a silver halide grain with the grain inside being fogged described in U.S. Patent 4,626,498 and JP-A-59-214852 or a colloidal silver is preferably applied to a light-sensitive silver halide emulsion layer and/or a substantially light-insensitive hydrophilic colloid layer. The term “silver halide grain with the grain inside or surface being fogged” as used herein means a silver halide grain which can be uniformly (non-imagewise) developed irrespective of an unexposed area or an exposed area of the light-sensitive material. The preparation method of such a grain is described in U.S. Pat. No. 4,626,498 and JP-A-59-214852. The silver halide constituting the inner core of a core/shell type silver halide grain with the grain inside being fogged may have a different halogen composition. The silver halide with the grain inside or surface being fogged may be any of silver chloride, silver chlorobromide, silver iodobromide and silver chloroiodobromide. The fogged silver halide grain preferably has an average grain size of 0.01 to 0.75 μm, more preferably from 0.05 to 0.6 μm. The grain may have a regular shape and the emulsion may be a polydisperse emulsion, but the emulsion is preferably a monodisperse emulsion (an emulsion where at least 95% by weight or number of silver halide grains have a grain size within the average grain size ±40%).

In the present invention, a light-insensitive fine grain silver halide is preferably used. The term “light-insensitive fine grain silver halide” as used herein means a silver halide fine grain which is not exposed at the imagewise exposure for obtaining a dye image and is substantially not developed at the development processing of the dye image. The light-insensitive fine grain silver halide is preferably not fogged in advance. This fine grain silver halide has a silver bromide content of 0 to 100 mol % and, if desired, may contain silver chloride and/or silver iodide, but preferably contains from 0.5 to 10 mol % of silver iodide. Furthermore, this fine grain silver halide preferably has an average grain size (an average of equivalent-circle diameters of the projected areas) of 0.01 to 0.5 μm, more preferably from 0.02 to 0.2 μm.

This fine grain silver halide can be prepared by the same method as those for normal light-sensitive silver halide. The surface of the silver halide grain needs not be optically sensitized and also needs not be spectrally sensitized. However, a known stabilizer such as triazole-base compound, azaindene-base compound, benzothiazolium-base compound, mercapto-base compound or zinc compound is preferably added to the fine grain silver halide prior to the addition to a coating solution. The layer containing this fine silver halide grain may contain colloidal silver.

The amount of coated silver in the light-sensitive material of the invention is preferably 8.0 g/m² or less than that.

Photographic additives which can be used in the invention are also described in RD, and particular parts where related descriptions are given are shown in the following table.

| Kind of Additive | | RD17643 | RD18716 | RD307105 |
|---|---|---|---|---|
| 1. | Chemical sensitizers | p.23 | p.648 (right column) | p.866 |
| 2. | Sensitivity- | | p.648 (right column) | |
| | increasing agents | | | |
| 3. | Spectral sensitizers | pp.23-24 | p.648 (right column) | pp.866-868 |
| | and supersensitizers | | to p.649 | |
| | | | (right column) | |
| 4. | Brightening agents | p.24 | p.647 (right column) | p.868 |
| 5. | Light-absorbing | pp.25-26 | p.649 (right column | p.873 |
| | agents, filter dyes | | to p.650 | |
| | and UV absorbents | | (right column) | |
| 6. | Binders | p.26 | p.651 (left column) | pp.873-874 |
| 7. | Plasticizers | p.27 | p.650 (right column) | p.876 |
| | and lubricants | | | |
| 8. | Coating aids | pp.26-27 | p.650 (right column) | pp.875-876 |
| | and surfactants | | | |
| 9. | Antistatic agents | p.27 | p.650 (right column) | pp.876-877 |
| 10. | Matting agent | | | pp.878-879 |

Various dye-forming couplers may be used in the light-sensitive material of the invention. The following couplers are particularly preferred.

Yellow couplers: couplers represented by the formulae (I) and (II) described in EP 502,424A; couplers represented by the formulae (1) and (2) described in EP 513,496A (particularly Y-28 on page 18); couplers represented by formula (I) in claim 1 described in EP 568,037A; couplers represented by the general formula (I) described in U.S. Pat. No. 5,066,576, column 1, lines 45 to 55; couplers represented by the general formula (I) described in JP-A-4-274425, par. 0008; couplers described in claim 1 on page 40 of EP 498,381A1 (particularly D-35); couplers represented by the formula (Y) described on page 4 of EP 447,969A1 (particularly Y-1 (p. 17) and Y-54 (p. 41)); and couplers represented by formulae (II) to (IV) described in U.S. Pat. No. 4,476,219, column 7, lines 36 to 58 (particularly II-17 and 19 (column 17) and II-24 (column 19)).

Magenta couplers: L-57 described in JP-A-3-39737 (p. 11, right column, lower part), L-68 described therein (p. 12, right column, lower part) and L-77 described therein (p. 13, right column, lower part); [A-4]-63 described in European Patent No. 486,965 (p. 134), and [A-4]-73 and -75 described therein (p. 139); M-4 and -6 described in European Patent No. 486,965 (p. 26); M-45 described in EP 571,959A (p. 19); (M-1) described in JP-A-5-204106 (p. 6); and M-22 described in JP-A-4-362631, par. 0237.

Cyan couplers: CX-1, 3, 4, 5, 11, 12, 14 and 15 described in JP-A-4-204843 (pp. 14-16); C-7 and 10 described in JP-A-4-43345 (p. 35), 34 and 35 described therein (p. 3y7) and (I-1) and (I-17) described therein (pp. 42-43); and couplers represented by the general formula (Ia) or (Ib) described in claim 1 of JP-A-6-67385.

Polymer couplers: P-1 and P-5 described in JP-A-2-44345 (p. 11).

As couplers forming a colored dye having an appropriate diffusibility, those which are described in U.S. Pat. No. 4,366,237, British Patent No. 2,125,570, European Patent No. 96,873B and German Patent No. 3,234,533 are preferred.

As couplers for correcting unnecessary absorptions of a formed dye, yellow-colored cyan couplers represented by the formula (CI), (CII), (CIII) or (CIV) described in European Patent 456,257A1, page 5 (particularly, YC-86 on page 84), yellow-colored magenta coupler ExM-7 described in the European Unexamined Patent Publication (p. 202), EX-1 described therein (p. 249) and EX-7 described therein (p. 251); magenta-colored cyan coupler CC-9 described in U.S. Pat. No. 4,833,069 (column 8) and CC-13 described therein (column 10); (2) described in U.S. Pat. No. 4,837,136 (column 8); and uncolored masking couplers represented by the formula (A) in claim 1 described in WO92/11575 pamphlet (particularly, illustrative compounds on pages 36 to 45) are preferred.

Compounds capable of reacting with an oxidation product of a developing agent to release a photographically useful compound residue (including couplers) are illustrated below. Development inhibitor-releasing compounds: compounds represented by the formulae (I), (II), (III) and (IV) described on page 11 of European Patent 378,236A1 (particularly T-101 (p. 30), T-104 (p. 31), T-113 (p. 36),k T-131 (p. 45), T-144 (p. 51) and T-158 (p. 58)); compounds represented by the formula (I) described on page 7 of European Patent 436,938A2 (particularly D-49 (p. 51)); compounds represented by the formula (I) described in European Patent 568,037A (particularly (23) (p.11)); and compounds represented by the formulae (I), (II) and (III) described on pages 5 to 6 of European Patent No. 440,195A2 (particularly I-(1) on page 29). Bleaching accelerator-releasing compounds: compounds represented by the formulae (I) and (I′) on page 5 of European Patent No. 310,125A2 (particularly (60) and (61) on page 1) and compounds represented by the formula (I) described in claim 1 of JP-A-6-59411 (particularly (7 on page 7). Ligand-releasing compounds: compounds represented by LIG-X described in claim 1 of U.S. Pat. No. 4,555,478 (particularly compounds in column 12, lines 21 to 41). Leuco dye-releasing compounds: compounds 1 to 6 described in U.S. Pat. No. 4,749,641, columns 3 to 8. Fluorescent dye-releasing compounds: compounds represented by COUP-DYE described in claim 1 of U.S. Pat. No. 4,774,181 (particularly compounds 7 to 10 in columns 7 to 11). Development accelerator- or fogging agent-releasing compounds: compounds represented by the general formulae (1), (2) and (3) described in U.S. Pat. No. 4,656,123, column 3 (particularly (I-25) in column 25) and ExZK-2 described in European Patent 450,637A2, p. 75, lines 36 to 38. Compounds capable of releasing a group which forms a dye when split off: compounds represented by the formula (I) described in claim 1 of U.S. Pat. No. 4,857,447 (particularly Y-1 to Y-19 in columns 25 to 36).

As other additives than the couplers, the following ones are preferred.

Dispersion media for oil-soluble organic compounds: P-3, 5, 16, 19, 25, 30, 42, 49, 54, 55, 66, 81, 85, 86 and 93 described in JP-A-62-215272 (pp. 140-144); latexes for impregnation of oil-soluble organic compounds: latex described in U.S. Pat. No. 4,199,363; Scavengers for an oxidation product of a developing agent: compounds represented by the formula (I) described in U.S. Pat. No. 4,978,606, column 2, pp. 54-62 (particularly I-(1), (2), (6) and (12) (columns 4 to 5) and compounds represented by the formula described in U.S. Pat. No. 4,923,787, column 2, lines 5 to 10 (particularly compound I (column 3)); stain-preventing agents: compounds represented by the formulae (I) to (III) described in European Patent No. 298321A, p. 4, lines 30 to 33, particularly I-47, 72, III-1 and 27 (pp. 24-48); fading inhibitors: A-6, 7, 20, 21, 23, 24, 25, 26, 30, 37, 40, 42, 48, 63, 90, 92, 94 and 164 described in European Patent No. 298321A (pp. 69-118), II-1 to III-23, particularly III-10, described in U.S. Pat. No. 5,122,444, columns 25 to 38, I-1 to III-4, particularly III-10, described in European Patent No. 471347A, A-1 to 48, particularly A-39 and 42 described in U.S. Pat. No. 5,139,931, columns 32 to 40; materials for reducing the amount of a color formation-enhancing agent or a color mixing inhibitor: I-1 to II-15, particularly, I-46, described in European Patent No. 411324A, pp. 5-24; formalin scavengers: SCV-1 to 28, particularly SCV-8, described in European Patent No. 477932A, pp. 24-29; hardening agents: H-1, 4, 6, 8 and 14 described in JP-A-1-214845, p. 17, compounds (H-1 to 54) represented by the formulae (VII) to (XII) described in U.S. Pat. No. 4,618,573, columns 13 to 23, compounds (H-1 to 76), particularly H-14, represented by the formula (6) described in JP-A-2-214852, p. 8, right column, lower part, and compounds described in claim 1 of U.S. Pat. No. 3,325,287; development inhibitor precursors: P-24, 37 and 39 described in JP-A-62-168139 (pp. 6-7), compounds described in claim 1 of U.S. Pat. No. 5,019,492, particularly 28 and 29 in column 7, antiseptics and antifungal agents: I-1 to II-43, particularly II-1, 9, 10, 18 and III-25, described in U.S. Pat. No. 4,923,790, columns 3 to 15; stabilizing agents and antifoggants: I-1 to (14), particularly, I-1, 60, (2) and (13), described in U.S. Pat. No. 4,923,793, columns 6 to 16 and compounds 1 to 65, particularly 36, described in U.S. Pat. No. 4,952,483, columns 25 to 32; chemically sensitizing agents: triphenylphosphine selenide and compound 50 described in JP-A-5-40324; dyes: a-1 to b-20, particularly a-1, 12, 18, 27, 35, 36, b-5, described in JP-A-3-156450 and V-1 to 23, particularly, V-1, described on pages 27 to 29, F-I-1 to F-II-43, particularly, F-I-11 and F-II-8, described in European Patent No. 445627A, pp. 33-55, III-1 to 36, particularly III-1 and 3, described in European Patent No. 457153A, pp. 17-28, dispersion of fine crystals of Dye-1 to 24 described in WO88/04794 pamphlet, compounds 1 to 22, particularly compound 1, described in European Patent No. 319999A, pp. 6-11, D-1 to 87 represented by the formulae (1) to (3) described in European Patent No. 519306A (pp. 3-28), compounds 1 to 22 represented by the formula (I) described in U.S. Pat. No. 4,268,622 (columns 3 to 10), and compounds (1) to (31) represented by the formula (I) described din U.S. Pat. No. 4,923,788 (columns 2 to 9); UV absorbents: compounds (18b) to (18r) and 101 to 427 represented by the formula (1) described in JP-A-46-3335 (pp. 6-9), compounds (3) to (66) represented by the formula (I) described in European Patent No. 520938A (pp. 10-44) and compounds HBT-1 to 10 represented by the formula (III) described therein (p. 14), and compounds (1) to (31) represented by the formula (1) described in European Patent No. 521823A (columns 2-9).

The invention is applicable to various color light-sensitive materials such as color negative films for general purpose or for cinema, color reversal films for slides or TV, color paper, color positive film and color reversal paper. Also, it is appropriate for lens-fitted film units described in JP-B-2-32615 and JP-UM-B-3-39784.

Examples of supports to be appropriately used in the invention are described in, for example, RD No. 17643, p. 28, ibid., No. 18716, p. 647, right column to p. 648, left column, and ibid., No. 307105, p. 879.

The specific photographic sensitivity in the invention is determined by the method described in JP-A-63-236035. This method is based on JIS K 7614-1981, with the difference being in the point of completing development processing in a period of from 30 minutes to 6 hours after exposure for sensitometry and in the point that the development processing is Fuji Color standard processing formulation CN-16. Except for these points, the method is substantially the same as the measuring method described in JIS.

The light-sensitive material of the invention has a thickness of preferably 24 μm or less, more preferably 22 μm or less, in terms of the thickness from the light-sensitive silver halide layer nearest the support to the surface of this photographic light-sensitive material. Also, the film-swelling rate T_{1/2} is preferably 30 seconds or shorter, more preferably 20 seconds or shorter. T_{1/2} is defined in such a manner that, when 90% of the maximum swelled film thickness attained upon processing with a color developer at 30° C. for 3 minutes and 15 seconds is referred to as a saturated film thickness, the period of time until the film thickness reaches ½ thereof is designated as T_{1/2}. The film thickness herein means a film thickness after conditioning at 25C and 55% RH for 2 days, and T_{1/2} can be measured by using a swellometer of the model disclosed in A. Green, Photogr. Sci. Eng., vol. 19(2), pp. 124-129. The value T_{1/2} can be adjusted by adding a hardening agent to gelatin used as a binder or by changing the time-lapse conditions after coating. The swelling ratio is preferably from 150 to 400%. The swelling ratio can be calculated by using the maximum swelled film thickness under the conditions described above according to the equation: (maximum swelled film thickness−film thickness)/film thickness.

The light-sensitive material of the invention preferably has a hydrophilic colloid layer (referred to as “back layer”) of from 2 μm to 20 m in total dry film thickness on the opposite side of the emulsion layer-provided side. In this back layer are preferably incorporated the aforesaid light absorbents, filter dyes, UV ray absorbents, antistatic agents, hardening agents, binders, plasticizers, lubricants, coating aids and surfactants. The back layer has a swelling ratio of preferably from 150 to 500%.

The light-sensitive material of the invention can be development-processed according to usual processes described in RD No. 17643, pp. 28-29, ibid., No. 18716, p. 651, left column to right column and ibid., No. 307105, pp. 880-881 having been referred to hereinbefore.

Next, processing solutions for color negative film to be employed in the invention are described.

In the color developing solution to be used in the invention, compounds described in JP-A-4-121739, p. 9, right and upper column, line 1 to p. 11, left and lower column, line 4 can be used. Particularly, in the case of conducting rapid processing, 2-methyl-4-[N-ethyl-N-(2-hydroxyethyl)amino]aniline, 2-methyl-4-[N-ethyl-N-(3-hydroxypropyl)amino]aniline and 2-methyl-4-[N-ethyl-N-(4-hydroxybutyl)amino]aniline are preferred as the developing agent.

These color developing agents are used in a color developing solution in an amount of preferably from 0.01 to 0.08 mol, particularly from 0.015 to 0.06 mol, still more preferably from 0.02 to 0.05 mol, per liter (hereinafter, “liter” is also expressed as “L”) of the color developing solution. A replenisher for the color developing solution contains the color developing agent preferably in a 1.1- to 3-fold amount based on the above-mentioned concentration, particularly preferably in a 1.3- to 2.5-fold amount.

As a preservative for the color developing solution, hydroxylamine can widely been used and, in the case where a higher preservability is required, hydroxylamine derivatives having a substituent such as an alkyl group, a hydroxyalkyl group, a sulfoalkyl group or a carboxyalkyl group are preferred. Specifically, N,N-di(sulfoethyl)hydroxylamine, monomethylhydroxylamine, dimethylhydroxylamine, monoethylhydroxylamine, diethylhydroxylamine and N,N-di(carboxyethyl)hydroxylamine are preferred. Of those described above, N,N-di(sulfoethyl)hydroxylamine is particularly preferred. These derivatives may be used in combination with hydroxylamine, but use of one or a combination of two or more of the derivatives in place of hydroxylamine is preferred.

The preservative is used in an amount of preferably from 0.02 to 0.2 mol, particularly preferably from 0.03 to 0.15 mol, still more preferably from 0.04 to 0.1 mol, per L of the preservative. Also, in the replenisher, it is preferred to incorporate the preservative in a 1.1- to 3-fold concentration of the mother liquor (processing solution in a tank) as with the color developing agent.

In the color developing solution, a sulfite is used as an agent for preventing formation of tar of an oxidation product of the color developing agent. The sulfite is used in an amount of from 0.01 to 0.05 mol, particularly preferably from 0.02 to 0.04 mol, per L of the color developing solution. In the replenisher, the sulfite is used in an amount of preferably 1.1- to 3-fold amount in comparison with the amount in the developing solution.

Also, pH of the color developing solution is preferably in the range of from 9.8 to 11.0, particularly preferably from 10.0 to 10.5 and, in the replenisher, the pH is preferably set at a level higher than this range by 0.1 to 1.0. In order to stably keep the pH at such level, known buffer agents such as carbonates, phosphates, sulfosalicylates and borates are used.

A replenishing amount of the color developing solution is preferably from 80 to 1300 mL per m² of the light-sensitive material. In view of reducing a load of environmental pollution, however, a less amount is more preferred. Thus, specifically, the replenishing amount is preferably from 80 to 600 mL, more preferably from 80 to 400 mL.

The bromide ion concentration in the color developing solution is usually from 0.01 to 0.06 mol per L. However, for the purpose of depressing fog while maintaining sensitivity to thereby improve discrimination and graininess, it is preferred to control the bromide ion concentration at a level of from 0.015 to 0.03 mol per L. In the case of controlling the bromide ion concentration at such level, it suffices to incorporate in the replenisher a bromide ion in an amount calculated according to the following formula, provided that, when C becomes minus, no bromide ion be incorporated in the replenisher.
C=A−W/V
C: bromide ion concentration (mol/L) in a replenisher the color developing solution
A: target bromide ion concentration (mol/L) in the color developing solution
W: amount of bromide ion (mol) to be dissolved from a light-sensitive material into the color developing solution when 1 m² of the light-sensitive material is subjected to color development processing
V: amount of a replenisher of the color developing solution (L) to be added for 1 m² of the light-sensitive material

In the case of reducing the replenishing amount or setting the bromide ion concentration at a high level, it is also preferred, as a technique of increasing sensitivity, to use a development accelerator such as a pyrazolidone (typically, 1-phenyl-3-pyrazolidone or 1-phenyl-2-methyl-2-hydroxymethyl-3-pyrazolidone) or a thioether compound (typically, 3,6-dithia-1,8-octanediol).

In the processing solution having a bleaching ability to be used in the invention, compounds and processing conditions described in JP-A-4-125558, p. 4, left and lower column, line 16 to p. 7, left and lower column, line 6 can be employed.

The bleaching agent has an oxidation-reduction potential of preferably 150 mV or more and, as specific examples thereof, those which are described in JP-A-5-72694 and JP-A-5-173312 are preferred. In particular, 1,3-diaminopropanetetraacetic acid and a ferric complex salt of a specific compound 1 described in JP-A-5-173312, p. 7 are preferred.

In order to improve biodegradability of the bleaching agent, it is preferred to use ferric complex salts of compounds described in JP-A-4-251845, JP-A-4-268552, EP No. 588,289, EP No. 591,934 and JP-A-6-208213 as bleaching agents. The concentration of these bleaching agents is preferably from 0.05 to 0.3 mol per L of a solution having the bleaching ability. Particularly, for the purpose of reducing the amount discharged into the environment, it is preferred to design the amount to be 0.1 mol to 0.15 mol. In the case where the solution having the bleaching ability is a bleaching solution, it is preferred to incorporate a bromide in an amount of from 0.2 mol to 1 mol per L, with 0.3 to 0.8 mol being particularly preferred.

In the replenisher for the solution having a bleaching ability, each ingredient is incorporated fundamentally in a concentration calculated according to the following formula, thus concentrations of respective ingredients in the mother liquor being kept at constant levels.
Cᵣ=C_{T}×(V₁+V₂)/V₁+C_{P}
C_{R}: concentration of an ingredient in the replenisher
C_{T}: concentration of the ingredient in the mother liquor (processing solution in a tank)
C_{P}: concentration of the ingredient consumed during processing
V₁: amount (mL) of the replenisher having a bleaching ability to be added per m² of a light-sensitive material
V₂: amount (mL) entrained from a pre-bath by 1 m² of the light-sensitive material

In addition, it is preferred to incorporate a pH buffer agent to the bleaching solution, particularly a dicarboxylic acid giving a less amount of an offensive smell, such as succinic acid, maleic acid, malonic acid, glutaric acid or adipic acid. It is also preferred to use known bleaching accelerators described in JP-A-53-95630, RD No. 17129 and U.S. Pat. No. 3,893,858.

The bleaching solution is replenished with the replenisher in an amount of preferably from 50 to 1,000 mL, particularly preferably from 80 to 500 mL, more preferably from 100 to 300 mL, of a replenisher per m² of a light-sensitive material.

Further, the bleaching solution is preferably subjected to aeration.

In the processing solution having a fixing ability to be used in the invention, compounds and processing conditions described in JP-A-4-125558, p. 7, left and lower column, line 10 to p. 8, right and lower column, line 19 can be employed.

In particular, in order to accelerate the fixing speed and improve preservability, it is preferred to incorporate compounds represented by the general formulae (I) and (II) described in JP-A-6-301169 independently or in combination of two or more thereof in the processing solution having a fixing ability. In addition, use of sulfinic acids described in JP-A-1-224762 including a p-toluenesulfinate is preferred in view of improving preservability.

Use of ammonium as a cation in the solution having a bleaching ability or the solution having a fixing ability is preferred in view of improving desilvering properties. For the purpose of reducing environmental pollution, the amount of ammonium be preferably reduced to a lower level or to zero.

In the bleaching step, the bleach-fixing step and the fixing step, it is particularly preferred to conduct jet stirring described in JP-A-1-309059.

The replenishing amount of a replenisher in the bleach-fixing step or the fixing step is from 100 to 1,000 mL, preferably from 150 to 700 mL, particularly preferably from 200 to 600 mL, per m² of the light-sensitive material.

In the bleach-fixing or fixing step, various silver-removing apparatuses be preferably provided in-line or off-line relationship. By providing such apparatuses in an in-line relationship, the silver concentration of the solution can be reduced and, as a result, the replenishing amount can be reduced. It is also preferred to recover silver in an off-line manner and re-use the residual solution as a replenisher.

The bleach-fixing step or the fixing step can be constituted by a plurality of processing tanks, with each tank preferably having a cascade piping to conduct multi-step countercurrent processing. In view of balance with a developing machine, a 2-tank cascade constitution is generally effective. The ratio of a processing time in the front tank to a processing time in the rear tank is in the range of preferably from 0.5:1 to 1:0.5, particularly preferably from 0.8:1 to 1:0.8.

In view of improvement of preservability, it is preferred to allow a free chelating agent not forming a metal complex to exist in the bleach-fixing solution or the fixing solution. As such chelating agent, biodegradable chelating agents having been described with respect to the bleaching solution are preferably used.

As to a water-washing step and a stabilizing step, the contents described in the foregoing JP-A-4-125558, p. 12, right and lower column, line 6 to p. 13, right and lower column, line 16 can preferably be employed. In particular, in the stabilizing solution, use of azolylmethylamines described in EP Nos. 504,609 and 519,190 and N-methylolazoles described in JP-A-4-362943 in place of formaldehyde and use of 2-equivalent magenta couplers which serves to prepare a surfactant solution not containing an image-stabilizing agent such as formaldehyde are preferred in view of safety of working environment.

Also, in order to reduce the amount of dust adhered to a magnetic recording layer coated on the light-sensitive material, a stabilizing solution described in JP-A-6-289559 can preferably be used.

The replenishing amount of the water-washing solution or the stabilizing solution is preferably from 80 to 1,000 mL, particularly preferably from 100 to 500 mL, more preferably from 150 to 300 mL, per m² of the light-sensitive material in view of both ensuring the water-washing function or the stabilizing function and reducing the amount of waste liquors for protecting environment. In processing performed with this replenishing amount, it is preferable to prevent the propagation of bacteria and fungi by using known antifungal agents such as thiabendazole, 1,2-benzoisothiazolin-3 -one and 5-chloro-2-methylisothiazolin-3-one, antibiotics such as gentamicin, and water deionized by an ion-exchange resin. It is more effective to use deionized water together with the antifungal agent or antibiotic.

It is also preferred to reduce the replenishing amount of the water-washing solution or the stabilizing solution in the water-washing tank or in the stabilizing solution tank by performing reverse permeable membrane processing described in JP-A-3-46652, JP-A-3-53246, JP-A-3-55542, JP-A-3-121448 and JP-A-3-126030. A reverse permeable membrane used in this processing is preferably a low-pressure reverse permeable membrane.

In the processing of the invention, it is particularly preferable to perform processing solution evaporation correction disclosed in Hatsumei Kyokai Kokai Giho, Kogi No. 94-4992. In particular, a method of performing the correction on the basis of (formula-1) on page 2 by using temperature and humidity information of an environment wherein a developing machine is installed is preferred. Water for use in this evaporation correction is preferably taken from the washing water replenishing tank. If this is the case, deionized water is preferably used as the replenishing water for the tank.

As the processing agents to be used in the invention, those which are described in the afore-mentioned Kokai Giho, page 3, right column, line 15 to page 4, left column, line 32 are preferred. Also, as a developing machine to be employed for these agents, a film processor described on page 3, right column, lines 22 to 28 is preferred.

Specific preferred examples of the processing agents, automatic developing machine and evaporation-correcting system are described in the afore-mentioned Kokai Giho, page 5, right column, line 11 to page 7, right column, last line.

Processing agents to be used in the invention can be supplied in any form: a liquid agent in a form having the concentration of a solution to be used or in a concentrated form; a granular form; a powdery form; a tablet form; a past form; or an emulsion form. As examples of such processing agents, JP-A-63-17453 discloses a liquid agent contained in a low-oxygen permeable vessel, JP-A-4-19655 and JP-A-4-230748 disclose a vacuum-packed powder agent or granular agent, JP-A-4-221951 discloses a granular agent containing a water-soluble polymer, JP-A-51-61837 and JP-A-6-102628 disclose a tablet agent, and JP-T-57-500485 discloses a pasty processing agent. Although any of these processing agents can preferably be used, use of a liquid agent previously adjusted to have the concentration of a solution under use is preferred for the sake of convenience upon use.

As a material for a vessel for these processing agents, polyethylene, polypropylene, polyvinyl chloride, polyethylene terephthalate and nylon are used singly or as a composite material thereof These materials are selected in accordance with the level of necessary oxygen permeability. For a readily oxidizable solution such as the color developing solution, a low-oxygen permeable material is preferable. Specifically, polyethylene terephthalate or a composite material between polyethylene and nylon is preferable. These materials are used in a thickness of from 500 to 1,500 μm for the vessel, with oxygen permeability being adjusted to be preferably 20 mL/m²·24 hrs·atm or less.

Next, processing solutions for a color reversal film to be used in the invention are described below.

Processing for a color reversal film is described in detail in Aztech Ltd., Kochi Gijutsu, No. 6 (1, Apr. 1991), page 1, line 5 to page 10, line 5, and page 15, line 8 to page 24, line 2, and any of the contents can preferably be applied.

In this color reversal film processing, an image-stabilizing agent is contained in a control bath or a final bath. Preferred examples of this image-stabilizing agent include formalin, formaldehyde-sodium bisulfite and N-methylolazoles. Of these, formaldehyde-sodium sulfite or N-methylolazoles are preferable in view of working environment. As the N-methylolazoles, N-methyloltriazole is particularly preferred. Also, the contents pertaining to a color developing solution, a bleaching solution, a fixing solution and washing water described with respect to the color negative film processing can preferably be applied to the color reversal film processing.

Preferred examples of the color reversal film processing agents containing the above-mentioned contents are an E-6 processing agent manufactured by Eastman Kodak Co. and a CR-56 processing agent manufactured by Fuji Photo Film Co., Ltd.

Next, a magnetic recording layer to be used in the invention is described below.

The magnetic recording layer to be used in the invention is a layer formed on a support by applying to the support an aqueous or organic solvent-based coating solution containing magnetic particles dispersed in a binder.

The magnetic particles to be used in the invention comprise a ferromagnetic iron oxide such as γFe₂O₃, Co-coated γFe₂O₃, Co-coated magnetite, Co-containing magnetite, ferromagnetic chromium dioxide, a ferromagnetic metal, a ferromagnetic alloy, Ba ferrite of hexagonal system, Sr ferrite, Pb ferrite or Ca ferrite. Of these, a Co-coated ferromagnetic iron oxide such as Co-coated γFe₂O₃ is preferred. The form thereof may be any of acicular, rice grain, spherical, cubic and tabular shapes. The specific surface area is preferably 20 m²/g or more, particularly preferably 30 m²/g or more, in terms of S_{BET}.

The saturation magnetization (σₛ) of the ferromagnetic material preferably ranges from 3.0×10⁴ to 3.0×10⁵ A/m, particularly preferably from 4.0×10⁴ to 2.5×10⁵ A/m. The ferromagnetic particles may be subjected to surface treatment with silica and/or alumina or with an organic material. Further, as is described in JP-A-6-161032, the surface of the magnetic particles may be treated with a silane coupling agent or a titanium coupling agent. Magnetic particles whose surface is coated with an inorganic or organic material, described in JP-A-4-259911 and JP-A-5-81652, can also be used.

As binders to be used for the magnetic particles, thermoplastic resins, thermosetting resins, radiation-curable resins, reactive resins, acid-, alkali- or bio-degradable polymers, natural polymers (e.g., cellulose derivatives and sugar derivatives) and mixtures thereof can be used. These resins have a Tg of from −40° C. to 300° C. and a weight-average molecular weight of from 2,000 to 1,000,000. Examples thereof include a vinyl-based copolymer, cellulose derivatives such as cellulose diacetate, cellulose triacetate, cellulose acetate propionate, cellulose acetate butyrate and cellulose tripropionate, acrylic resin and polyvinyl acetal resin. Gelatin is also preferred. In particular, cellulose di(tri) acetate is preferred. The binder can be subjected to curing treatment by adding an epoxy-based, aziridine-based or isocyanate-based cross-linking agent. Examples of the isocyanate-based cross-linking agent include isocyanates such as trilenediisocyanate, 4,4′-diphenylmethanediisocyanate, hexamethylenediisoyanate and xylylenediisocyanate, reaction products between these isocyanates and polyalcohols (e.g., a reaction product between 3 mols of trilenediisocyanate and 1 mol of trimethylolpropane), and polyisocyanates produced by condensation of these isocyanates, and are described in, for example, JP-A-6-59357.

The method of dispersing the magnetic material in the above-mentioned binder preferably comprises using a kneader, a pin type mill or an annular type mill, with the use of them in combination being also preferred, as described in JP-A-6-35092. Dispersants described in JP-A-5-088283 and other known dispersants can be used.

The thickness of the magnetic recording layer ranges from 0.1 μm to 10 μm, preferably from 0.2 μm to 5 μm more preferably from 0.3 μm to 3 μm. The weight ratio of magnetic material particles to binder is preferably in the range of 0.5:100 to 60:100, more preferably 1:100 to 30:100. The coating amount of the magnetic material particles ranges from 0.005 to 3 g/m², preferably from 0.01 to 2 g/m², more preferably from 0.02 to 0.5 g/m². The transmission yellow density of the magnetic recording layer is preferably in the range of 0.01 to 0.50, more preferably 0.03 to 0.20, particularly preferably 0.04 to 0.15. The magnetic recording layer can be applied to the back of a photographic support in its entirety or in striped form by coating or printing. As the method for coating the magnetic recording layer, an air doctor coating method, a blade coating method, an air knife coating method, a squeeze coating method, an immersion coating method, a reverse roll coating method, a transfer roll coating method, a gravure coating method, a kiss coating method, a cast coating method, a spray coating method, a dip coating method, a bar coating method and an extrusion coating method can be utilized. Coating solutions described in JP-A-5-341436 are preferred.

The magnetic recording layer can be given a lubricating property-improving function, curling adjusting function, antistatic function, adhesion preventing function, and head polishing function. Alternatively, another functional layer can be formed and these functions can be given to that layer. A polishing agent in which at least one type of grains are aspherical inorganic grains having a Mors Hardness of 5 or more is preferable. The composition of this aspherical inorganic grain is preferably an oxide such as aluminum oxide, chromium oxide, silicon dioxide, titanium dioxide and silicon carbide, a carbide such as silicon carbide and titanium carbide, or a fine powder of diamond. The surfaces of the grains constituting these polishing agents can be treated with a silane coupling agent or titanium coupling agent. These grains can be added to the magnetic recording layer or overcoated (as, e.g., a protective layer or a lubricant layer) on the magnetic recording layer. A binder used together with the grains can be any of those described above and is preferably the same binder as in the magnetic recording layer. Sensitive materials having the magnetic recording layer are described in U.S. Pat. Nos. 5,336,589, 5,250,404, 5,229,259 and 5,215,874, and EP No. 466,130.

Nest, a polyester support to be preferably used in the invention will be described below. Details of the polyester support including sensitive materials, processing, cartridges and examples (to be described hereinafter) are described in Kokai Giho, Kogi No. 94-60-23 (Hatsumei Kyokai; Mar. 15, 1994). The polyester to be used in the invention is formed by using diol and aromatic dicarboxylic acid as essential components. Examples of the aromatic dicarboxylic acid include 2,6-, 1,5-, 1,4- and 2,7-naphthalenedicarboxylic acids, terephthalic acid, isophthalic acid and phthalic acid, and examples of the diol include diethylene glycol, triethylene glycol, cyclohexanedimethanol, bisphenol A and bisphenol. Examples of the polymer include homopolymers such as polyethylene terephthalate, polyethylene naphthalate and polycyclohexanedimethanol terephthalate. Polyesters containing 50 mol % to 100 mol % of 2,6-naphthalenedicarboxylic acid is particularly preferred.

Polyethylene-2,6-naphthalate is particularly preferred among other polymers. The weight-average molecular weight ranges from about 5,000 to about 200,000. The Tg of the polyester of the invention is 50° C. or higher, preferably 90° C. or higher.

To give the polyester support a resistance to curling, the polyester support is heat-treated at a temperature of 40° C. to less than Tg, more preferably Tg-20° C. to less than Tg. The heat treatment can be performed at a fixed temperature within this range or can be performed together with cooling. The heat treatment time is 0.1 to 1,500 hours, more preferably 0.5 to 200 hours. The heat treatment can be performed for a roll-like support or while a support is conveyed in the form of a web. The surface shape can also be improved by roughening the surface (e.g., coating the surface with conductive inorganic fine grains such as SnO₂ or Sb₂O₅). It is desirable to knurl and slightly raise the end portion, thereby preventing the cut portion of the core from being photographed. These heat treatments can be performed in any stage after support film formation, after surface treatment, after back layer coating (e.g., an antistatic agent or lubricating agent), and after undercoating. A preferable timing is after the antistatic agent is coated.

An ultraviolet absorbent can be incorporated into this polyester. Also, in order to prevent light piping, dyes or pigments such as Diaresin manufactured by Mitsubishi Kasei Corp. or Kayaset manufactured by NIPPON KAYAKU CO. LTD. commercially available for polyester can be incorporated.

Next, in the invention, it is preferred to perform a surface treatment in order to adhere the support and the sensitive material-constituting layers. Examples of the surface treatment are surface activating treatments such as a chemical treatment, mechanical treatment, corona discharge treatment, flame treatment, ultraviolet treatment, high-frequency treatment, glow discharge treatment, active plasma treatment, laser treatment, mixed acid treatment, and ozone oxidation treatment. Of these surface treatments, the ultraviolet radiation treatment, flame treatment, corona treatment and glow treatment are preferred.

Next, an undercoat layer will be described below. The undercoat layer may be a single layer or two or more layers. Examples of an undercoat layer binder include copolymers formed by using, as a starting material, a monomer selected from among vinyl chloride, vinylidene chloride, butadiene, methacrylic acid, acrylic acid, itaconic acid and maleic anhydride; polyethyleneimine; epoxy resin; grafted gelatin; nitrocellulose; and gelatin. Resorcin and p-chlorophenol are examples of a compound which swells the support. Examples of a gelatin hardener to be added to the undercoat layer include chromium salt (e.g., chromium alum), aldehydes (e.g., formaldehyde and glutaraldehyde), isocyanates, an active halogen compound (e.g., 2,4-dichloro-6-hydroxy-s-triazine), epichlorohydrin resin, and an active vinylsulfone compound. SiO₂, TiO₂, inorganic fine grains or polymethyl methacrylate copolymer fine particles (0.01 to 10 μm) can also be contained as a matting agent.

Also, in the invention, an antistatic agent is preferably used. Examples of the antistatic agent include carboxylic acids and carboxylates, high polymers containing sulfonate, cationic high polymers and ionic surfactant compounds.

Most preferred as the antistatic agents are fine grains of at least one crystalline metal oxides selected from among ZnO, TiO₂, SnO₂, Al₂O₃, In₂O₃, SiO₂, MgO, BaO, MoO₃ and V₂O₅, and having a volume resistivity of 10⁷Ω·cm or less, more preferably 10⁵Ω·cm or less and a grain size of 0.001 to 1.0 μm, fine grains of composite oxides (e.g., Sb, P, B, In, Si and C) of these metal oxides, and fine grains of sol metal oxides or fine grains of composite oxides of these sol metal oxides.

The content in a sensitive material is preferably from 5 to 500 mg/m², particularly preferably from 10 to 350 mg/m². The ratio of a conductive crystalline oxide or its composite oxide to the binder is preferably from 1/300 to 100/1, more preferably from 1/100 to 100/5.

The sensitive material of the invention preferably has a slip property. A slip agent-containing layer is preferably formed on the surfaces of both a sensitive layer and a back layer. A preferred slip property is 0.01 to 0.25 in terms of a coefficient of kinetic friction. This represents a value obtained when a stainless steel sphere of 5 mm in diameter is conveyed at a speed of 60 cm/min (25° C. 60% RH). In this evaluation, a value of nearly the same level is obtained when the surface of a sensitive layer is used as a sample to be measured.

Examples of the slip agent usable in the invention include polyorganosiloxane, higher fatty acid amide, higher fatty acid metal salt and ester between higher fatty acid and higher alcohol. As the polyorganosiloxane, it is possible to use, e.g., polydimethylsiloxane, polydiethylsiloxane, polystyrylmethylsiloxane or polymethylphenylsiloxane. A layer to which the slip agent is to be added is preferably the outermost emulsion layer or back layer. Polydimethylsiloxane or ester having a long-chain alkyl group is particularly preferred.

The sensitive material of the invention preferably contains a matting agent. This matting agent can be added to either the emulsion surface or back surface, and is particularly preferably added to the outermost emulsion layer. The matting agent may be either soluble or insoluble in processing solutions, and the use of both types of matting agents in combination is preferred. Preferred examples thereof include polymethyl methacrylate grains, poly(methyl methacrylate/methacrylic acid)=9/1 or 5/5 (molar ratio) grains and polystyrene grains. The grain size is preferably from 0.8 to 10 μm, and a narrow grain size distribution is preferred. It is preferred that 90% or more in population of all grains have grain sizes 0.9 to 1.1 times the average grain size. To increase the matting property, it is preferred to simultaneously add fine grains with a grain size of 0.8 μm or smaller. Examples thereof include polymethyl methacrylate (0.2 μm), poly(methylmethacrylate/methacrylic acid)=9/1 (molar ratio, 0.3 μm), polystyrene particles (0.25 μm) and colloidal silica (0.03 μm).

Next, a film patrone to be employed in the invention will be described below. The main material composing the patrone for use in the invention may be a metal or a synthetic plastic.

Examples of preferred plastic materials include polystyrene, polyethylene, polypropylene and polyphenyl ether. The patrone for use in the invention may contain various types of antistatic agents. For example, carbon black, metal oxide grains, nonionic, anionic, cationic or betaine type surfactants and polymers can favorably be used. Such antistatic patrone is described in JP-A-1-312537 and JP-A-1-312538. The resistance thereof at 25C and 25% RH is preferably 10¹²Ω or less. The plastic patrone is generally manufactured by using a plastic having carbon black or a pigment incorporated therein for imparting light shielding properties. The patrone size may be the same as the current 135 or, for miniaturization of cameras, it is advantageous to decrease the diameter of the 25 mm cartridge of the surrent size 135 to 22 mm or less. The volume of the case of the patrone is preferably 30 cm³ or less, more preferably 25 cm³ or less. The weight of the plastic to be used for each patrone or each patrone case is preferably from 5 g to 15 g.

Further, the patrone for use in the invention may be one capable of feeding a film out by rotating a spool. Also, the patrone may be so structured that a film front edge is accomodated in the main frame of the patrone and that the film front edge is fed through a port part of the patrone to the outside by rotating a spool shaft in a film-feeding-out direction. These are disclosed in U.S. Pat. Nos. 4,834,306 and 5,226,613. The photographic film for use in the invention may be a so-called raw film having not yet been developed or a developed photographic film. The raw film and the developed photographic film may be accommodated in the same new patrone or in different patrones.

The color photographic light-sensitive material of the invention is also suited as a negative film for an advanced photo system (hereinafter referred to as “AP system”). Examples thereof are NEXIA A, NEXIA F and NEXIA H (ISO 200, 100 and 400, respectively) manufactured by Fuji Photo Film Co., Ltd. These films are so processed as to have an AP system format and set in an exclusive cartridge. These AP system cartridge films are loaded into AP system cameras such as the Fuji EPION series represented by the EPION 300Z, manufactured by Fuji Photo Film Co., Ltd. The color light-sensitive film of the invention is also suited as a film-fitted lens such as Fuji Color UTSURUNDESU Super Slim manufactured by Fuji Photo Film Co., Ltd.

A photographed film is printed through the following steps in a miniature laboratory system.

(1) Reception (an exposed cartridge film is received from a consumer)

(2) Detaching step (the film is transferred from the cartridge to an intermediate cartridge for development)

(3) Film development

(4) Reattaching step (the developed negative film is returned to the original curtridge)

(5) Printing (prints of three types C, H and P and an index print are continuously automatically printed on color paper [preferably SUPER FA8 produced by Fuji Photo Film Co., Ltd.])

(6) Collation and shipment (the cartridge and the index print are collated by an ID number and shipped together with the prints)

As these systems, the Fuji Film MINILABO CHAMPION SUPER FA-298, FA-278, FA-258 and FA-238 and Fuji Film DIGITAL LABO SYSTEM FRONTIER are preferred. Examples of a film processor for the MINILABO CHAMPION include FP922AL/FP562B/FP562B, AL/FP362B/FP362B and AL, and a recommended processing chemical is the FUJI COLOR JUST-IT CN-16L and CN-16Q. Examples of a printer processor include PP3008AR/PP3008A/PP1828AR/PP1828A/PP1258AR/PP1258A/PP728AR/PP728A, and recommended processing chemicals are FUJI COLOR JUST-IT CP-47L and CP-40FAII. In the FRONTIER SYSTEM, SCANNER & IMAGE-PROCESSOR SP-1000 and LASER PRINTER & PAPER PROCESSOR LP-1000P or LASER PRINTER LP-1000W are used. A detacher used in the detaching step and a reattacher used in the reattaching step are preferably the DT200/DT100 and AT200/AT100 (manufactured by Fuji Photo Film Co., Ltd.), respectively.

The AP system can also be enjoyed by PHOTO JOY SYSTEM whose main component is the Fuji Film digital work station Aladdin 1000. For example, a developed AP system cartridge film is directly loaded into the Aladdin 1000, or image information of a negative film positive film or print is input to the Aladdin 1000 by using the FE-550 35-mm film scanner or the PE-550 flat head scanner. Obtained digital image data can aeasily be processed and edited. The data can be printed out by the NC-550AL digital color printer using a photo-fixing heat-sensitive color printing system or the PICTOROGRAPHY 3000 using a laser exposure thermal development transfer system, or by means of existing laboratory equipment through a film recorder. The Aladdin 1000 can also output digital information directly to a floppy disk or Zip disk or to a CD-R via a CD writer.

On the other hand, in a home, a user can enjoy photographs on a TV set by simply loading a developed AP system cartridge film into the photo player AP-1 manufactured by Fuji Photo Film Co., Ltd. or can continuously input image information at a high speed into a personal computer by loading a developed AP system cartridge film into the photo scanner AS-1 manufactured by Fuji Photo Film Co., Ltd. The Photo Vision FV-10 or FV-5 manufactured by Fuji Photo Film Co., Ltd. can be used to input a film, print or three-dimensional object. Further, image information recorded in a floppy disk, Zip disk, CD-R or hard disk can be variously processed on a computer by using the Fuji Film Photo Factory application software. The NC-2 or NC-2D digital color printer manufactured by Fuji Photo Film Co., Ltd. using a photo-fixing heat-sensitive color printing system is suited to outputting high-quality prints from a personal computer.

To keep developed AP system cartridge films, the FUJICOLOR POCKET ALBUM AP-5 POP L, AP-1 POP KG or the CARTRIDGE FILE 16 is preferred.

### EXAMPLES

Examples of the invention will be described below, which, however, in no way limit the scope of the invention.

### Example 1

On an undercoated cellulose triacetate film support were multi-layer coated the layers having the following formulations to prepare a multi-layer color light-sensitive material [sample 101].

Coating of Light-Sensitive Layers:

Next, layers of the following formulations were multi-layer coated on the opposite side of the support to the back layer obtained hereinbefore to prepare a color negative film sample 101.

(Formulation of Light-Sensitive Layer)

The number corresponding to each component represents a coating amount in terms of g/m² unit or, with silver halide, a coating amount converted to silver amount.

(Sample 101)
First layer (First antihalation layer)

| | | |
|---|---|---|
| Black colloidal silver | silver | 0.108 |
| AgBrI emulsion grains | silver | 0.011 |
| (average grain size: 0.07 μm; AgI content: 2 mol %) | | |
| Gelatin | | 0.900 |
| ExM-1 | | 0.040 |
| ExC-1 | | 0.002 |
| ExC-3 | | 0.002 |
| Cpd-2 | | 0.001 |
| F-8 | | 0.001 |
| HBS-1 | | 0.050 |
| HBS-2 | | 0.002 |

Second layer (Second antihalation layer)

| | | |
|---|---|---|
| Black colloidal silver | silver | 0.058 |
| Gelatin | | 0.440 |
| ExY-1 | | 0.040 |
| ExF-1 | | 0.003 |
| F-8 | | 0.001 |
| Solid disperse dye ExF-7 | | 0.130 |
| HBS-1 | | 0.080 |

Third layer (Interlayer)

| | |
|---|---|
| ExC-2 | 0.045 |
| Cpd-1 | 0.092 |
| Cpd-8 | 0.015 |
| Polyethyl acrylate latex | 0.220 |
| HBS-1 | 0.120 |
| Gelatin | 0.740 |

Fourth layer (Low-speed red-sensitive emulsion layer)

| | | |
|---|---|---|
| Em-C | silver | 0.510 |
| Em-D | silver | 0.370 |
| Em-E | silver | 0.270 |
| ExC-1 | | 0.188 |
| ExC-2 | | 0.012 |
| ExC-3 | | 0.077 |
| ExC-4 | | 0.123 |
| ExC-5 | | 0.012 |
| ExC-6 | | 0.008 |
| ExC-8 | | 0.053 |
| ExC-9 | | 0.020 |
| ExY-3 | | 0.009 |
| Cpd-2 | | 0.025 |
| Cpd-4 | | 0.023 |
| Cpd-7 | | 0.015 |
| UV-2 | | 0.040 |
| UV-3 | | 0.060 |
| UV-4 | | 0.015 |
| HBS-1 | | 0.200 |
| HBS-5 | | 0.030 |
| Gelatin | | 1.430 |

Fifth layer (Medium-speed red-sensitive emulsion layer)

| | | |
|---|---|---|
| Em-B | silver | 0.330 |
| Em-C | silver | 0.334 |
| ExC-1 | | 0.140 |
| ExC-2 | | 0.080 |
| ExC-3 | | 0.028 |
| ExC-4 | | 0.110 |
| ExC-5 | | 0.018 |
| ExC-6 | | 0.012 |
| ExC-8 | | 0.019 |
| ExC-9 | | 0.004 |
| ExY-3 | | 0.007 |
| Cpd-2 | | 0.036 |
| Cpd-4 | | 0.028 |
| Cpd-7 | | 0.020 |
| HBS-1 | | 0.120 |
| Gelatin | | 0.890 |

Sixth layer (High-speed red-sensitive emulsion layer)

| | | |
|---|---|---|
| Em-A | silver | 1.250 |
| ExC-1 | | 0.220 |
| ExC-3 | | 0.030 |
| ExC-6 | | 0.022 |
| ExC-8 | | 0.110 |
| ExC-9 | | 0.024 |
| ExM-6 | | 0.060 |
| ExY-3 | | 0.014 |
| Cpd-2 | | 0.060 |
| Cpd-4 | | 0.079 |
| Cpd-7 | | 0.030 |
| Cpd-9 | | 0.080 |
| HBS-1 | | 0.290 |
| HBS-2 | | 0.060 |
| Gelatin | | 1.350 |

Seventh layer (Interlayer)

| | |
|---|---|
| Cpd-1 | 0.090 |
| Cpd-6 | 0.372 |
| Cpd-8 | 0.032 |
| Solid disperse dye ExF-4 | 0.032 |
| HBS-1 | 0.052 |
| Polyethyl acrylate latex | 0.090 |
| Gelatin | 0.900 |

Eighth layer (Layer to donate interlayer effect to red-sensitive layer)

| | | |
|---|---|---|
| Em-F | silver | 0.230 |
| Em-G | silver | 0.160 |
| Cpd-4 | | 0.030 |
| ExM-2 | | 0.140 |
| ExM-3 | | 0.016 |
| ExM-4 | | 0.010 |
| ExY-1 | | 0.017 |
| ExY-3 | | 0.005 |
| ExY-4 | | 0.041 |
| ExC-7 | | 0.010 |
| ExC-1 | | 0.007 |
| HBS-1 | | 0.222 |
| HBS-3 | | 0.003 |
| HBS-5 | | 0.030 |
| Gelatin | | 0.650 |

Ninth layer (Low-speed green-sensitive emulsion layer)

| | | |
|---|---|---|
| Em-J | silver | 0.460 |
| Em-K | silver | 0.314 |
| Em-L | silver | 0.154 |
| ExM-2 | | 0.248 |
| ExM-3 | | 0.050 |
| ExM-4 | | 0.120 |
| ExY-1 | | 0.010 |
| ExY-3 | | 0.006 |
| ExC-7 | | 0.004 |
| ExC-10 | | 0.002 |
| HBS-1 | | 0.330 |
| HBS-3 | | 0.008 |
| HBS-4 | | 0.200 |
| HBS-5 | | 0.050 |
| Cpd-5 | | 0.020 |
| Cpd-7 | | 0.020 |
| Gelatin | | 1.408 |

Tenth layer (Medium-speed green-sensitive emulsion layer)

| | | |
|---|---|---|
| Em-I | silver | 0.355 |
| Em-J | silver | 0.165 |
| ExM-2 | | 0.055 |
| ExM-3 | | 0.022 |
| ExM-4 | | 0.005 |
| ExM-5 | | 0.005 |
| ExY-3 | | 0.006 |
| ExC-6 | | 0.014 |
| ExC-7 | | 0.050 |
| ExC-8 | | 0.010 |
| ExC-10 | | 0.020 |
| HBS-1 | | 0.060 |
| HBS-3 | | 0.002 |
| HBS-4 | | 0.020 |
| HBS-5 | | 0.020 |
| Cpd-5 | | 0.020 |
| Cpd-7 | | 0.010 |
| Gelatin | | 0.460 |

Eleventh layer (High-speed green-sensitive emulsion layer)

| | | |
|---|---|---|
| Em-H | silver | 1.140 |
| ExC-6 | | 0.003 |
| ExC-8 | | 0.014 |
| ExM-1 | | 0.017 |
| ExM-2 | | 0.025 |
| ExM-3 | | 0.020 |
| ExM-4 | | 0.005 |
| ExM-5 | | 0.005 |
| ExM-6 | | 0.060 |
| ExY-3 | | 0.008 |
| Cpd-3 | | 0.005 |
| Cpd-4 | | 0.007 |
| Cpd-5 | | 0.020 |
| Cpd-7 | | 0.020 |
| Cpd-9 | | 0.080 |
| HBS-1 | | 0.149 |
| HBS-3 | | 0.003 |
| HBS-4 | | 0.020 |
| HBS-5 | | 0.037 |
| Polyethyl acrylate latex | | 0.090 |
| Gelatin | | 0.975 |

Twelfth layer (Yellow filter layer)

| | |
|---|---|
| Cpd-1 | 0.090 |
| Cpd-8 | 0.032 |
| Solid disperse dye ExF-2 | 0.074 |
| Solid disperse dye ExF-5 | 0.008 |
| Oil-soluble dye ExF-6 | 0.008 |
| HBS-1 | 0.040 |
| Gelatin | 0.615 |

Thirteenth layer (Low-speed blue-sensitive emulsion layer)

| | | |
|---|---|---|
| Em-O | silver | 0.330 |
| Em-P | silver | 0.100 |
| Em-Q | silver | 0.012 |
| ExC-1 | | 0.023 |
| ExC-7 | | 0.006 |
| ExC-10 | | 0.003 |
| ExY-1 | | 0.003 |
| ExY-2 | | 0.350 |
| ExY-3 | | 0.007 |
| ExY-4 | | 0.050 |
| ExY-5 | | 0.410 |
| Cpd-2 | | 0.100 |
| Cpd-3 | | 0.004 |
| HBS-1 | | 0.220 |
| HBS-5 | | 0.070 |
| Gelatin | | 1.402 |

Fourteenth layer (Medium-speed blue-sensitive emulsion layer)

| | | |
|---|---|---|
| Em-N | silver | 0.604 |
| ExY-2 | | 0.041 |
| ExY-3 | | 0.006 |
| ExY-4 | | 0.040 |
| ExY-5 | | 0.050 |
| Cpd-2 | | 0.035 |
| Cpd-3 | | 0.001 |
| Cpd-7 | | 0.016 |
| HBS-1 | | 0.060 |
| Gelatin | | 0.343 |

Fifteenth layer (High-speed blue-sensitive emulsion layer)

| | | |
|---|---|---|
| Em-M | silver | 0.416 |
| ExY-2 | | 0.041 |
| ExY-3 | | 0.003 |
| ExY-4 | | 0.030 |
| ExY-5 | | 0.050 |
| Cpd-2 | | 0.035 |
| Cpd-3 | | 0.001 |
| Cpd-7 | | 0.016 |
| Cpd-9 | | 0.080 |
| HBS-1 | | 0.060 |
| Gelatin | | 0.373 |

Sixteenth layer (First protective layer)

| | | |
|---|---|---|
| AgBrI emulsion grains | silver | 0.323 |
| (average grain size: 0.07 μm; content of AgI: 2 mol %) | | |
| UV-1 | | 0.210 |
| UV-2 | | 0.127 |
| UV-3 | | 0.190 |
| UV-4 | | 0.020 |
| UV-5 | | 0.204 |
| ExF-8 | | 0.001 |
| ExF-9 | | 0.001 |
| ExF-10 | | 0.002 |
| ExF-11 | | 0.001 |
| F-11 | | 0.009 |
| S-1 | | 0.086 |
| HBS-1 | | 0.170 |
| HBS-4 | | 0.052 |
| Gelatin | | 2.150 |

Seventeenth layer (Second protective layer)

| | |
|---|---|
| H-1 | 0.400 |
| B-1 (diameter 1.7 μm) | 0.050 |
| B-2 (diameter 1.7 μm) | 0.150 |
| B-3 | 0.050 |
| S-1 | 0.200 |
| Gelatin | 0.700 |

Further, in order to improve the preservability, processability, resistance to pressure, antifungal and antibacterial properties, antistatic properties and coating properties, W-1 to W-13, B-4 to B-6, F-1 to F-19, a lead salt, platinum salt, iridium salt and rhodium salt are properly incorporated in each layer.
Preparation of Dispersions of Organic Solid Disperse Dyes:

The solid disperse dye ExF-2 used in the twelfth layer was dispersed by the following method.

| | |
|---|---|
| Wet cake of ExF-2 (containing 17.6% by weight of water) | 1.210 kg |
| W-11 | 0.400 kg |
| F-15 | 0.006 kg |
| Water | 8.384 kg |
| Total | 10.000 kg |

(pH being adjusted to 7.2 with NaOH)

After roughly dispersing a slurry of the above formulation in a dissolver, dispersion was performed using an agitator mill LMK-4 under such conditions that the peripheral speed, delivering rate and packing ratio of 0.3-mm diameter zirconia beads were 10 m/s, 0.6 kg/min and 80%, respectively to thereby obtain a solid fine particulate dispersion. The average particle diameter of the fine particles of the dye was 0.15 μm.

Solid dispersions of ExF-4 and ExF-7 were obtained in the same manner. The average particle diameters of the fine particles of the dyes were 0.28 μm and 0.49 μm, respectively. ExF-5 was dispersed according to the microprecipitation dispersion method described in Example 1 of European Patent 549,489A. The average particle diameter thereof was 0.06 μm.

Characteristic properties of the emulsions used in Examples of the invention are shown in Tables 1 to 4.

TABLE 1(A)

| | | | Average | Average Equivalent- |
|---|---|---|---|---|
| | | | Equivalent- | circle Diameter (μm) |
| | | | Sphere Diameter | Coefficient of |
| | Layer For Use | Shape of Grains | (μm) | Variation (%) |
| Em-A | High-speed red- | (111) main plane | 1.30 | 3.50/32 |
| | sensitive layer | tabular shape | | |
| Em-B | Medium-speed red- | (111) main plane | 0.95 | 2.20/32 |
| | sensitive layer | tabular shape | | |
| Em-C | Medium- and low- | (111) main plane | 0.69 | 1.30/35 |
| | speed red-sensitive | tabular shape | | |
| | layer | | | |
| Em-D | Low-speed red- | (111) main plane | 0.48 | 0.89/17 |
| | sensitive layer | tabular shape | | |
| Em-E | Low-speed red- | (111) main plane | 0.31 | 0.40/20 |
| | sensitive layer | tabular shape | | |
| Em-F | Layer to donate | (111) main plane | 0.78 | 1.38/24 |
| | interlayer effect to red- | tabular shape | | |
| | sensitive layer | | | |
| Em-G | Layer to donate | (111) main plane | 0.95 | 2.20/32 |
| | interlayer effect to red- | tabular shape | | |
| | sensitive layer | | | |
| Em-H | High-speed green- | (111) main plane | 1.30 | 3.50/32 |
| | sensitive layer | tabular shape | | |
| Em-I | Medium-speed green- | (111) main plane | 0.95 | 2.20/32 |
| | sensitive layer | tabular shape | | |
| Em-J | Medium- and low- | (111) main plane | 0.74 | 1.64/34 |
| | speed green-sensitive | tabular shape | | |
| | layer | | | |
| Em-K | Low-speed green- | (111) main plane | 0.55 | 0.79/30 |
| | sensitive layer | tabular shape | | |
| Em-L | Low-speed green- | (111) main plane | 0.44 | 0.53/30 |
| | sensitive layer | tabular shape | | |
| Em-M | High-speed blue- | (111) main plane | 1.35 | 3.50/35 |
| | sensitive layer | tabular shape | | |
| Em-N | Medium-speed blue- | (111) main plane | 1.30 | 2.20/24 |
| | sensitive layer | tabular shape | | |
| Em-O | Low-speed blue- | (111) main plane | 0.81 | 1.10/30 |
| | sensitive layer | tabular shape | | |
| Em-P | Low-speed blue- | (111) main plane | 0.40 | 0.55/32 |
| | sensitive layer | tabular shape | | |
| Em-Q | Low-speed blue- | (111) main plane cubic | 0.21 | 0.21/20 |
| | sensitive layer | shape | | |

TABLE 1(B)

| | Average | | | | | |
|---|---|---|---|---|---|---|
| | Thickness | | Ratio of | | | |
| | (μm) | | Tabular | | | |
| | Coefficient | Average | Grains to | Thickness of | Growth Ring | Number of |
| | of Variation | Aspect | Total Grains | Core Portion | Structure of | Dislocation |
| | (%) | Ratio | (%) | (μm) | Core Portion | Lines per grain |
| Em-A | 0.12/14 | 30 | 91 | 0.09 | no | 10 or more |
| Em-B | 0.12/14 | 18 | 97 | 0.09 | no | 10 or more |
| Em-C | 0.10/15 | 13 | 90 | 0.07 | no | 10 or more |
| Em-D | 0.09/12 | 10 | 99 | — | — | 10 or more |
| Em-E | 0.09/9.3 | 4.5 | 98 | — | — | 10 or more |
| Em-F | 0.15/13 | 9.2 | 90 | 0.12 | yes | 10 or more |
| Em-G | 0.12/14 | 18 | 97 | 0.09 | no | 10 or more |
| Em-H | 0.12/14 | 30 | 91 | 0.09 | no | 10 or more |
| Em-I | 0.12/14 | 18 | 97 | 0.09 | no | 10 or more |
| Em-J | 0.10/15 | 16 | 96 | 0.07 | no | 10 or more |
| Em-K | 0.14/13 | 5.5 | 97 | 0.11 | yes | 10 or more |
| Em-L | 0.17/18 | 3.2 | 97 | 0.13 | yes | 10 or more |
| Em-M | 0.13/21 | 27 | 90 | 0.09 | yes | 10 or more |
| Em-N | 0.34/22 | 7 | 98 | 0.14 | no | 10 or more |
| Em-O | 0.23/18 | 4.7 | 97 | 0.13 | yes | 10 or more |
| Em-P | 0.13/16 | 4.6 | 96 | 0.11 | yes | 10 or more |
| Em-Q | 0.21/20 | 1 | — | — | — | — |

TABLE 2

| | | Characteristics of | Silver Ratio (%) and Halide Composition in |
|---|---|---|---|
| | | Grains Amounting to | Grain Structure (described from the center of |
| | | 70% or more of Total | grain)(Composition at epitaxial junction |
| | Layer For Use | Projection Area | portion being given between <>) |
| Em-A | High-speed red-sensitive | (111) main plane | (11%)AgBr/(35%)AgBr₉₇I₃/ |
| | layer | tabular grains | (18%)AgBr/(9%)AgBr₆₂I₃₈/(27%)AgBr |
| Em-B | Medium-speed red- | (111) main plane | (11%)AgBr/(35%)AgBr₉₇I₃/ |
| | sensitive layer | tabular grains | (18%)AgBr/(9%)AgBr₆₂I₃₈/(27%)AgBr |
| Em-C | Medium- and low-speed | (111) main plane | (7%)AgBr/(31%)AgBr₉₇I₃/ |
| | red-sensitive layer | tabular grains | (16%)AgBr/(12%)AgBr₆₂I₃₈/(34%)AgBr |
| Em-D | Low-speed red-sensitive | (111) main plane | (1%)AgBr/(77%)AgBr₉₉I₁/ |
| | layer | tabular grains | (9%)AgBr/(12%)AgBr₉₅I₅/ |
| | | | (13%)<AgBr₆₃Cl₃₅I₂> |
| Em-E | Low-speed red-sensitive | (111) main plane | (57)AgBr/(14%)AgBr₉₆I₄/ |
| | layer | tabular grains | (29%)<AgBr₆₇Cl₄₁I₂> |
| Em-F | Layer to donate | (111) main plane | (13%)AgBr/(36%)AgBr₉₇I₃/ |
| | interlayer effect to red- | tabular grains | (7%)AgBr/(11%)AgBr₆₂I₃₈/(33%)AgBr |
| | sensitive layer | | |
| Em-G | Layer to donate | (111) main plane | (11%)AgBr/(35%)AgBr₉₇I₃/ |
| | interlayer effect to red- | tabular grains | (18%)AgBr/(9%)AgBr₆₂I₃₈/(27%)AgBr |
| | sensitive layer | | |
| Em-H | High-speed green- | (111) main plane | (11%)AgBr/(35%)AgBr₉₇I₃/ |
| | sensitive layer | tabular grains | (18%)AgBr/(9%)AgBr₆₂I₃₈/(27%)AgBr |
| Em-I | Medium-speed green- | (111) main plane | (11%)AgBr/(35%)AgBr₉₇I₃/ |
| | sensitive layer | tabular grains | (18%)AgBr/(4%)AgI/(32%)AgBr |
| Em-J | Medium- and low-speed | (111) main plane | (7%)AgBr/(31%)AgBr₉₇I₃/ |
| | green-sensitive layer | tabular grains | (15%)AgBr/(14%)AgBr₆₂I₃₈/(33%)AgBr |
| Em-K | Low-speed green- | (111) main plane | (15%)AgBr/(44%)AgBr₉₇I₃/ |
| | sensitive layer | tabular grains | (11%)AgBr/(5%)AgI/(25%)AgBr |
| Em-L | Low-speed green- | (111) main plane | (60%)AgBr/(2%)AgI/(38%)AgBr |
| | sensitive layer | tabular grains | |
| Em-M | High-speed blue- | (111) main plane | (1%)AgBr/(6%)AgBr₉₇I₃/ |
| | sensitive layer | tabular grains | (68%)AgBr₉₀I₂/(15%)AgBr/ |
| | | | (10%)<AgBr₇₈Cl₂₀I₂> |
| Em-N | Medium-speed blue- | (111) main plane | (8%)AgBr/(10%)AgBr₉₅I₅/ |
| | sensitive layer | tabular grains | (52%)AgBr₉₃I₇/(11%)AgBr/ |
| | | | (2%)AgI/(17%)AgBr |
| Em-O | Low-speed blue-sensitive | (111) main plane | (12%)AgBr/(43%)AgBr₉₀I₁₀/ |
| | layer | tabular grains | (14%)AgBr/(2%)AgI/ |
| | | | (29%)AgBr |
| Em-P | Low-speed blue-sensitive | (111) main plane | (58%)AgBr/(4%)AgI/(38%)AgBr |
| | layer | tabular grains | |
| Em-Q | Low-speed blue-sensitive | (111) main plane cubic | (6%)AgBr/(94%)AgBr₉₆I₄ |
| | layer | grains | |

TABLE 3(A)

| | | Average Iodide | | Average Chloride |
|---|---|---|---|---|
| | | Content (mol %) | | Content (mol %) |
| | | Coefficient of | | Coefficient of |
| | | Variation Among | Surface Iodide | Variation Among |
| | Layer For Use | Grains | Content (mol %) | Grains |
| Em-A | High-speed red- | 4.5/10 | 3.90 | 0 |
| | sensitive layer | | | |
| Em-B | Medium-speed red- | 4.5/10 | 3.90 | 0 |
| | sensitive layer | | | |
| Em-C | Medium- and low- | 5.5/11 | 5.00 | 0 |
| | speed red-sensitive | | | |
| | layer | | | |
| Em-D | Low-speed red- | 1.5/10 | 3.70 | 4.7/8.0 |
| | sensitive layer | | | |
| Em-E | Low-speed red- | 1.1/11 | 5.00 | 12/9.0 |
| | sensitive layer | | | |
| Em-F | Layer to donate | 5.3/10 | 5.90 | 0 |
| | interlayer effect to red- | | | |
| | sensitive layer | | | |
| Em-G | Layer to donate | 4.5/10 | 3.90 | 0 |
| | interlayer effect to red- | | | |
| | sensitive layer | | | |
| Em-H | High-speed green- | 4.5/10 | 3.90 | 0 |
| | sensitive layer | | | |
| Em-I | Medium-speed green- | 5.1/10 | 3.90 | 0 |
| | sensitive layer | | | |
| Em-J | Medium- and low- | 6.3/13 | 5.60 | 0 |
| | speed green-sensitive | | | |
| | layer | | | |
| Em-K | Low-speed green- | 6.3/12 | 7.39 | 0 |
| | sensitive layer | | | |
| Em-L | Low-speed green- | 2.0/14 | 5.68 | 0 |
| | sensitive layer | | | |
| Em-M | High-speed blue- | 7.1/10 | 3.80 | 5.4/8.0 |
| | sensitive layer | | | |
| Em-N | Medium-speed blue- | 6.1/8.0 | 5.50 | 0 |
| | sensitive layer | | | |
| Em-O | Low-speed blue- | 6.3/9.0 | 1.90 | 0 |
| | sensitive layer | | | |
| Em-P | Low-speed blue- | 4.0/10 | 5.50 | 0 |
| | sensitive layer | | | |
| Em-Q | Low-speed blue- | 3.8/9.0 | 4.50 | 0 |
| | sensitive layer | | | |

TABLE 3(B)

| | | Plane-to-plane Space | Ratio | Number of grains |
|---|---|---|---|---|
| | Surface | in Twined Crystals | of (100) | (Population) |
| | Chloride | (μm) | Plane | Satisfying the |
| | Content | Coefficient of | to Side | Following |
| | (mol %) | Variation (%) | plane | Requirement A |
| Em-A | 0 | 0.011/30 | 20 | 55 |
| Em-B | 0 | 0.011/30 | 20 | 55 |
| Em-C | 0 | 0.010/30 | 30 | 75 |
| Em-D | 16 | 0.010/31 | 25 | — |
| Em-E | 23 | 0.009/29 | 25 | — |
| Em-F | 0 | 0.012/30 | 35 | 20 |
| Em-G | 0 | 0.011/30 | 20 | 55 |
| Em-H | 0 | 0.011/30 | 20 | 55 |
| Em-I | 0 | 0.012/30 | 20 | 60 |
| Em-J | 0 | 0.010/30 | 30 | 65 |
| Em-K | 0 | 0.016/32 | 20 | 15 |
| Em-L | 0 | 0.016/32 | 35 | 18 |
| Em-M | 10 | 0.012/30 | 30 | 85 |
| Em-N | 0 | 0.017/33 | 20 | 20 |
| Em-O | 0 | 0.019/30 | 30 | 15 |
| Em-P | 0 | 0.020/31 | 30 | 20 |
| Em-Q | 0 | — | — | — |

Requirement A: comprising silver bromoiodide or silver chlorobromoiodide having (111) plane as a main surface, having an equivalent-circle diameter of 1.0 μm or more, a grain thickness of 0.15 μm or less, having a core portion of 0.1 μm or less in thickness with no growth ring structure, and having 10 or more dislocation lines.

TABLE 4

| | | Sensitizing | |
|---|---|---|---|
| | Layer For Use | Dye | Dopant |
| Em-A | High-speed red- | 2, 3, 14 | K₂IrCl₆, K₄Ru(CN)₆ |
| | sensitive layer | | |
| Em-B | Medium-speed red- | 2, 3, 14 | K₂IrCl₆, K₄Ru(CN)₆ |
| | sensitive layer | | |
| Em-C | Medium- and low- | 1, 2, 3 | K₂IrCl₆, K₂IrCl₅(H₂O), |
| | speed red-sensitive | | K₄Ru(CN)₆ |
| | layer | | |
| Em-D | Low-speed red- | 2, 3, 14 | K₂IrCl₆, K₄Fe(CN)₆ |
| | sensitive layer | | |
| Em-E | Low-speed red- | 2, 3, 14 | K₂IrCl₆, K₄Fe(CN)₆ |
| | sensitive layer | | |
| Em-F | Layer to donate | 7, 8 | K₄Fe(CN)₆ |
| | interlayer effect to red- | | |
| | sensitive layer | | |
| Em-G | Layer to donate | 7, 8 | K₄Fe(CN)₆ |
| | interlayer effect to red- | | |
| | sensitive layer | | |
| Em-H | High-speed green- | 5, 6, 8 | K₄Ru(CN)₆ |
| | sensitive layer | | |
| Em-I | Medium-speed green- | 4, 5, 6, 8 | K₂IrCl₆, K₄Ru(CN)₆ |
| | sensitive layer | | |
| Em-J | Medium- and low- | 4, 5, 6, 8 | K₂IrCl₆, K₄Fe(CN)₆ |
| | speed green-sensitive | | |
| | layer | | |
| Em-K | Low-speed green- | 4, 5, 6, 8, 13 | K₂IrCl₆ |
| | sensitive layer | | |
| Em-L | Low-speed green- | 6, 8, 13 | K₂IrCl₆, K₄Fe(CN)₆ |
| | sensitive layer | | |
| Em-M | High-speed blue- | 16 | — |
| | sensitive layer | | |
| Em-N | Medium-speed blue- | 16 | — |
| | sensitive layer | | |
| Em-O | Low-speed blue- | 9 | — |
| | sensitive layer | | |
| Em-P | Low-speed blue- | 9, 15 | — |
| | sensitive layer | | |
| Em-Q | Low-speed blue- | 12, 15 | K₂IrCl₆ |
| | sensitive layer | | |

Emulsions Em-A and H were prepared by reference to the process for preparing Emulsion 1-H described in Example of JP-A-2002-268162.

Emulsions Em-B to C, G, I to J, and N were prepared by reference to the process for preparing Emulsion I -E described in Example of JP-A-2002-268162.

Emulsions Em-F, K to L, and O to P were prepared by reference to the process for preparing Emulsion 1-D described in Example of JP-A-2002-268162.

Emulsions Em-D to E were prepared by reference to the process for preparing emulsions described in Example of JP-A-2002-278007.

Emulsion Em-M was prepared by reference to the process for preparing Em-4 and Em-5 described in Example of JP-A-2004-37936.

Emulsion Em-Q was prepared by reference to the process for preparing Em-N described in Example 1 of JP-A-2002-72429.

Emulsions Em-M to Q were subjected to reduction sensitization upon preparation of grains.

To emulsions Em-A, H and M to N was added compound 11 described in Example of U.S. Pat. No. 6,686,140.

To the emulsions were added the spectrally sensitizing dyes described in Table 4 in optimal amounts, and the emulsions were optimally subjected to gold sensitization, sulfur sensitization and selenium sensitization.

Sensitizing dyes used in this Example of the invention are shown below.

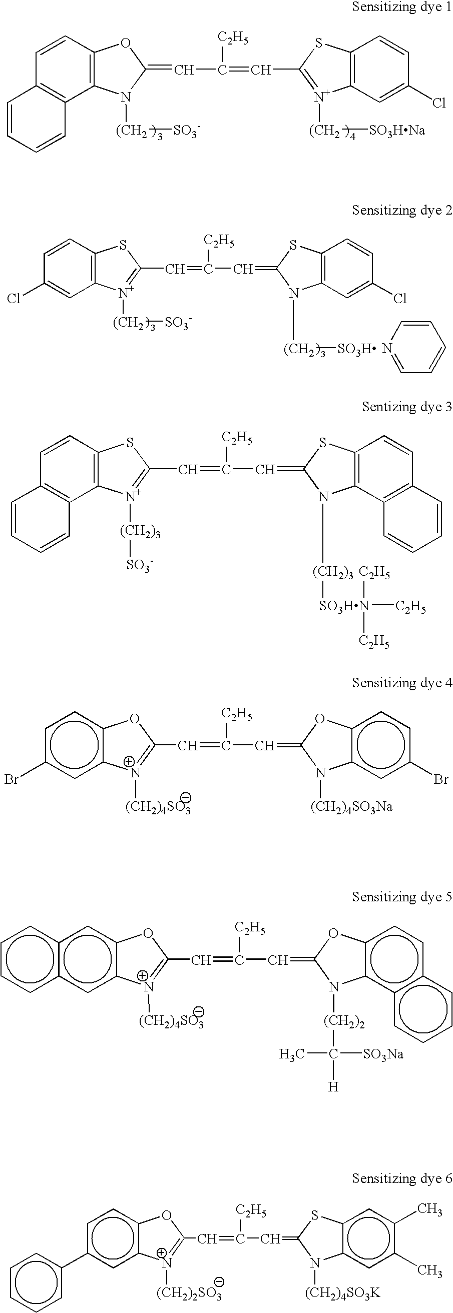

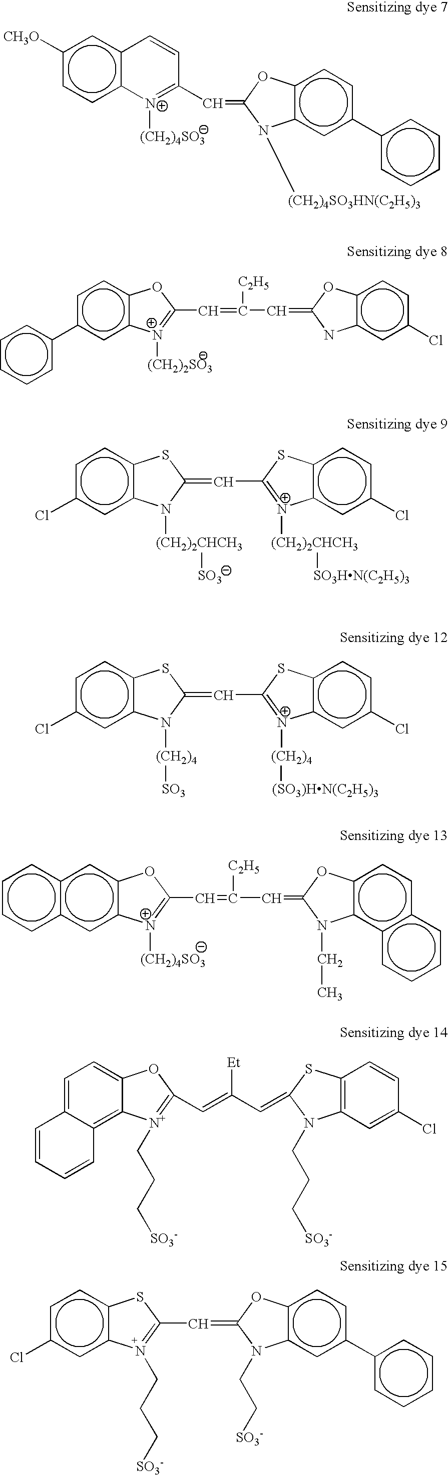

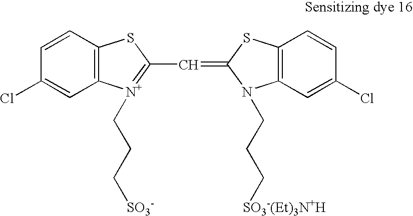

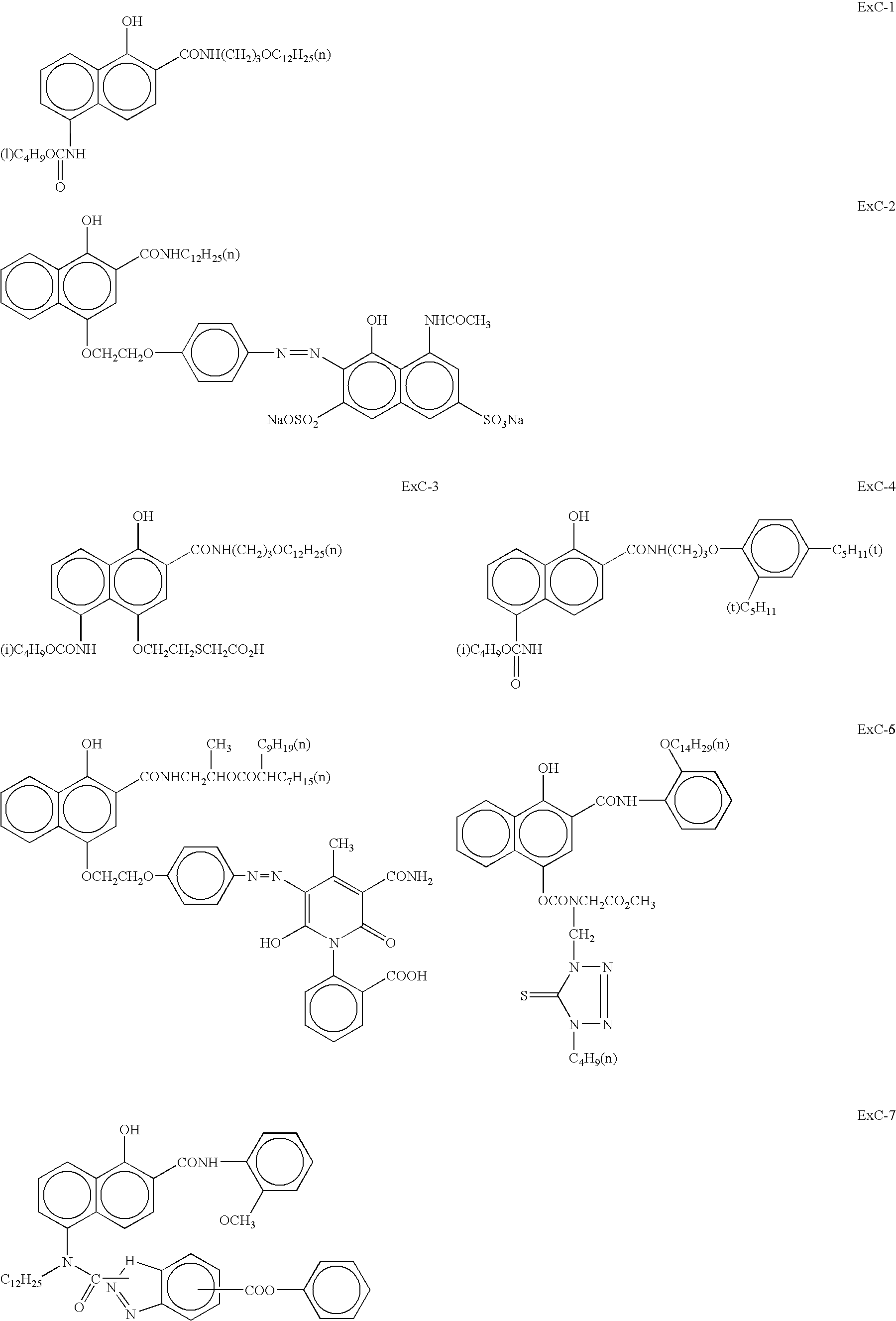

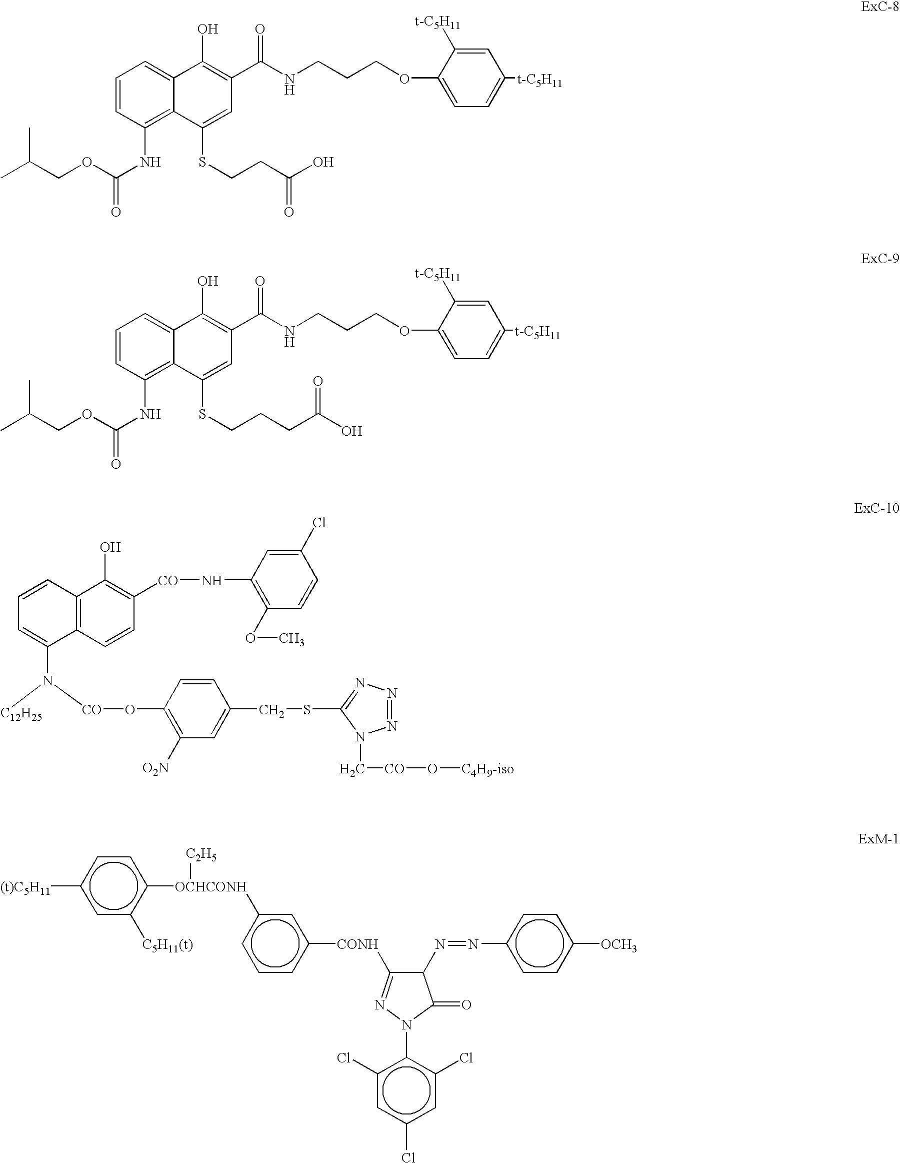

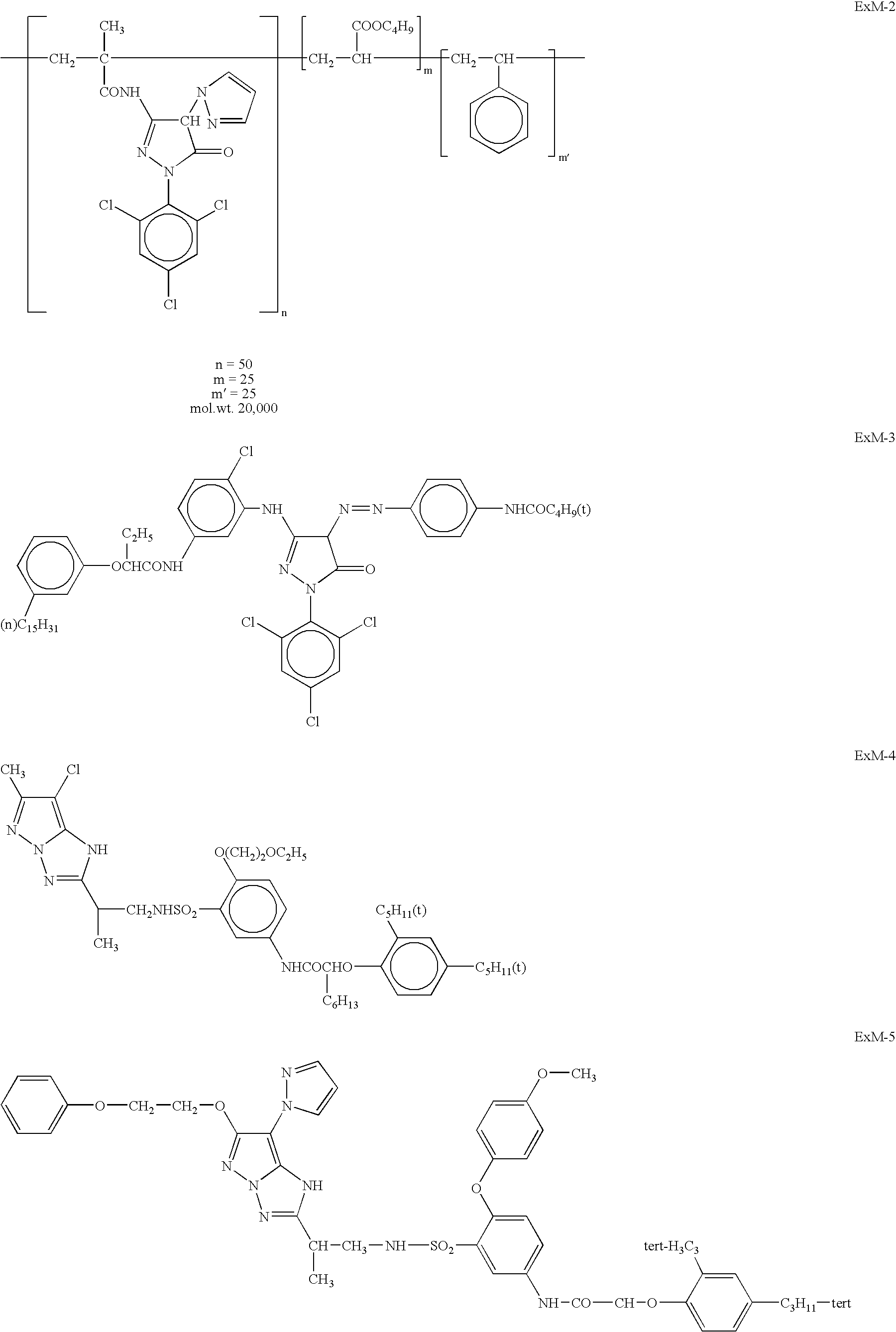

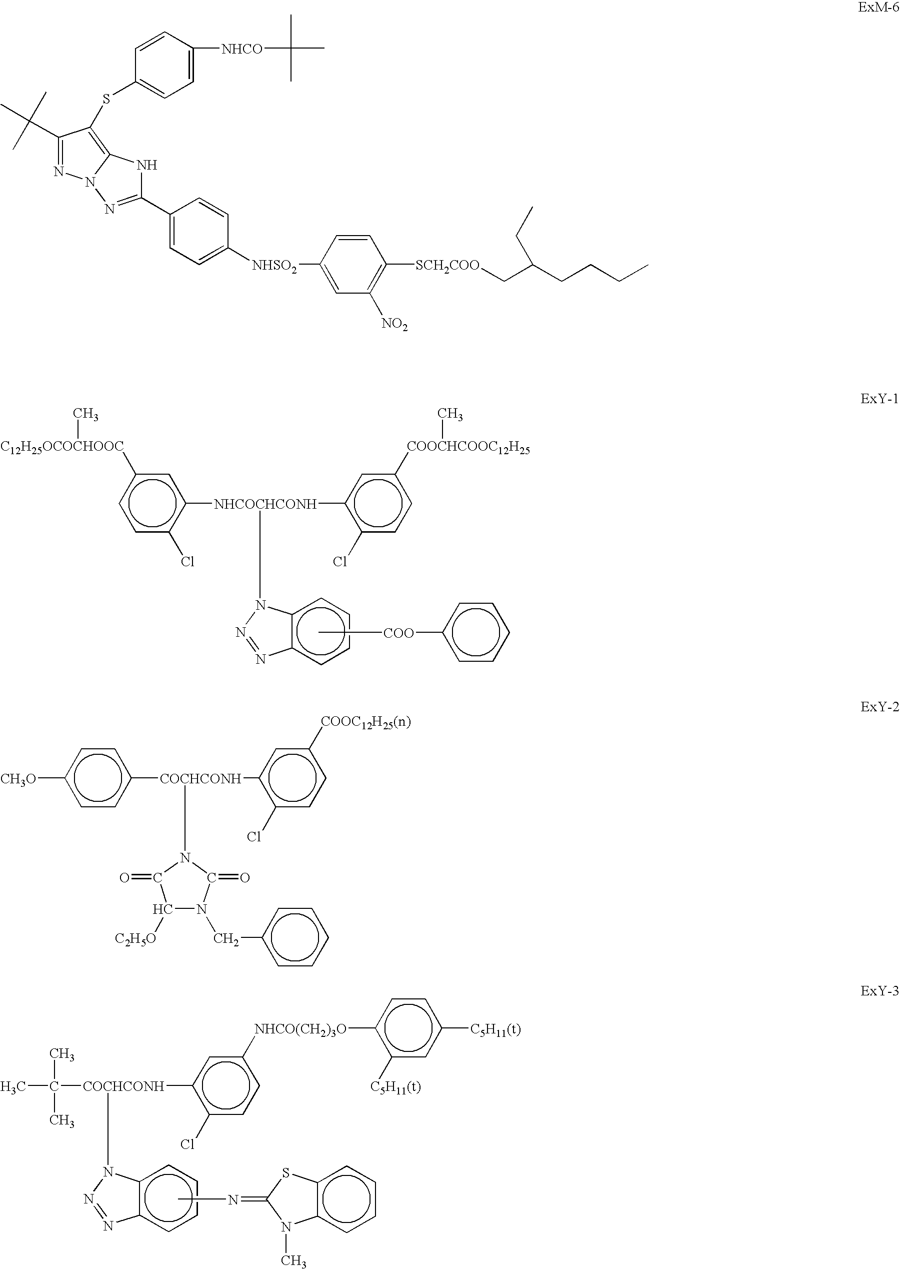

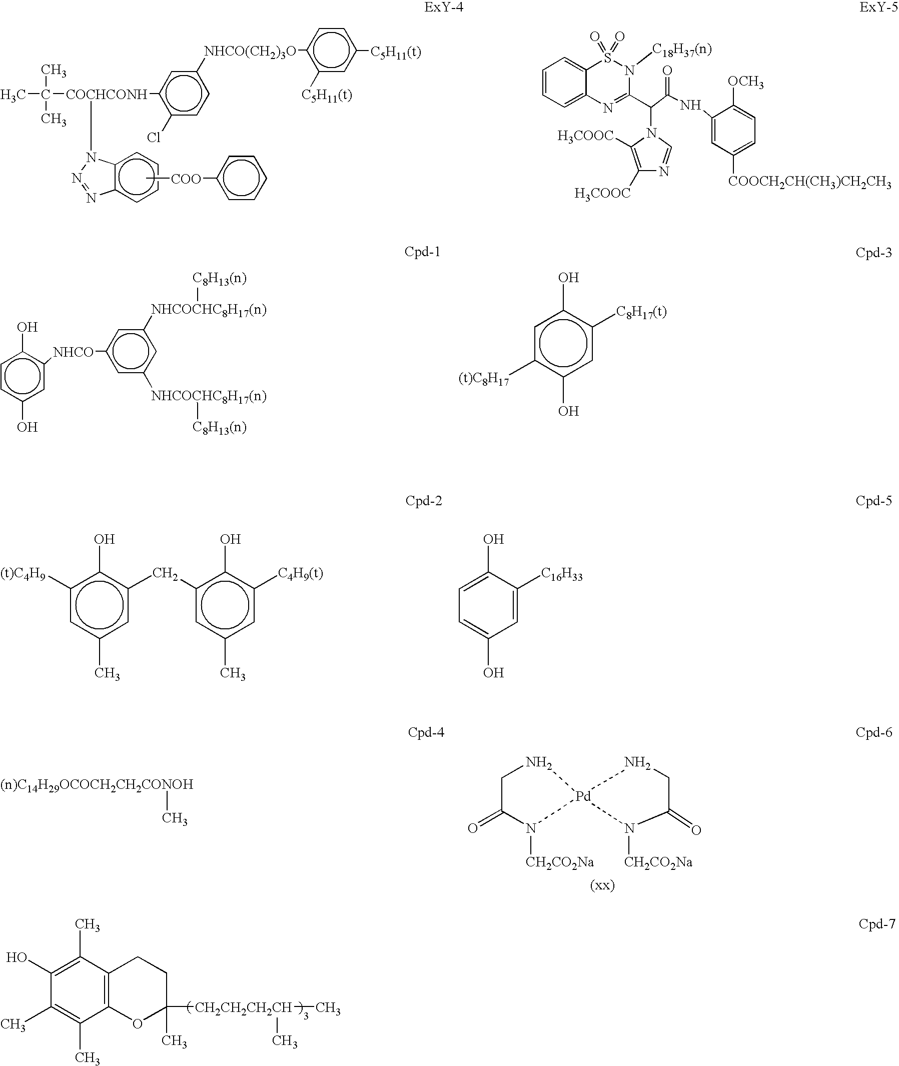

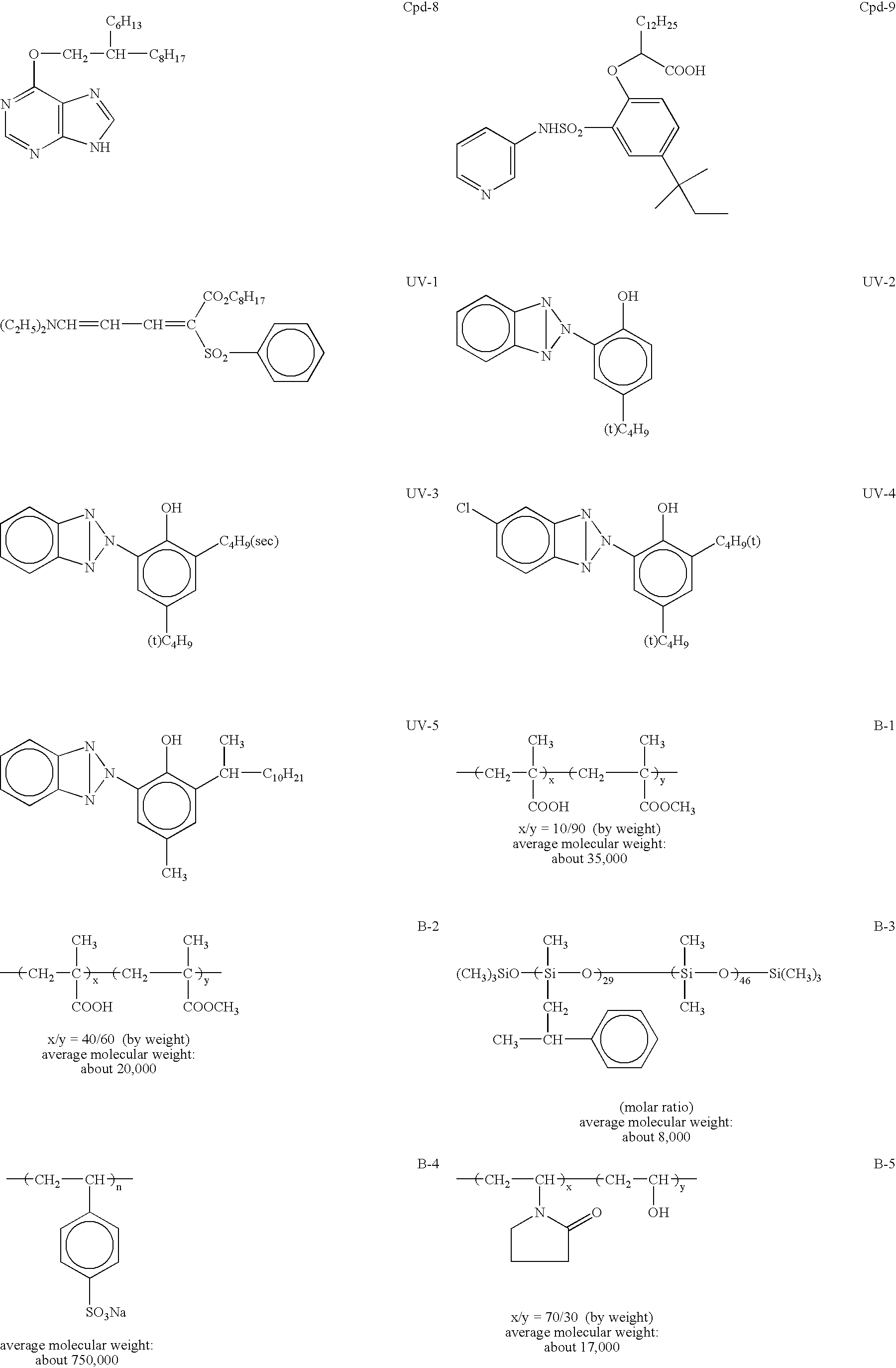

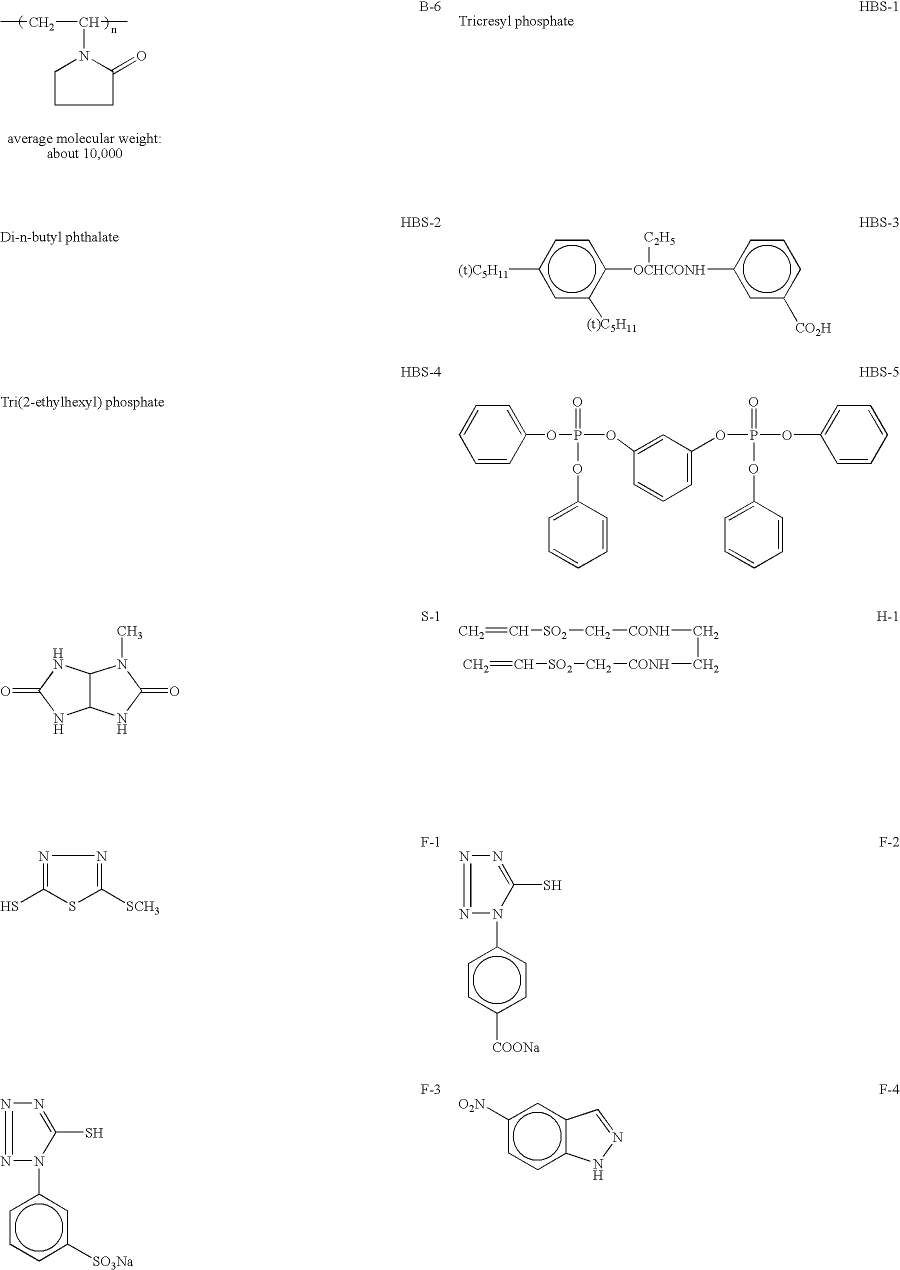

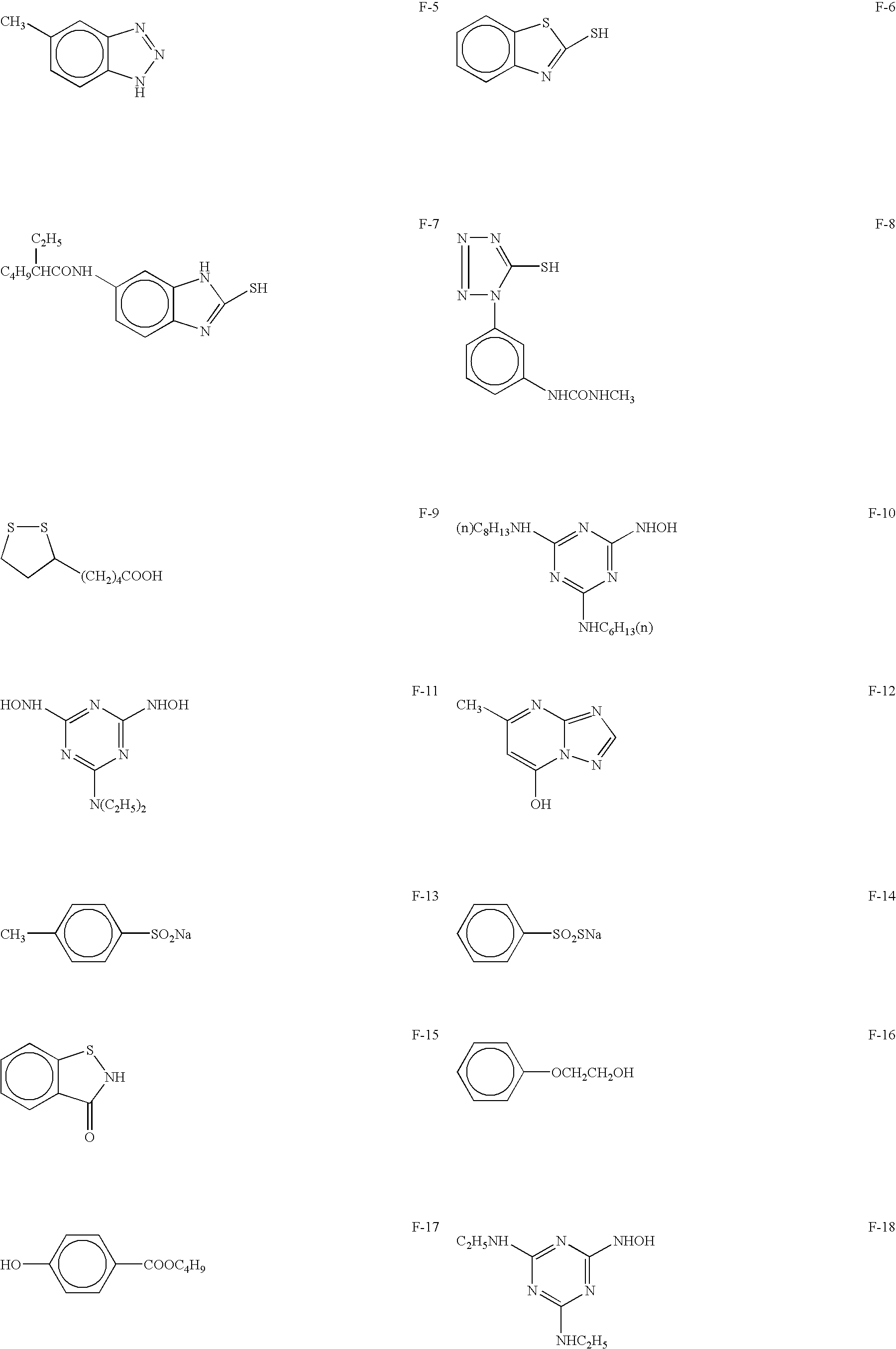

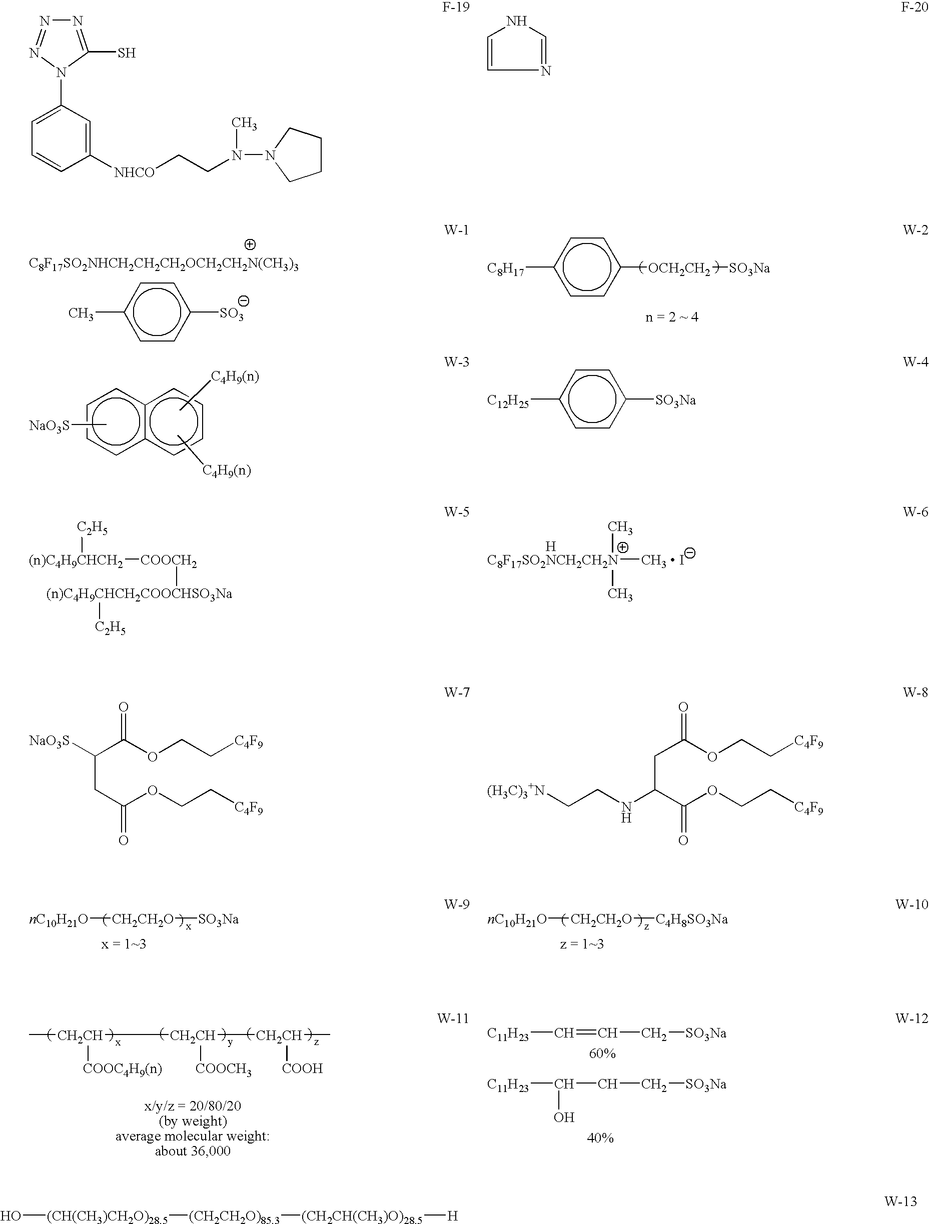

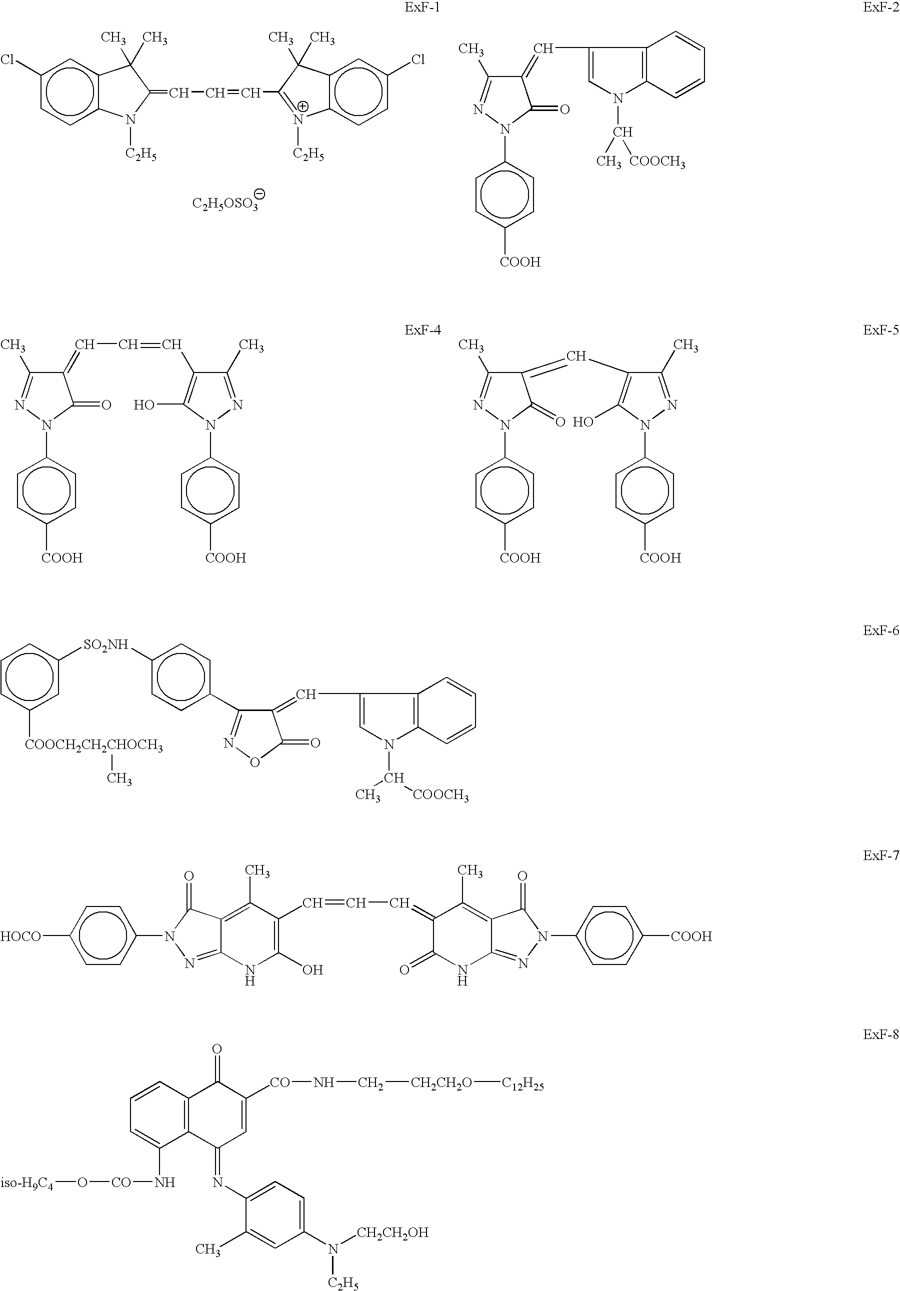

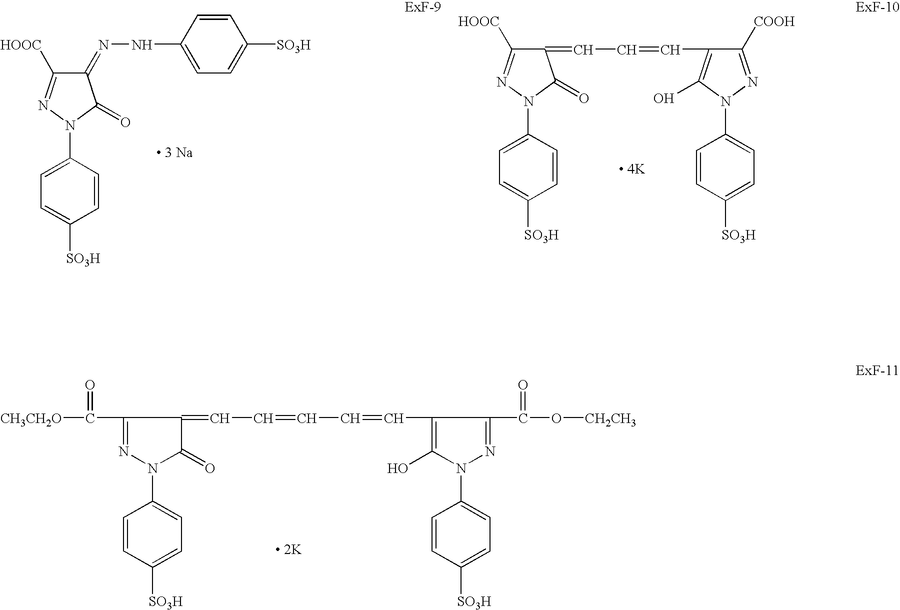

The above-described silver halide color photographic light-sensitive material was referred to as sample 101.

As to sensitometry, the international standard of ISO sensitivity is employed in the art upon determining a specific photographic sensitivity. In the ISO sensitivity, it is prescribed that a light-sensitive material be developed on 5^{th} day after exposure, with the development processing being conducted according to the specification of each company.

In the invention, the time between exposure and development processing was shortened, with performing a definite development processing.

This method for determining a specific photographic sensitivity is according to JIS K 7614-1981, with differences being that development processing is completed within a period of 30 minutes to 6 hours after exposure for sensitometry and that development processing is the FUJICOLOR processing formulation CN-16 described below. Except for these differences, the measurement is substantially the same as that described in JIS.

Sample 101 was exposed for 1/100 second through a gelatin filter SC-39 manufactured by Fuji Photo Film Co., Ltd. and a continuous wedge.

The thus-exposed sample was processed according to the following processing.

(Processing method)

| Step | Processing Time | Processing Temperature |
|---|---|---|
| Color development | 3 min & 15 sec | 38° C. |
| Bleaching | 3 min & 00 sec | 38° C. |
| Washing with water | 30 sec | 24° C. |
| Fixing | 3 min & 00 sec | 38° C. |
| Washing with water (1) | 30 sec | 24° C. |
| Washing with water (2) | 30 sec | 24° C. |
| Stabilizing | 30 sec | 38° C. |
| Drying | 4 min & 20 sec | 55° C. |

Next, formulations of processing solutions are shown below.

| | (unit: g) | |
|---|---|---|
| (Color developing solution) | | |
| Diethylenetriaminepentaacetic acid | 1.0 | |
| 1-Hydroxyethylidene-1,1-diphosphonic acid | 2.0 | |
| Sodium sulfite | 4.0 | |
| Potassium carbonate | 30.0 | |
| Potassium bromide | 1.4 | |
| Potassium iodide | 1.5 | mg |
| Hydroxylamine sulfate | 2.4 | |
| 4-[N-Etyl-N-(β-hydroxyethyl)amino]-2- | 4.5 | |
| methylaniline sulfate | | |
| Water to make | 1.0 | L |
| pH (adjusted with KOH and H₂SO₄) | 10.05 | |
| (Bleaching solution) | | |
| Fe(III) Na ethylenediaminetetraacetate tetrahydrate | 100.0 | |
| Disodium ethylenediaminetetraacetate | 10.0 | |
| 3-Mercapto-1,2,4-triazole | 0.03 | |
| Ammonium bromide | 140.0 | |
| Ammonium nitrate | 30.0 | |
| Aqueous ammonia (27%) | 6.5 | mL |
| Water to make | 1.0 | L |
| pH (adjusted with aqueous ammonia and nitric acid) | 6.0 | |
| (Fixing solution) | | |
| Disodium ethylenediaminetetraacetate | 0.5 | |
| Ammonium sulfite | 20.0 | |
| Ammonium thiosulfate aqueous solution (700 g/L) | 295.0 | mL |
| Acetic acid (90%) | 3.3 | |
| Water to make | 1.0 | L |
| pH (adjusted with aqueous ammonia and nitric acid) | 6.7 | |
| (Stabilizing solution) | | |
| p-Nonylphenoxypolyglycidol (average | 0.2 | |
| polymerization degree of glycidol: 10) | | |
| Ethylenediaminetetraacetic acid | 0.05 | |
| 1,2,4-Triazole | 1.3 | |
| 1,4-Bis(1,2,4-triazol-1-ylmethyl) piperadine | 0.75 | |
| Hydroxyacetic acid | 0.02 | |
| Hydroxyethyl cellulose (Daiseru Kagaku; HEC SP-2000) | 0.1 | |
| 1,2-Benzisothiazolin-3-one | 0.05 | |
| Water to make | 1.0 | L |

| | |
|---|---|
| PH | 8.5 |

The specific photographic sensitivity of sample 101 measured according to the above-mentioned measuring method was ISO3200.

Samples 102 to 109 were prepared in the same manner as with sample 101 except for adding compound (A) of the invention or a comparative compound F-20 to the 4th, 5th, 6th, 8th, 9th, 10th, 11th, 13th, 14th and 15th layers.

The samples 101 to 109 were exposed to a gelatin filter SC-39 manufactured by Fuji Photo Film Co., Ltd. and a continuous wedge for 1/100 second, then subjected to the above-mentioned development processing. The sensitivity of each of red-sensitive layer, green-sensitive layer and blue-sensitive layer was shown in terms of a reciprocal of exposure amount giving a density of minimum density +0.2 for cyan, magenta or yellow color image density, and was shown as a difference from that of the sample 101.

Graininess was evaluated by determining RMS granularity of a cyan, magenta or yellow color image at a density of fog +0.2. It was expressed as a relative value with the graininess of sample 101 being taken as 100.

Additionally, in order to evaluate a substantial increase in sensitivity, in the case where RMS granularity was changed with the increase of sensitivity, the amounts of ExY-3 in the fourth, fifth, sixth, eighth, ninth, tenth, eleventh, thirteenth, fourteenth and fifteenth layer were adjusted so that the RMS granularity became the same.

As to prevervability, fog density of a raw sample was measured after the raw sample was left for 30 days under incubation conditions of 40° C. and 30% was measured. The preservability was evaluated in terms of a difference in fog density compared with the case of not leaving under the incubation conditions.

The smaller the value, the less the increase of fog with the lapse of time, thus a smaller value being preferred.

TABLE 5(A)

| | Compound (A) | | Sensitivity | | |
|---|---|---|---|---|---|
| | of the Invention | | Red- | Green- | Blue- |
| Sample | [Addition | | sensitive | sensitive | sensitive |
| No. | Amount]* | | layer | Layer | Layer |
| 101 | — | | 0 | 0 | 0 |
| (Comparative | | | | | |
| Example) | | | | | |
| 102 | F-20 | [18 × 10⁻³] | 0.06 | 0.05 | 0.05 |
| (Comparative | | | | | |
| Example) | | | | | |
| 103(Invention) | 2 | [18 × 10⁻³] | 0.06 | 0.04 | 0.05 |
| 104(Invention) | 6 | [18 × 10⁻³] | 0.05 | 0.04 | 0.04 |
| 105(Invention) | 27 | [18 × 10⁻³] | 0.05 | 0.04 | 0.05 |
| 106(Invention) | 29 | [18 × 10⁻³] | 0.05 | 0.04 | 0.05 |
| 107(Invention) | 32 | [18 × 10⁻³] | 0.07 | 0.07 | 0.06 |
| 108(Invention) | 34 | [18 × 10⁻³] | 0.07 | 0.06 | 0.07 |
| 109(Invention) | 40 | [18 × 10⁻³] | 0.07 | 0.06 | 0.06 |

*Addition amount: mol/Ag 1 mol

TABLE 5(B)

| | Graininess | | | Sensitivity | | |
|---|---|---|---|---|---|---|
| | red- | Green- | Blue- | Red- | Green- | |
| Sample | sensitive | sensitive | sensitive | sensitive | sensitive | Blue-sensitive |
| No. | Layer | Layer | Layer | layer | Layer | Layer |
| 101(Comparative | 100 | 100 | 100 | 0.09 | 0.07 | 0.07 |
| Example) | | | | | | |
| 102(Comparative) | 101 | 100 | 99 | 0.20 | 0.18 | 0.19 |
| Example) | | | | | | |
| 103(Invention) | 101 | 101 | 98 | 0.11 | 0.08 | 0.09 |
| 104(Invention) | 100 | 100 | 100 | 0.10 | 0.07 | 0.09 |
| 105(Invention) | 99 | 99 | 101 | 0.11 | 0.07 | 0.08 |
| 106(Invention) | 98 | 99 | 101 | 0.10 | 0.07 | 0.08 |
| 107(Invention) | 99 | 98 | 99 | 0.07 | 0.06 | 0.07 |
| 108(Invention) | 99 | 100 | 99 | 0.08 | 0.06 | 0.07 |
| 109(Invention) | 99 | 98 | 100 | 0.07 | 0.07 | 0.07 |

As is seen above, it is apparent that the light-sensitive materials of the invention can provide a high sensitivity without spoiling graininess and are excellent in preservability with time (depressing increase of fog).

### Example 2

Samples 201 to 209 were obtained in the same manner as with the samples 101 to 109 described in Example 1 except for changing the support to that shown below. Evaluation in the same manner as in Example revealed that the samples 203 to 209 showed favorable effects in this Example as well.

1) First Layer and Undercoat Layer

Both sides of each of 90-μm thick polyethylene naphthalate supports were subjected to glow discharge treatment under the conditions of 2.66×10 Pa in pressure of processing atmosphere, 75% in partial pressure of H₂O in the ambient gas, 30 kHz in discharge frequency, 2500 W in output, and 0.5 kV·A·min/m² in treating intensity. On this support was coated, as the first layer, a coating solution of the following formulation employing the bar coating method described in JP-B-58-4589 in a coating amount of 5 mL/m².

| | |
|---|---|
| Dispersion of conductive fine particles | 50 parts by weight |
| (concentration of SnO₂/Sb₂O₅ grains: | |
| 10% aqueous dispersion; secondary agglomerate of | |
| 0.005 μm in primary grain size; average grain size | |
| of the secondary agglomerate: 0.05 μm) | |
| Gelatin | 0.5 part by weight |
| Water | 49 parts by weight |
| Polyglycerol polyglycidyl ether | 0.16 part by weight |
| Poly(polymerization degree: 20)- | 0.1 part by weight |
| oxyethylene sorbitan monolaurate | |

After coating the first layer, the support was wound around a stainless steel core of 20 cm in diameter, and was heat-treated at 110° C. (Tg of the PEN support: 119° C.) for 48 hours to impart heat history and conduct annealing treatment. Then, a coating solution of the following formulation was coated, as an undercoat layer for emulsion, on the opposite side of the support to the first layer side in a coating amount of 10 mL/m² using a bar coating method

| | |
|---|---|
| Gelatin | 1.01 parts by weight |
| Salicylic acid | 0.30 part by weight |
| Resorcinol | 0.40 part by weight |
| Poly(polymerization degree: 10)- | 0.11 part by weight |
| oxyethylene nonylphenyl ether | |
| Water | 3.53 parts by weight |
| Methanol | 84.57 parts by weight |
| n-Propanol | 10.08 parts by weight |

Further, the second and the third layers to be described hereinafter were coated in order and, finally, a color negative light-sensitive material of the formulation to be described hereinafter was multilayer-coated on the opposite side of the support to prepare a transparent magnetic recording medium having a silver halide emulsion layer.

2) Second Layer (Transparent Magnetic Recording Layer)

(i) Dispersion of a Magnetic Material

1100 Parts by weight of Co-coated γ-Fe₂O₃ magnetic material (average longer axis length: 0.25 μm; S_{BET}: 39 m²/g; Hc: 6.56×10⁴ A/m; σS: 77.1 Am²/kg; or: 37.4 Am²/kg), 220 parts by weight of water and 165 parts by weight of a silane coupling agent [3-(poly(polymerization degree: 10)oxyethynyl)oxypropyl trimethoxysilane] were added to an open kneader and were well kneaded for 3 hours. The thus-roughly dispersed, viscous liquid was dried at 70° C. for one day and one night to remove water, followed by heat-treating at 110° C. for 1 hour to obtain surface-treated magnetic grains.

Further, the following formulation was again kneaded for 4 hours in the open kneader.

| | |
|---|---|
| Surface-treated magnetic grains described above | 855 g |
| Diacetyl cellulose | 25.3 g |
| Methyl ethyl ketone | 136.3 g |
| Cyclohexanone | 136.3 g |

Further, the following formulation was finely dispersed in a sand mill (¼ G sand mill) at 2,000 rpm for 4 hours. 1-mmφ glass beads were used as media.

| | |
|---|---|
| Kneaded solution described above | 45 g |
| Diacetyl cellulose | 23.7 g |
| Methyl ethyl ketone | 127.7 g |
| Cyclohexanone | 127.7 g |

Further, a magnetic material-containing intermediate solution was prepared according to the following formulation.

(ii) Preparation of a Magnetic Material-Containing Intermediate Solution

| | |
|---|---|
| Magnetic material fine dispersion described above | 674 g |
| Diacetyl cellulose solution | 24280 g |
| (solid content: 4.34%; solvent: methyl ethyl | |
| ketone/cyclohexanone = 1/1) | |
| Cyclohexanone | 46 g |

After mixing these components, the mixture was stirred in a disper to prepare “a magnetic material-containing intermediate solution”.

An α-alumina abrasive dispersion of the invention was prepared according to the following formulation.

(a) Preparation of Dispersion of Fine Grains of SUMICORUNDUM AA-1.5 (Average Primary Particle Size: 1.5 μm; Specific Surface Area: 1.3 m²/g)

| | |
|---|---|
| SUMICORUNDUM AA-1.5 | 152 g |
| Silane coupling agent KBM 903 (manufactured | 0.48 g |
| by Shin-etsu Silicone Co.) | |
| Diacetyl cellulose solution | 227.52 g |
| (solid content: 4.5%; solvent: methyl ethyl | |
| ketone/cyclohexanone = 1/1) | |

The above-mentioned formulation was finely dispersed for 4 hours at 800 rpm using a ceramic-coated sand mill (¼ G sand mill). 1-mmφ zirconia beads were used as media.

(b) Dispersion of Colloidal Silica Grains (Fine Grains)

MEK-ST manufactured by Nissan Kagaku K.K. was used.

This is a dispersion of colloidal silica having an average primary grain size of 0.015 μm using methyl ethyl ketone as a dispersing medium, and contains 30% solids.

(iii) Preparation of a Coating Solution for the Second Layer

| | |
|---|---|
| Magnetic material-containing intermediate | 19053 g |
| solution described above | |
| Diacetyl cellulose solution | 264 g |
| (solid content: 4.5%; solvent: methyl ethyl | |
| ketone/cyclohexanone = 1/1) | |
| Colloidal silica dispersion MEK-ST (dispersion b) | 128 g |
| (solid content: 30%) | |
| AA-1.5 dispersion (dispersion a) | 12 g |
| Millionate MR-400 (manufactured by | 203 g |
| Nihon Poriuretan K.K.)(diluted solution) | |
| (solid content: 20%; diluting solvent: methyl | |
| ethyl ketone/cyclohexanone = 1/1) | |
| Methyl ethyl ketone | 170 g |
| Cyclohexanone | 170 g |

The above-described components were mixed and stirred, and the resulting coating solution was coated in a coating amount of 29.3 mL/m² by using a wire bar. Drying was conducted at 110° C. The thickness of the dried magnetic layer was 1.0 μm. 3) Third Layer (Higher Fatty Acid Ester Lubricant-Containing Layer)

(i) Preparation of a Mother Solution for Dispersing a Lubricant

The following solution (a) was heated to 100C to dissolve and, after adding it to solution (b), the resulting mixture was subjected to dispersing step in a high-pressure homogenizer to prepare a mother solution for dispersing a lubricant.

| | |
|---|---|
| Solution (a) | |
| The following compound | 399 parts by weight |
| C₆H₁₃CH₈(OH)(CH₂)₁₀COOC₅₀H₁₀₁ | |
| The following compound | 171 parts by weight |
| n-C₅₀H₁₀₁O(CH₂CH₂O)₁₆H | |
| Cyclohexanone | 830 parts by weight |
| Solution (b) | |
| Cyclohexanone | 8600 parts by weight |

(ii) Preparation of a Dispersion of Spherical Inorganic Grains

A dispersion [c1] of spherical inorganic grains was prepared according to the following formulation.

| | |
|---|---|
| Isopropyl alcohol | 93.54 parts by weight |
| Silane coupling agent KBM903 | 5.53 parts by weight |
| (manufactured by Shin'etsu Silicone Co.) | |
| compound 1-1: (CH₃O)₃Si—(CH₂)₃—NH₂) | |
| Compound 1 | 2.93 parts by weight |
| Compound 1 | |
| 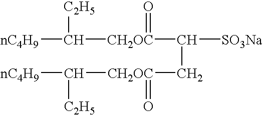 | |
| Seahosar KEP50 | 88.00 parts by weight |
| (amorphous spherical silica; average grain size: | |
| 0.5 μm; manufactured by Nippon Shokubai Co., | |
| Ltd.) | |

The above-described formulation was stirred for 10 minutes, followed by adding thereto the following.

| | |
|---|---|
| Diacetone alcohol | 252.93 parts by weight |

The above-described solution was dispersed for 3 hours by means of an ultrasonic wave homogenizer SONIFIER450 (manufactured by BRANSON CO.) while cooling with ice and stirring to complete a dispersion cl of the spherical inorganic grains.

(iii) Preparation of a Dispersion of Spherical Organic High Polymer Particles

A dispersion [c2] of spherical organic high polymer particles was prepared according to the following formulation.

| | |
|---|---|
| XC99-A8808 | 60 parts by weigh |
| (manufactured by Toshiba Silicone Co.; spherical | |
| crosslinked polysiloxane particles; average | |
| particle size: 0.9 μm) | |
| Methyl ethyl ketone | 120 parts by weight |
| Cyclohexanone | 120 parts by weight |
| (solid content: 20%; methyl ethyl | |
| ketone/cyclohexanone = 1/1) | |

The above-described mixture was dispersed for 2 hours by means of an ultrasonic wave homogenizer SONIFIER450 (manufactured by BRANSON CO.) while cooling with ice and stirring to complete a dispersion c2 of the spherical organic high polymer particles.

(iv) Preparation of a Coating Solution for the Third Layer

To 542 g of the above-described lubricant dispersion mother solution was added the following components to prepare a coating solution for the third layer.

| | | |
|---|---|---|
| Diacetone alcohol | 5950 | g |
| Cyclohexanone | 176 | g |
| Ethyl acetate | 1700 | g |
| Seahostar KEP50 dispersion [c1] | 53.1 | g |
| described above | | |
| Dispersion [c2] of spherical | 300 | g |
| high polymer particles | | |
| FC431 | 2.65 | g |
| (manufactured by 3 M; solid | | |
| content: 50%; solvent: ethyl acetate) | | |
| BYK310 | 5.3 | g |
| (BYK JAPAN Co.; solid content: 25%) | | |

The coating solution for the third layer was coated on the second layer in a coating amount of 10.35 mL/m², then dried at 110° C., and further dried at 97C for 3 minutes.

The photographic light-sensitive material of the invention has the effect of increasing sensitivity without deteriorating preservability and graininess.

The entire disclosure of each and every foreign patent application from which the benefit of foreign priority has been claimed in the present application is incorporated herein by reference, as if fully set forth.

What is claimed is:

1. A silver halide photographic light-sensitive material comprising at least one compound (A),
wherein the at least one compound (A) is a compound capable of releasing a sensitizing compound that increases a sensitivity of the silver halide photographic light-sensitive material in comparison with a case where a silver halide photographic light-sensitive material does not comprise the at least one compound (A), and the sensitizing compound is released by hydrolysis.

2. The silver halide photographic light-sensitive material according to claim 1, which further comprises:
a support;
at least one blue-sensitive layer comprising a silver halide emulsion layer;
at least one green-sensitive layer comprising a silver halide emulsion layer;
at least one red-sensitive layer comprising a silver halide emulsion layer; and
at least one light-insensitive layer,
wherein at least one layer of the silver halide photographic light-sensitive material comprises the at least one compound (A).

3. The silver halide photographic light-sensitive material according to claim 1,
wherein the at least one compound (A) is a compound represented by one of formula (A-1) and (A-2): 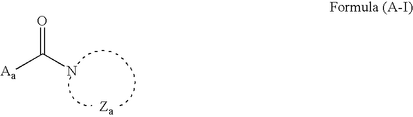
wherein Zₐ represents a group forming a hetero ring containing 1 or 2 hetero atom(s) including a nitrogen atom in the formula; and Aa represents an alkyl group, an alkenyl group, a cycloalkyl group, an aryl group, an alkylamino group, an arylamino group or an alkoxy group; 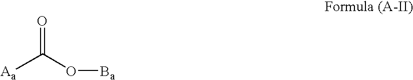
wherein Aₐ represents an alkyl group, an alkenyl group, a cycloalkyl group, an aryl group, an alkylamino group, an arylamino group or an alkoxy group; and Bₐ represents a hetero ring.

4. The silver halide photographic light-sensitive material according to claim 3, wherein the at least one compound (A) is a compound represented by Formula (A-I).

5. The silver halide photographic light-sensitive material according to claim 3, wherein the at least one compound represented by Formula (A-I) is a compound in which the hetero ring formed by Zₐ is an imidazole ring, a pyrrole ring, a pyrazole ring or a benzimidazole ring.
